(19) United States
(12) Patent Application Publication
(10) Pub. No.: US 2023/0214792 A1
(43) Pub. Date: Jul. 6, 2023

(54) COMPUTER IMPLEMENTED SYSTEMS AND METHODS

(71) Applicant: ELAS HOLDINGS PTY LTD, Fortitude Valley, Queensland (AU)

(72) Inventor: Brendan LEE, Fortitude Valley, Queensland (AU)

(21) Appl. No.: 18/000,769

(22) PCT Filed: Jun. 8, 2021
(86) PCT No.: PCT/EP2021/065333

§ 371 Date: Dec. 5, 2022

(30) Foreign Application Priority Data
Jun. 10, 2020 (GB) 2008790.4
Dec. 17, 2020 (GB) 2019960.0
Apr. 19, 2021 (GB) 2105595.9
Jun. 4, 2021 (GB) 2108043.7

(51) Int. Cl. G06Q 20/02; G06Q 20/36; G06Q 20/38

(52) U.S. Cl. CPC G06Q 20/02; G06Q 20/3678; G06Q 20/3825

(57) ABSTRACT

The invention resides in a blockchain-implemented method of operating a system having a device, the method comprising: using, processing and/or generating a blockchain transaction (MTx) having: one or more token-related outputs (T-UTXO), each of which represents a respective token (T) issued by a Token Issuer (TI) and specifies a) at least one of the operation, status and data that determines the configuration of the device; b) a quantity of token-related cryptocurrency (TRC) associated with the respective token (T). The operation, status and data that determines the configuration and/or status of the device can be determined from instructions on the output of a respective token's blockchain transaction. Generally, assets or resources can be tracked and/or managed using one or more blockchain transactions in which token-related outputs, representing tokens, function to determine the status of an asset.

### CROSS-REFERENCE TO RELATED PATENT APPLICATIONS

This application is a U.S. National Stage Application under 35 U.S.C. § 371 of International Patent Application No. PCT/EP2021/065333 filed Jun. 8, 2021, which claims the benefit of priority of British Patent Application numbers GB 2108043.7 filed Jun. 4, 2021, GB 2105595.9 filed Apr. 19, 2021, GB 2019960.0 filed on Dec. 17, 2020, and GB 2008790.4 filed Jun. 10, 2020, all of which are incorporated by reference in their entireties. The International Application was published on Dec. 16, 2021, as International Publication No. WO/2021/250022A1.

### FIELD

This disclosure relates generally to methods and systems for electronic exchange between parties. Examples utilise, at least in part, a distributed ledger (blockchain) to facilitate the secure and efficient transfer of control of a tokenised resource from one party to another. The disclosure is particularly suited, but not limited, to use in respect of the distribution of tokenised assets across a computing network. Verification of these tokenised assets is improved, enhancing security and reducing vulnerability to transfers and exploits by unauthorised parties. Examples enable the implementation of improved digital wallets which are able to exchange data in new and technically advantageous ways. Further examples of the invention generally reside in a blockchain-implemented token generation, transfer and/or verification method that uses, processes and/or generates a blockchain transaction (MTx), a digital wallet arranged and configured to use or process the method, a computer implemented method comprising the step of: generating, storing, processing and/or maintaining a computer-based resource (R) of a plurality of token-related blockchain transaction outputs (T-UTXOs), a computer network comprising a plurality of nodes, wherein each node in the computer network comprises is configured to implement said methods, and a non-transitory computer-readable storage medium having stored thereon executable instructions that, as a result of being executed by a processor of a computer system to perform said methods.

### BACKGROUND

The Bitcoin blockchain ledger as introduced in 2008 by Satoshi Nakamoto's whitepaper (https://bitcoin.org/bitcoin.pdf) is the most widely known blockchain and associated network/platform in use today. Therefore, we will refer to Bitcoin in the examples used herein. However, examples of the disclosure are not limited in this regard and alternative blockchain protocols and implementations fall within the scope of the present disclosure.

A blockchain transaction is a data structure formed in accordance with a blockchain protocol and comprises at least one input and at least one output. Control of the cryptocurrency that is digested/received by the input(s) is spent/transferred from the output(s) of the transaction to the input(s) of further transaction(s) that are added to the blockchain, such as in subsequently mined block(s). Any portion of the cryptocurrency that is not transferred to a new receiving address/owner/receiver is sent back to the current address/owner/sender as “change”. Inputs and outputs are ordered and numbered within their respective transactions so that they can be referenced. In the case of outputs, they form a zero-indexed Vector (list) based on their position within the transaction's outputs. An output's index number is known as its “Vout” index. With respect to inputs, each input in a transaction is identifiable by the transaction identifier (TxID) and the Vout of the output that it will spend. The inputs in a given transaction are also listed in a zero-indexed Vector, this time known as “Vin”. In this way, each input references an identifiable output in a previous transaction on the ledger, thus creating a chain so that the immutable transfer history of each cryptocurrency unit can be verified by traversing the blockchain back to the unit's originating source. In the Bitcoin protocol, this could be a Coinbase transaction in which the cryptocurrency was created by a miner as a reward for Proof-of-Work effort, or the very first block of the ledger which is usually known as the Genesis block.

Although it has gained publicity as a means of transferring cryptocurrency, the wider applicability of blockchain technology is somewhat analogous to the way that the Internet provides an underpinning support layer for many distributed services, communications and data sharing technologies. In the same way as the Internet forms the backbone of many more computer-implemented solutions beyond just the provision of web pages, blockchain platforms can provide the underlying mechanism that enables much more than just the transfer of cryptocurrency. For example, blockchain transactions can be used to transfer other types of data in addition to digital money, thus driving technologies across a wide spectrum of industries and applications. This additional data is often referred to as “metadata” and could potentially comprise any type or format of data, such as text, media content, images, links to off-chain locations or resources, executable code, smart contracts, hashes of such data etc.

The ability to transfer data, plus blockchain-implemented technologies such as smart contracts, the Metanet, Simplified Payment Verification (SPV) and more, have resulted in the use of blockchain platforms as an underlying infrastructure or vehicle that other “layer 2” technologies can be built upon. These include layer 2 tokenisation solutions which use the blockchain as an underlying transfer mechanism for communication of electronic tokens. A token is a digital object or item that is used to represent some other object or resource, physical digital or otherwise. Blockchain tokenisation technologies provide numerous technical advantages such as improved security, efficiency, ease of use and enhanced network privacy. However, known tokenisation approaches also face numerous technical challenges. These include, but are not limited to, the following problems. Firstly, current token solutions require some type of third-party infrastructure to handle authorisation of actions and verification of the token's authenticity. Such infrastructures can be costly in terms to develop and operate, both financially and in terms of required computing resources and time and, therefore, can be inefficient. They can also require the use of trusted third parties which, in turn, can lead to security concerns and increased potential for attacks, exploits and breaches. Moreover, wallet integration can be a significant challenge as the process is often complex and time consuming Other challenges include, but are not limited to, concerns over the scalability of tokenisation solutions, concerns surrounding privacy for users and therefore potential for targeted exploits, the need for off-chain token processing or transfer which means that such solutions are not fully cryptographically enforced and immutably verifiable on a public ledger, or require that the user inserts data into a script in order to process the tokens. Moreover, some tokenisation schemes lend themselves only to handling of certain types of tokens, which means they are restricted with regard to wider applicability and cannot be extended or adapted for use in more diverse, potentially desirable implementations. These, and other challenges faced by current blockchain-implemented tokenisation schemes, are not trivial to address. New adaptable and scalable protocols and applications for electronic tokens are sought, especially when they result in more efficient processing.

### SUMMARY

Aspects and examples of the present disclosure provide techniques, protocols and systems for creating, using, processing, and transferring tokenised assets or resources via a blockchain (ledger) that is associated with a blockchain protocol and network. This may be, for example, a version of a cryptocurrency ledger e.g. the Bitcoin ledger that follows its protocol that operates on its associated network and platform but other blockchain protocols and implementations may be used and fall within the scope of the present disclosure.

Generally, assets or resources can be tracked and/or managed using one or more blockchain transactions in which token-related outputs, representing tokens, function to determine the status of an asset. The status can, for example, indicate at least one of ownership, access rights to a secured asset, data, instruction, state, operation, configuration and value of an asset or resource, such as an amount of token-units. Token transactions include a quantity of token-related cryptocurrency associated with the respective token, and during a token transaction (i) the authentication of the cryptocurrency processed in the transaction can be deterministically verified by the miner processing the transaction and/or (ii) the token's authenticity can be verified e.g. by a recipient of the token, such as a user's wallet, a database management system or device within a control system.

The tokens described herein are created through a set of transactions, including at least one of: an inaugural transaction, which can be root node holding digital identities and/or digital signatures of the issuer and/or authority responsible for the tokens, which can also include additional signatures from, for example, a governmental or regulatory authority; a token definition transaction, that defines the tokens to be created, and their format, which can be a minting transaction, database establishment transaction or a device set-up record in a control system, said token definition transaction preferably referencing the inaugural transaction, and preferably defining an ‘establishment transaction’; and a token issuance transaction, wherein a token is transferred to a user, which preferably references the token definition transaction e.g. establishment transaction and/or the inaugural transaction. The inaugural transaction can include at least one Issuer-related output (I-UTXO) comprising issuance data (IData) associated with the Token Issuer (TI).

Token transactions have a deterministic relationship with the at least one of the inaugural transaction and the token definition transaction that creates the token and/or establishes its application and configuration.

A set of transactions can include at least two of the inaugural transaction, token definition transaction and the token issuance transaction. For example, the set of transactions can be a set of one, wherein a single transaction includes the operation of each of the inaugural transaction, token definition transaction and the token issuance transaction. By way of another example, the minting transaction can include the function of the token definition transaction and the token issuance transaction. Each of the transactions can, however, exist separately such that the set has transactions distributed at different points in time, with subsequent transactions referring to the others.

The or each of the inaugural transaction, token definition transaction and the token issuance transaction can be referred to as a ‘minting’ transaction because it is responsible, at least in part, for the creation of a token. This is because these transactions establish, on-chain, at least one of an authority, a token definition and the subsequent issue of a token derived from said authority. The issue of a token refers directly to the token definition and/or the authority.

An authority can, at any time, issue further tokens by referring to a token definition, wherein the authority of the further issued tokens is determinable from an earlier transaction, such as the inaugural transaction and/or the token definition transaction.

When a token transaction outputs data, and refers to an earlier token transaction, the linear transaction history can be referred to as a portion of a writechain, which is the relationship between the use of a token in two or more transactions. The inaugural transaction and/or the token issuance transaction can include a digitally signed certificate of an authority that will monitor the operation of the device. The set of transactions i.e. at least one of the inaugural transaction, token definition transaction and the token issuance transaction, alone or in combination, determine the start or ‘root’ of the writechain. These three transactions can occur at separate instances on a writechain, or their actions can be combined in to one or two transactions.

Overall, the authenticity of the status of the asset and its history can be determined through verification that the token is derived from an issuer responsible for the asset and/or an inaugural establishment transaction, which can be verified, for example, from the token's relationship with at least one of the Issuer-related output (I-UTXO) associated with the issuer of the token and/or output that created the token i.e. token authentication is via a relationship with at least one of the inaugural transaction, token definition transaction and the token issuance transaction. Authentication can include a Merkle proof.

Additionally or alternatively, an existing token can be to be refreshed i.e. its token transaction history up until the refresh can be disregarded, which can be achieved by the authority applying a further set of signatures or a new set of signatures and, in effect, repeat the steps of at least one of set of transactions, such as the inaugural transaction and/or token issuance trans action.

UTXO origins in a cryptocurrency ledger are traceable back to the coinbase transaction that created it, which can be performed by miners, and the position of the block in which it was created within the blockchain can be determined. A token ledger operates in parallel to the cryptocurrency ledger, and when a recipient of a token verifies its authenticity it can do so by referring back to its own creation, i.e. the set of transaction(s) that created the token, and do so independently of the underlying cryptocurrency, thus resulting in a faster and more efficient computational process of authentication. This efficiency can be achieved because the token has a linear transaction history i.e. the token transaction history from the latest transaction to the issuing transaction involves no forks or loops.

Examples herein correspond to tokens created to control assets or resources having at least one of: static values; dynamic values; the authority to write data to establish a transactional record of data, such as information and/or instructions e.g. for a transactional database (including the sub-division of those assets); and the status of a device or system having a device. The status of an asset can be analogous to the status of a machine. The status can be at least one of the operation, and data that determines the configuration of the asset or resource. The operation can include a finite-state machine. Changing the status of a token can be determined by the transaction output, wherein the script determines the signatures required to unlock the UTXO and spend the transaction into a new state. The tokens, their applications and support devices and systems enable the deterministic verification of the right to access an asset or the status of an asset by using a ledgers to record the transaction output. Not only does this inhibit corruption but the token implementation alone, or as part of a system, provides for an efficient process and cost effective means of managing an asset. The token ledger, or platform upon which assets can be managed, use a combination of transactions e.g. inaugural, definition and issuance, to establish a digital record from which a series of transactions depend from, thus creating a writechain, which can be described as a linear history back to said record.

Subsequent blockchain transactions can include at least one of a corresponding signature of the public key from a parent transaction, and a unique identification, including a signed public key of the parent transaction, creating an edge connection with a previous transaction and an identification of the previous transaction. The subsequent transaction, which refers to the previous transaction via an edge, can define, at least in part, the writechain.

According to an aspect of the invention, there resides a blockchain-implemented token generation, transfer and/or verification method comprising: using, processing and/or generating a blockchain transaction (MTx) having: i) one or more token-related outputs (T-UTXOs), each of which represents a respective token (T) issued by a Token Issuer (TI) and specifies a quantity of a) token units (TU) and b) token-related cryptocurrency (TRC) associated with the respective token (T); and ii) at least one Issuer-related output (I-UTXO) comprising issuance data (IData) associated with the Token Issuer (TI).

Examples of the disclosure comprise a system wherein one or more tokens are generated via the use of an issuing or “minting” transaction. A token may, in the alternative, be considered as a “digital object” and may provide an on-blockchain representation of some tokenised resource or units thereof, such as the status of an asset. The minting transaction comprises issuance data which testifies to the issuer's identity and/or authority to issue the tokens, and serves as a verification means during transfer and processing of the tokens in subsequent use. The minting transaction can also comprise one or more outputs (UTXOs), each of which represents a token. As described above, a minting transaction can include one or more of the inaugural transaction, token definition transaction and the token issuance transaction. This is because a reference back to any one of these three transactions can enable a recipient of a token to determine its source and the authenticity of the token i.e. a recipient can validate the origin of the token by determining that it originated from a set of transactions, which can be one transaction. These transactions, at least in part, define the origins of the linear transaction history of the token.

In turn, each token represents a quantity of tokenised asset or resource of some type. In some cases, the tokenised asset/resource may be expressed as a quantity of unit(s). The tokenised resource can take any form. For example, it can be a digital or virtual asset, an abstract entity or a physical entity. The token's pre-determined quantity of resource units is specified when the token is minted and during use the protocol can be configured such that requires that: (i) this quantity of tokenised resource units remains fixed i.e. immutable or unchanging in some respect despite their transfer over the blockchain; or (ii) the quantity of tokenised resource units is changeable i.e. dynamic. The token can be used to hold a token value which corresponds to a function of the satoshi value (or other form of cryptocurrency units) held in the token that tracks the number of token units held in the output. When the token's quantity is fixed, the token is transferred during a transaction e.g. from Alice to Bob. When the token's quantity is changeable, a quantity of resource units is transferred during a transaction e.g. from Alice's dynamic token to Bob's dynamic token. In other words, when the token's quantity (satoshi amount) is fixed, the associated value is fully transferred during a transaction e.g. from Alice to Bob i.e. a token having a fixed value is indivisible and is transferred in its entirety. When the token's (satoshi amount) quantity is variable (dynamic), a quantity of resource units (satoshis) is transferred during a transaction e.g. from Alice's dynamic token to Bob's dynamic token.

For the sake of convenience, the terms “token value” or “denomination” may be used interchangeably herein with “quantity of tokenised resource” or “token units”. According to the disclosure, the token is represented by either (i) a fixed quantity of cryptocurrency units (e.g. Satoshis or some other type of cryptocurrency) held in the locking script of a UTXO that has a linear history linking it to the token's creation in a minting transaction via the ledger, or (ii) a changeable quantity of cryptocurrency units (e.g. Satoshis or some other type of cryptocurrency) held in the locking script of a UTXO, and the token has a linear history linking it to the token's creation in a minting transaction via the ledger.

When the token is to be transferred from one party to another, a solution for the locking script plus a reference to the UTXO holding the token are used as an input in a new transaction which spends the token-holding UTXO to a new locking script specified by the receiving party. As is known in the art, spending of a UTXO requires the transfer of control of a quantity of cryptocurrency from one address to another, i.e. from one cryptographically locked/secured challenge to another, and so transfer of the token is performed upon spending of an underlying portion of cryptocurrency. In some examples, the issuance data and/or other data is also transferred along with the token and cryptocurrency.

The tokens described herein have a deterministic relationship with the minting transaction that enables its authentication and/or a linear transaction history to be determined. When the transactions have output data, the linear transaction history can be referred to as the writechain, which is the relationship between the use of a token in two or more related transactions. The two or more related transactions can be sequential transactions. The writechain can determine the token history. When token outputs are used to determine a database and/or control system, multiple writechains can co-exist, wherein each writechain determines different operations on the same database and/or have different token identities.

All tokens have a relationship history that leads back to the minting transaction (MTx) that created them, although not necessarily with each other. Multiple tokens create multiple writechains. The operations of tokens can be configured according to their applications, such that their rule-set or functionality varies e.g. static tokens have a fixed value, while write tokens can only output instructions that provide write instructions to a database, whereas other tokens can refer to transactions made in another writechain e.g. an admin token can be configured to output an instruction that overwrites an earlier instruction output by a write token. A database might have multiple write chains which each perform different operations on the same database, or which carry different token identities.

In each of the examples of the invention, the minting transaction provides data that determines the functional operation of a token—which can, at least one of, manage an asset, record information in transactions and subsequently enable compilation of transactions on a writechain into a functional record deterministically. Further, the interaction with a ledger, such as a cryptocurrency ledger, inhibits corruption and optimises use of a scalable platform in an efficient and cost-effective manner.

In an example, when the token is transferred, the UTXO holding the token is used as an input to the transaction and a quantity of cryptocurrency tokens must be spent into an output with the same index as the input for the token transfer to be valid. This occurs when the number of token units held by the token is static or dynamic. In this way, ownership of the token is passed to the new UTXO's controlling party. This method has the benefit of being easily traceable on the public ledger due to the matching indices of input and output (Vin and Vout) in each transaction, resulting in improved speed and efficiency when validating the provenance and/or authenticity of the token. However, in other examples the transfer of the token can be performed through the linking of the input of the transaction containing the token to an output of the transaction through other mechanisms such as, for example, a signature or identifier placed into the locking script of the new UTXO that holds the token.

In another example, the token is not transferred. In this case the number of token units held by the token is changeable, and a number of token units are transferred, such that it is a dynamic token. The dynamic token, therefore, is held by an owner and it is the UTXO of the token units held in the token that is used as an input to the transaction and a quantity of token units of cryptocurrency within the token must be spent into an output with the same index as the input for the token transfer to be valid. If the amount of token units required to be transferred is less than the total number of units held in the dynamic token, then change can be given. In this way, ownership of token units of the token is passed to the new UTXO's controlling party. This method also has the benefit of being easily traceable on the public ledger due to the matching indices of input and output (Vin and Vout) in each transaction, resulting in improved speed and efficiency when validating the provenance of the token units.

Irrespective of the particular linking technique used, though, a token used and arranged in accordance with examples of the disclosure can be described as having a linear transaction history when that token has a complete history of being transferred. When a static token is transferred there is no change to the originally ascribed token value applied in the minting transaction. This means that the token, when configured as a static token, is always transferred wholly into a single, separate and unique UTXO without having its token value split, merged, duplicated or modified in any way. This means that the transaction history of a token can be represented as a series of linear actions in which each action transfers the token in the same form in which it was created in the minting transaction.

The token can be used to hold a dynamic token value which corresponds to a function of the cryptocurrency unit e.g. satoshi value, held in the token which tracks i.e. corresponds to the number of token units held in the output. When token units in a dynamic token are transferred the originally ascribed token value applied in the minting transaction is changed. Those token units being transferred are transferred wholly into a separate and unique UTXO. Any change from the transaction to be returned is also assigned a separate and unique UTXO. In the transaction history the movement of token units from each input-output ‘pair’ can be represented as a series of linear actions in which each action transfers the token units in the same form in which it was created in the minting transaction. Moreover, the net balance between the sum of the inputs and outputs is zero. The ‘zero’ net balance does not take into account transaction fees.

Because of these transfer characteristics, in most examples of the disclosure the overhead required to manage token transfers is very low, and can be applied in a way that pushes the transfer governance process down onto the nodes of the Bitcoin network to manage as part of their role in transaction validation. In other examples, these transfer characteristics can be applied in a way that utilises the underlying protocol for transfer, while the overlayed tokenisation protocol can be handled by wallet providers.

In transactions involving both static and dynamic tokens the net balance between the input (Vin) and output (Vout) is zero i.e. the sum of the inputs equals the sum of the outputs. To be clear, fees and other non-token inputs and outputs are not generally considered part of the transaction, unless specifically referred to herein—it is the token value being exchanged or created that has a net balance, which does not include overhead costs.

Each time a token or token unit is transferred, its identity and authenticity as a token or token unit in accordance with the protocol can be verified. As the token's or token unit's transaction history is linear and the tokenised resource units (TU) represented by the token (T) are not altered during transfer, this can be performed quickly and efficiently. In the case of static tokens, which are transferred as a whole, the tokenised resource units (TU) represented by the token (T) are not spilt, thus making the traceability back to the minting transaction efficient. In the case of dynamic tokens, in which a subset of the token units can be transferred, the total number of tokenised resource units (TU) in a transaction does not change, such that the net balance is zero, therefore making the traceability back to the minting transaction efficient. The blockchain record can be provably traversed until the minting transaction is reached, as illustrated in FIG. 8. The issuance data and/or minting record associated with the minting transaction can be checked to ensure that the token or number of token units transferred is a genuine, authorised token or token unit in accordance with an example of the present disclosure. Known techniques and technologies such as Simplified Payment Verification (SPV), Metanet graphs etc can be used in conjunction with one or more examples to further enhance efficiency and speed of verification or transfer, while preserving security.

According to another aspect of the invention, there resides a blockchain-implemented token generation, transfer and/or verification method. The method includes using, processing and/or generating a blockchain transaction. The transaction has one or more token-related outputs, each of which represents a respective token issued by a Token Issuer and specifies a quantity of a) token units and b) token-related cryptocurrency associated with the respective token. The transaction can also have at least one Issuer-related output comprising issuance data associated with the Token Issuer. The token value can correspond to a function of the cryptocurrency value e.g. satoshi value held in the token. During the creation of a token the authenticity can be established through a set of transactions, including at least one of: an inaugural transaction, which can be root node holding digital identities and/or digital signatures of the issuer and/or authority responsible for the tokens, which can also include additional signatures from, for example, a governmental or regulatory authority; a token definition transaction, that defines the tokens to be created, and their format, which can be a minting transaction, database establishment transaction or a device set-up record in a control system, said token definition transaction preferably referencing the inaugural transaction, and preferably defining an ‘establishment transaction’; and a token issuance transaction, wherein a token is transferred to a user, which preferably references the token definition transaction e.g. establishment transaction and/or the inaugural transaction. The inaugural transaction can include the at least one Issuer-related output (I-UTXO) comprising issuance data (IData) associated with the Token Issuer (TI).

A token's value, which can be represented by the token-units, can be the ‘status’ of the token, such that a token can have a ‘zero-satoshi’ status i.e. a zero-unit value, and that value can correspond to a function of the satoshis value held in the token—even if that value is zero. This can be achieved in the output script of a token transaction, which functions as a carrier of information and said information can carry a satoshi value even if that value is ‘zero’. The script on a token transaction output determines the actions to be taken e.g. how a token value to is to spent or processes, or transferred elsewhere.

An issuer may create sub-ledgers under which multiple sub-issuers are authorized to issue tokens that carry the same denominated token value, and these tokens can be used in transactions together, as long as there is a common parent issuer. A sub-issuer can be authorized to refresh a token by repeating the set of transactions, such that a recipient only needs to verify a linear transaction history of a token back to the most recent set of transactions.

Dynamic tokens hold a variable number of token units, which can be considered as analogous to varying levels of, for example, access to an asset or a resource, or even varying levels of permission to write data to a database. A dynamic token can also create a sub-token. Verifying a sub-token that has been derived from a dynamic token can include determining the linear transaction history back to at least one of (i) the most recent set of transactions that output or refreshed the dynamic token and (ii) the transaction in which the sub-token was created from a dynamic token. When a zero satoshi token is spent, the TX and VOUT that is being spent is referenced and the script solution is provided. This is a valid expression in the Bitcoin protocol and as such represents a valid spend event under a ruleset defined by the unbounded bitcoin protocol. While non-technical limits are in place to inhibit this function at the time or writing, this aspect can be implemented when said limits are lifted.

The transaction can further comprise: at least one input comprising a quantity of cryptocurrency; and/or at least one input comprising the issuance data. The Issuance data can be provided in the same or a different input that comprises the quantity of cryptocurrency.

The issuance data can comprise, or reference, a digital signature controlled by and/or associated with the Token Issuer.

At least one of the one or more token-related outputs can comprise a unique token identifier (tokenID) associated with the token represented by the token-related output.

The blockchain transaction can further comprise at least one input and/or output comprising token generation data relating to the one or more Token-related outputs.

The method can further comprise the step of: using a token transfer transaction to transfer control, to a recipient, of: a static token having a fixed quantity of token-related cryptocurrency (TRC) represented by one of the one or more token-related outputs; and/or a dynamic token, having a changeable quantity of token-related cryptocurrency (TRC) represented by one of the one or more token-related outputs; and/or a sub-token, derived from a dynamic token, having a quantity of token-related cryptocurrency represented by one of the one or more token-related outputs.

During a blockchain-implemented token transfer and/or verification method the step of using and/or generating a blockchain transaction (TokenTx) comprises an input which includes a token. The token can be linked in a linear transaction history on the blockchain to a token-issuing blockchain transaction. The token-issuing blockchain transaction include, or be derived from at least one Issuer-related output (I-UTXO) associated with issuance data (IData) relating to a Token Issuer (TI) that Issued the token (T), which can be part of the set of transactions that established and/or refreshed the token. The token can comprise a quantity of token units (TU) specified in a token-related output (T-UTXO) of the token issuing blockchain transaction (MTx). The token can also include token-related cryptocurrency (TRC). The token-issuing transaction can be part of a set of transactions, which can include at least two of the inaugural transaction, token definition transaction and the token issuance transaction.

The method can further comprise the step of: using at least one further token transfer transaction to transfer control of a particular token (sT) to the same or a further recipient. The method can further comprise the step of: providing a solution in an unlocking script of an input in the token transfer transaction (TTTx) or at least one further token transfer transaction (TTTX1) to a locking script of the token-related output (T-UTXO, sT-UTXO) that represents the particular token or tokens (sT).

The method can further comprise the step of: using at least one further token transfer transaction (TTTX1) to transfer control of a portion of the quantity of token-related cryptocurrency (TRC) associated with the respective dynamic token (dT) to the same or a further recipient.

The method can further comprise the step of: providing a solution in an unlocking script of an input in the token transfer transaction (TTTx) or at least one further token transfer transaction (TTTX1) to a locking script of the token-related output (T-UTXO, dT-UTXO) that represents a portion of the quantity of token-related cryptocurrency (TRC) associated with the respective dynamic token (dT).

The method can further comprise the step of: providing a physical representation of at least one of the respective tokens, or portion thereof, represented by the one or more token-related outputs (T-UTXOs); preferably wherein the physical representation comprises means for identifying the at least: one respective static token (sT); and/or a portion of the quantity of token-related cryptocurrency (TRC) associated with the respective dynamic token (dT).

The method can further comprise the step of destroying the token (sT, dT) by at least one of: removing it from a computer-based storage resources such as a token register; publishing data relating to the destruction of the token; and spending an unspent transaction output (UTXO) that comprises token generation data e.g. a minting record (MR) relating to the one or more Token-related outputs (T-UTXOs).

The method can further comprise the step of: submitting the blockchain transaction (MTx) to a blockchain network.

According to another aspect of the invention, there resides a blockchain-implemented (i) transfer of a token and/or a token unit therein, wherein the token is at least one of a token and/or sub-token and/or (ii) verification method comprising the step of using and/or generating a blockchain transaction (TokenTx) comprising an input from a token (T) or a sub-token. The token and/or sub-token can be linked in a linear transaction history on the blockchain to a token-issuing blockchain transaction (MTx) which comprises at least one Issuer-related output (I-UTXO) associated with issuance data (IData) relating to a Token Issuer (TI) that Issued the token (T). The token or sub-token can comprise a quantity of: token units (TU) specified in a token-related output (T-UTXO) of the token issuing blockchain transaction (MTx); and/or token-related cryptocurrency (TRC).

The method can be used and/or generated by a computing resource that is arranged to implement a tier-2 blockchain tokenisation protocol. Referring to the OSI layer definitions, the existence and validation of the base cryptocurrency used within a token transaction is determined at ‘layer 1’, by data stored within a blockchain node. The determination of the authentication of a token and the definition of the assets it represents can be determined at ‘layer 1’ because said determination is based on the stored data. The management of the base cryptocurrency i.e. the UTXO, communication between nodes and the protocol for processing and creating script occurs at ‘layer 2’. The quantity of token-related cryptocurrency (TRC) can be fixed such that it remains the same upon spending the input to an output (UTXO).

The method can further comprise the step of transferring the token (T) from a Sender (S) to a receiver (R) by: spending the output (UTXO) of the blockchain transaction (TokenTx) to an input (I) in a receiving blockchain transaction (RTx), wherein an index or other identifier associated with the output (UTXO) corresponds to an index or other identifier associated with the Input.

The input can be from a token (dT) having a changeable quantity, wherein a portion of the quantity of token-related cryptocurrency (TRC) associated with the respective token (dT) is transferred.

The method can further comprise the step of transferring a portion of the quantity of token-related cryptocurrency (TRC) associated with the respective dynamic token (dT) from a Sender (S) to a receiver (R) by: spending the portion (UTXO) of the blockchain transaction (TokenTx) to an input (I) in a receiving blockchain transaction (RTx), wherein an index or other identifier associated with the output (UTXO) corresponds to an index or other identifier associated with the Input.

The sum of the quantity of token-related cryptocurrency (TRC) input to transaction can be equal to the sum of the quantity of TRC output from the transaction—the sum of the input is preferably equal to the output.

The method can be configured such that during a transaction between a sender (S) and a receiver (R), the sender (S) has a dynamic token (dT) having an initial quantity and spends a first portion of the quantity to a transaction (SVin) and receives the difference between the initial quantity and the first portion as an output (SVout) from the transaction, and the receiver (R) has a dynamic token (dT) having an initial quantity and spends said quantity input to a transaction (RVin) and receives an output (RVout) from the transaction equal to the sum of his initial quantity plus the first portion of the quantity (SVin) spent by the sender.

According to another aspect of the invention, there resides a blockchain-implemented token refresh or update method comprising: using, processing and/or generating a blockchain transaction (MTx) having: one or more token-related outputs (T-UTXOs), each of which represents a respective token (T) or sub-token issued and/or permitted by a Token Issuer (TI) and specifies a quantity of a) token units (TU) and b) token-related cryptocurrency (TRC) associated with the respective token (T). The token can represent a quantity of tokenised asset or resource of some type. The tokenised asset/resource may be expressed as a quantity of token unit(s). The method further includes authenticating the token by determining a relationship with a set of transactions that established the token, said set including at least one of an inaugural transaction, token definition transaction and the token issuance transaction. The token transaction can include at least one Issuer-related output (I-UTXO) comprising issuance data (IData) associated with the Token Issuer (TI). The set of transactions can include the at least one Issuer-related output. The token and/or sub-token can be linked in a linear transaction history on the blockchain to the set of transactions that established the token. The issuance data (IData) can comprise, or reference, a digital signature controlled by and/or associated with the Token Issuer (TI).

Determining the authenticity of a token can be achieved by determining a relationship with the issuer and/or authority that created the token in a set of transactions at the beginning of a linear transaction history i.e. writechain. In other words, a relationship between the token and its history of transactions can be determined. If a token has been used in many transactions, typically 100 or more, or 1000 or more, the linear transaction history takes longer to verify. A token can be returned by spending it back to the issuer, the token destroyed, and a new token of equivalent value or access issued in its place.

Alternatively, an existing token can be updated, wherein the token is spent into a transaction that is signed by the signature of the at least one of the inaugural transaction, token definition transaction and the token issuance transaction, such that the authenticity of the token is refreshed. An update includes a re-mint without destruction of the token and/or its linear transaction history. The linear transaction history can, therefore, include two or more of the sets of transactions, which can include at least one of the inaugural transaction, token definition transaction and the token issuance transaction. By processing the token with a second or subsequent one of the set of transactions a recipient of the token only needs to determine the validity of the token by referring to one or more of the most recent inaugural, definition or issuance transactions. The set, or part thereof, can be referred to as the minting transaction, and an updated token's linear transaction history can include two or more minting transactions i.e. an initial minting transaction and a subsequent re-minting. Updating, therefore, avoids the need to at least one of removing it from a computer-based storage resources such as a token register, publishing data relating to the destruction of the token, spend an unspent transaction output (UTXO) that comprises token generation data (MR) relating to the one or more Token-related outputs (T-UTXOs) and/or issue an equivalent token in exchange for a token.

According to another aspect of the invention, there resides a blockchain-implemented token generation, transfer and/or verification method of performing a blockchain transaction (MTx) having one or more token-related outputs (T-UTXOs), each of which represents a respective token (T) or sub-token issued and/or permitted by a Token Issuer (TI), wherein the linear transaction history of the respective token or sub-token comprises two or more sets of transactions that authenticate a token, wherein the or each set of transactions includes at least one of: an inaugural transaction or root node; a token definition transaction for defining the token to be created; and a token issuance transaction, wherein a token is transferred to a user the inaugural transaction can include at least one Issuer-related output (I-UTXO) comprising issuance data (IData) associated with the Token Issuer (TI).

The set of transactions can at least one of: holding digital identities and/or digital signatures of the issuer and/or authority responsible for the tokens, which can also include additional signatures from, for example, a governmental or regulatory authority; and function as a minting transaction, database establishment transaction or a device set-up record in a control system.

A first transaction set that can be used to authenticate a token can be actioned by the issuer and/or authority supporting the tokens, while a second set can be actioned by a node or a wallet acting on behalf of the issuer and/or authority.

By updating a token its linear transaction history can be maintained, although only part of said history is required to authenticate the token e.g. the most recent set of transactions. Updating a token maintains its identity with all characteristics maintained, such that an update is backwards compatible, which is important for the maintenance and continued operation of tokens used for the establishment of transactional databases and/or control systems. The update can use a re-mint action while avoiding a return to the issuer.

A recipient of a token unit can verify the authenticity of a token unit by performing a validation check e.g. a Merkle proof with one or more of the set of transactions. As the transaction history becomes longer a recipient of an updated token only needs to validate e.g. using a Merkle proof, back to the most recent set of transactions that updated the token with an issuer and/or authority signature. Therefore, authenticity can be determined during the transfer of a token can be achieved by linking of the input of the transaction containing the token to an output of the transaction, or through other mechanisms such as, for example, a signature or identifier placed into the locking script of the new UTXO that holds the token.

Overall, updating a token keeps the same tokens in existence while minimising the overhead needed to handle the simplification of the verification process. The overhead is minimized because the refreshing can be implemented in a single transaction and avoid the need for the creation of a melt record and/or other associated transaction costs associated with a full minting transaction, such as new token creation or re-minting. In an update transaction the linear history can be re-set such that the authentication of a refreshed token only needs to follow the linear transaction history back to the most recent refresh transaction.

According to another aspect of the invention, there resides a blockchain-implemented method of creating a sub-token from a dynamic token during a transaction, the method including receiving into the transaction a dynamic token (dT) having a changeable quantity of token related cryptocurrency, wherein the value of token units is a function of token related cryptocurrency held therein, and creating in a new output a sub-token. The sub-token can have a value of token units that is a function of token related cryptocurrency derived from the dynamic token, wherein the sub-token is transferable and/or spendable into a dynamic token in a further trans action.

The sub-token can have secondary function configured in script to determine the asset or resource secured by the sub-token. The sub-token can have at least one of: static values; dynamic values; the authority to write data to establish a transactional record of data, such as information and/or instructions e.g. for a transactional database (including the sub-division of those assets); and the status of a device or system having a device. The status of an asset can be analogous to the status of a machine. The status can be at least one of the operation, and data that determines the configuration of the asset or resource.

The dynamic token input to the transaction can provide the value of token units that is a function of token related cryptocurrency to the sub-token. The creation of a sub-token can be managed independently of the minting transaction that created the dynamic token from which it is derived. The sub-token can have a relationship with the dynamic token from which it is derived e.g. through the transaction identifier.

A sub-token can be transferred. When the function of sub-token expires, or is removed e.g. spent, then the function of the sub-token reverts to the form of the token from which it was derived e.g. it reverts to a dynamic token.

The dynamic token and the sub-token can be linked in a linear transaction history on the blockchain to a token-issuing blockchain transaction (MTx) which comprises at least one Issuer-related output (I-UTXO) associated with issuance data (IData) relating to a Token Issuer (TI) that Issued the token (T). The token-issuing blockchain transaction (MTx) can contain, or provide links to, issuance data and/or the authority certificate of the issuer. The issuer may delegate, through sub-ledgers, the authority to issue tokens, wherein multiple sub-issuers are authorized to issue tokens that carry the same denominated token value. Tokens derived from a common parent issuer can be used in transactions together.

The dynamic token and the sub-token can comprise a quantity of: token units (TU) specified in a token-related output (T-UTXO) of the token issuing blockchain transaction (MTx); and/or token-related cryptocurrency (TRC).

The quantity of the sub-token that can be derived from the quantity of the dynamic token is limited to the maximum value of the dynamic token. The sub-token can be transferrable, independently of the dynamic token from which it was created, in a digital or physical form.

The sub-token can be a second-order sub-token having a secondary function providing conditional access to a resource and/or value, in addition to the value of token units that is a function of token related cryptocurrency provided therein, when spent into a further dynamic token.

The secondary function can unlock further conditional access to a resource and/or value when used together with another second-order sub-token. The sub-token can have one of: a static value; a dynamic value; or a zero-unit value, e.g. a zero-satoshi value. The sub-token can be configured for single-use or be programmed to have a set number of uses.

The creation of the sub-token can include: a token-related outputs representing the sub-token issued by the dynamic token and can specify a quantity of a) token units (TU) and b) token-related cryptocurrency (TRC) associated with the respective token; and creator-related data associated with the respective creating dynamic token.

The method can include performing a transaction involving the transfer of a quantity of token units (TU) between a first dynamic token and second dynamic token of a user, such that the linear chain of history that ties a user to their first dynamic token and/or the value within that first dynamic token is removed.

The transfer can include a quantity of token units (TU) of the first dynamic token being input (Vin) to a transaction and being assigned to a different output (Vout). As a consequence, if two dynamic tokens of the same type are used in a token transaction then swapping inputs and outputs obfuscates which party held which token from a subsequent scan of the linear transaction history. In other words, if one party in a transaction were to hold significant assets then swapping inputs and outputs means that a scan of the history reveals that one party had significant assets, but not the party, at any given moment. Therefore, a recipient is unable to look back to see what assets another party held previously.

The method can include a sender having a first dynamic token (dT1) and a second dynamic token (dT2), and performing a transfer of a quantity from the first dynamic token (dT1) to the second dynamic token (dT2) in a first transaction, and transferring a portion of the quantity of the second token (dT2) to a receiver in a second transaction.

According to another aspect of the invention, there resides a digital wallet arranged and configured to use or process the aforementioned method.

According to another aspect of the invention, there resides a computer implemented method comprising the step of: generating, storing, processing and/or maintaining a computer-based resource (R) of a plurality of token-related blockchain transaction outputs (T-UTXOs), wherein each of the outputs (T-UTXOs): provides a respective token (T) issued by a Token Issuer (TI) and specifies a quantity of a) token units (TU) and b) token-related cryptocurrency (TRC) associated with the respective token (T); and has a linear transaction history to a blockchain transaction (MTx) that comprises at least one Issuer-related output (I-UTXO) which includes issuance data (IData) associated with the Token Issuer (TI).

According to another aspect of the invention, there resides a computer implemented method comprising the step of: transferring a token or token unit and/or verification, the method comprising the step of using and/or generating a blockchain transaction (TokenTx) comprising an input from a token (T) which is linked in a linear transaction history on the blockchain to a token-issuing blockchain transaction (MTx) which comprises at least one Issuer-related output (I-UTXO) associated with issuance data (IData) relating to a Token Issuer (TI) that Issued the token (T); and comprises a quantity of: token units (TU) specified in a token-related output (T-UTXO) of the token issuing blockchain transaction (MTx); and token-related cryptocurrency (TRC).

The computer-based resource (R) can be generated, stored, processed and/or maintained off-chain. Moreover, the computer-based resource (R) can be deterministically recreated from the digital ledger/blockchain. The or each token-related blockchain transaction output (T-UTXO) can be generated and/or spent by a computing component arranged to implement a tier-2 blockchain tokenisation protocol and comprises at least one partially signed locking script.

The method can further comprise the step of: receiving, at the computer-based resource (R) from a sending device (S), a token (T) provided by one of the plurality of token-related blockchain transaction outputs (T-UTXOs); storing at least one Token (T), received from a sending device, in the computer-based resource (R); and/or sending at least one Token (T) to a receiving device, wherein the token is provided by an output (T-UTXO) selected from the resource (R) of token-related blockchain transaction outputs (T-UTXOs).

According to another aspect of the invention, there resides a digital wallet arranged and configured to use, process or perform a token transaction for a static, dynamic or sub-token as taught herein.

According to another aspect of the invention, there resides a computer network comprising a plurality of nodes, wherein each node in the computer network comprises: a processor; and memory including executable instructions that, as a result of execution by the processor, causes the system to perform the aforementioned method.

According to another aspect of the invention, there resides a non-transitory computer-readable storage medium having stored thereon executable instructions that, as a result of being executed by a processor of a computer system, cause the computer system to perform the aforementioned computer-implemented method.

Overall, the or each token described and claimed herein provides a cost-effective and secure access to a resource. Many of the examples relate to digital and fungible currency units, and the invention is not limited thereto because it provides analogous control of access to assets in a secure manner. The tokens come in various formats according to the access requirements and levels of access and/or control to be provided.

The tokens can improve upon existing means for accessing a resource by improving the security level and/or traceability of said assets or permission granted. The implementation of the tokens herein can use a known blockchain, such as the BSV blockchain and associated protocols, such as the Metanet protocol, although these are referred to by way of example and other blockchains and protocols can be used.

The tokens as described and claimed herein can utilise cryptocurrencies and their platforms to provide ‘keys’ that are, amongst other things, more secure, efficiently transferrable, efficiently authenticated and in some formats provide additional and/or conditional access and functionality.

According to another aspect of the invention, there resides a blockchain-implemented database generation, modification and/or verification method comprising: using, processing and/or generating a blockchain transaction having that outputs data that includes instructions to at least one creation and/or modify a database, format or re-format a database, add or delete content from a database. Tokens are used to create transaction having outputs, which can be retrieved and used as instructions for a database. The outputs can be defined in the output script of the token transaction. The instructions, which can determine the content of a database, can have outputs that are dead-ends, such that they are not processed any further on the ledger—in other words, said token transactions are said to be ‘hanging’, such that the tokens associated with outputting data for a database can be referred to as hanging tokens. Any of the tokens herein can be configured to be recognisable by a database compiler and provide instructions.

According to another aspect of the invention, there resides a blockchain-implemented database generation, modification and/or verification method comprising: using, processing and/or generating a blockchain transaction (MTx) having: one or more token-related outputs (T-UTXO), each of which represents a respective token (T) issued by a Token Issuer (TI) and specifies a) at least one of a database format, entity and parameter and/or data related to the creation and/or modification of said database, and b) a quantity of token-related cryptocurrency (TRC) associated with the respective token (T).

Each subsequent transaction by a token can be referred to as a child transaction, the preceding transaction referred to as a parent transaction. The parent and child transactions define, at least in part, a writechain of transactions that have output, or written, data to the ledger, such as a cryptocurrency ledger e.g. a cryptocurrency blockchain.

The first transaction in a writechain can contain at least one of: the root node, which can be the inaugural transaction; minting transaction, which can be the token issuance transaction; and database establishment transaction, which can be the token definition transaction, each of which can be provided at a later time in the writechain. In other words, while their actions can reside in a single transaction, or occur substantially simultaneously, these transactions can occur in succession. The or each transaction in a writechain can contain a deterministic link to at least one of the root node, minting transaction and database establishment transaction or contain information, that enables such a link to be determined e.g. using a Merkle proof.

The database establishment record can be used to establish a database. It can reside in the output of a first transaction in a writechain, or in a child transaction. Additionally or alternatively, a log of the minted tokens can be compiled during a minting transaction. This log is a record of what tokens were created along with the status and any other details, such as the format of the database being created or the database that it is to be associated with. Therefore, when the database management system builds a transactional database from one or more writechains it can use the log to associate tokens with content. The log can also be used to search for and identify token transactions on the token ledger and selectively process their transaction output.

It is to be noted that each of the tokens disclosed herein, which have a determinable linear transaction history through their relationship with a minting transaction, such as the static, dynamic and sub-tokens, can be used to create a transaction output and, therefore, can function as ‘hanging’ tokens. This can be achieved by a token transaction output including, for example, instructions or information to be stored on-chain in relation to said token transaction.

The output from a token transaction can further include at least one Issuer-related output (I-UTXO) comprising issuance data (IData) associated with the Token Issuer (TI). The transaction (MTx) can further comprise: at least one input comprising a quantity of cryptocurrency (C); and/or at least one input comprising the issuance data (IData), preferably wherein the Issuance data is provided in the same or a different input that comprises the quantity of cryptocurrency (C).

The method can further comprise the step of using a token transfer transaction (TTTX) to transfer control, to a recipient, of a token (T) having a quantity of token-related cryptocurrency (TRC). By way of example, after a token has been minted under the control of an issuer it can be passed on for the management of recording information on transaction outputs by making transactions with the token.

The token-related output can comprise a mint record of the or each token. At least one of the mint record, database establishment record and an authorisation key, can be configured to provide said blockchain transaction with a status level. The subsequent deterministic compilation of a database using the transaction outputs can refer to one or more of these factors to determine a priority level of a token e.g. a master token can have priority over, and overwrite, an output from a lower level write token. The status level can be determined from at least one of the script in the transaction output and a record held by the database management system that can determine from the linear transaction history the level of authority provided to a token e.g. when it was created.

The database establishment record can include at least one of: ownership information; name; type; and attributes of the database. The attributes can be the number of rows and columns in a relational database. The attributes can be the nodes and edges of a graphical database.

The database establishment record can determine the format of at least one of, but not limited to: a Hierarchical database, network database, relational database, object-oriented database, graph database, ER model database, document database and NoSQL database.

The or each token related output can define a further database establishment record, thus creating a further database and/or at least one new token-related output (T-UTXO).

The or each token related output can define the information related to the modification of the table and/or database, the information comprising at least one of (i) amending by adding, deleting or updating and (ii) modifying at least one of a row, column or record. The information can be data in the form of an instruction. The instruction can be in the form of a digital code that a database compiler can understand.

The token related output can determine an administration token, and the creation thereof, said administration token authorised to at least one of: administer and write database content that was created by said administration token or a write token derived from said administration token, thus enabling the administration token to output an instruction to modify the database. In relation to administration and/or write tokens, said administration token can create a new token in an output, nullify a token and/or modify a token's authorisation. Said administration token can create a write token (wT) and/or another administration token, from the administration token, said write token having a quantity of token-related cryptocurrency (TRC) represented by one of the one or more token-related outputs (dT-UTXOs), and said write token having write-only authorisation over the database content. Said administration token can generate a minting record when creating a token.

The token related output can comprise: a write token, said write token having a quantity of token-related cryptocurrency (TRC) represented by one of the one or more token-related outputs (dT-UTXOs); and an instruction to modify the database, said write token having write-only authorisation over the database content.

In general, the authorisation level of a token can be determined from the minting transaction and/or the order of token creation and/or the database establishment records, which can be derived from the token identity or by the database compiler retrieving said information from the issuer. The database compiler can be the database management system that can retrieve all the required information from a token transaction its writechain history, which lies on the token ledger. To be clear, the status and the ability of instructions output therefrom to modify a database can be determined when a token is created, or subsequently when the status is changed by a higher-order token. This information is held in the minting transaction and/or the database establishment record—which the database compiler and management system can retrieve from the ledger and/or obtain directly from the issuer of the token or tokens. The content of a transactional database can be encrypted. Encryption can be implemented, by way of example, using the keypairs that create each transaction as ECC keys. Using key generation and management, the owner of a database can recover any key combination used in the database from a single master keypair. It is also possible to create a transactional database that contains a combination of encrypted and unencrypted write chains, or even to encrypt individual transactions or parameters within transactions. This can be entirely at the user's discretion. Users who control a write chain can be inhibited from viewing encrypted data from another writechain, such that they would only be able to access the data on the other writechain with the private key used to encrypt that data. Threshold keys can be used in order to allow multiple users to encrypt and view data across multiple chains with discretionary provisions.

The database management system can hold a private key or root private key corresponding to the chain of data being generated in the database through token transactions, which would allow it to decrypt the information. Said keys can be different keys to the keys being used to generate the transactions, allowing for the data source to be separate from the database management system, creating a security shell.

The token related output can comprise a master token, said master token having at least one of: authorisation to create a write token (wT) having a quantity of token-related cryptocurrency (TRC) represented by one of the one or more token-related outputs (dT-UTXOs), said write token having write-only authorisation over the database content. The master token can have authorisation to create an administration token (aT) having a quantity of token-related cryptocurrency (TRC) represented by one of the one or more token-related outputs, said admin token having administration and write authorisation over the database; administration and write authorisation over any database content (mT) by outputting information that includes an instruction to modify the database, said instruction configurable to at least one of: add, modify or remove any token derived therefrom, such as an admin token or a write token; and modify or undo any action taken by a token, such as an admin token or a write token, upon the database.

The or each token can have a changeable quantity of token-related cryptocurrency (TRC) represented by one of the one or more token-related transaction outputs. Tokens having a changeable quantity of TRC can utilise the TRC to determine its value. Therefore, a token can be configured such that the TRC of a token is blocked from paying the transaction fees unless the fees are being paid in the same base token unit as the TRC e.g. satoshis represents.

A node that receives a token e.g. as payment, can be enabled with the rights to re-mint the tokens in their coinbase transaction. Alternatively, this can be achieved via a contract with issuer that states the issuer will re-mint new tokens for node in exchange for the fees received.

Preferably, tokens for outputting instructions for a transactional database have a static value.

The blockchain transaction can be a minting transaction defining a root transaction. After the database establishment record and transaction output that can represent a respective token (T), a subsequent blockchain transaction can be derived from a previous transaction, which can be a parent transaction, wherein said subsequent blockchain transaction includes an output including a database instruction.

The subsequent blockchain transaction can also include at least one of: a corresponding signature of the public key from the parent transaction; a unique identification, including a signed public key of the parent transaction; creating an edge connection with a previous transaction; and an identification of the previous transaction. The subsequent transaction, which refers to the previous transaction via an edge, can define, at least in part, a writechain.

The subsequent blockchain transaction can include data associated with a previous transaction, including at least one of: a public key of the transaction, and a unique identification; an input, including a signed public key of a previous transaction, creating an edge connection with a previous transaction; an identification of a previous transaction; and an output including an update to a parameter of the database and/or a database instruction.

The previous transaction can be a parent transaction. However, the previous transaction is determined by the purpose of the child transaction and the instruction output. For example, if the instruction provides the latest information on an asset then the transaction edge will refer to the most recent transaction, but if a specific update or correction is required then the transaction edge refers to the transaction in which a specific instruction requires updating i.e. the edge refers to a previous transaction.

A database instruction means an output from a transaction that contains data or information that includes an instruction to modify a database, said instruction configurable to at least one of: add, modify or remove any token derived therefrom, such as an admin token or a write token; and modify or undo any action taken by a token, such as an admin token or a write token, upon the database.

The edge connection can be configured as at least one of:

a dynamic transaction edge, referencing a previous transaction, which can be a parent transaction, in which a database entity is created, wherein data or content retrieved by querying this dynamic transaction edge is the most recent data added to the database entity;

a static transaction edge, referencing the transaction in which a database entity was created, and a further transaction that updated said transaction, wherein data or content retrieved by querying a static transaction edge references the transaction in which a database entity was created, and/or a further transaction that updated said transaction, wherein data or content retrieved by querying a static transaction edge is the referenced version of the database entity;

a dynamic parameter edge, referencing a transaction in which a database entity was created, wherein content retrieved by querying the dynamic parameter edge is the most recent version of a parameter of the database entity;

a static parameter edge, referencing (i) the transaction in which a database entity was created and a parameter added thereto, and (ii) a further transaction that updated said parameter of the entity, wherein the data retrieved by querying the static parameter edge references the transaction in which a database entity was created, and/or a further transaction that updated said transaction, wherein data or content retrieved by querying a static transaction edge is the referenced version of the database entity.

In other words, a static edge always returns the same information, while a dynamic edge receives the most recent update.

The or each edge can be a parameterised edge that references data outside the database, wherein the edge includes a specification for a wrapper. A wrapper can be used to provide a subroutine, which can be from a software library or a computer program, whose main purpose is to call a second subroutine or a system call with little or no additional computation. In other words, the wrapper encapsulates another item.

In this way, a blob of data can be retrieved inside a Tokenized message, a HTML table, JSON header and footer, or any other wrapper, giving users the ability to create nodes that serve wholly complete documents or web pages in native formats when linked or queried. In this way, the same source data can be made available in multiple formats for purposes such as creating EDI transactions or serving different streams of data. By simply adding a ‘query node’ with several edges back to the same node, each with a different wrapper type.

The or each edge can be a query inclusive edge, wherein the returned data is the result of a plurality of queries. Therefore, when the edge is queried, the returned data is the result of another query. For instance if a node is being constantly updated with new data (e.g. hourly temperature) the edge can be programmed to return the 24 most recent updates, or the highest and lowest temperatures in the last 7 days. By setting up a query inclusive edge inside a parametrised edge, this data can be wrapped in HTML and served as part of a rich browsing experience.

Each subsequent blockchain transaction that relates to its parent transaction can define, at least in part, a writechain. Each subsequent blockchain transaction on the writechain can include a transaction output that depends therefrom and determines the updates and/or instructions that determine the content of the database.

The root of a writechain can be the database establishment transaction. The root of a writechain can also be the point at which a new token is created.

A transaction output can include information that includes an instruction to modify the database, wherein said transaction output is a terminal output, such as a FALSE RETURN, but not limited to a FALSE RETURN script. One or more outputs can be something other than a FALSE RETURN script. For example, an output can be configured to write data and/or simultaneously transferring asset value.

The transaction output can be encrypted. The transaction output can be locked by multiple entities using digital signatures e.g. an OP_CHECKMULTISIG script, or in a threshold signature scheme, or in an accumulator multisignature scheme, or in some other type of scheme that uses shared secrets or other techniques to allow multi party participation.

A transaction output can include a token that requires a form to be submitted adhering to a specific formula or layout, where the token's script is performing an analysis of the form and ensuring that all of the required conditions of the form e.g. a contract or agreement, have been entered correctly and signed by the appropriate parties. The form can include a template portion and blanks for completion by a recipient of the token, wherein completion of said blanks is implemented in one or more subsequent transaction outputs of the token. In other words, a transaction output can include a token that requires a form to be submitted adhering to a specific formula or layout, where the token's script is performing an analysis of the form and ensuring that all of the required conditions of the contract or agreement have been entered correctly and signed by the appropriate parties.

The form can be an agreement to be completed and/or signed, such as a contract. The output can include completing a blank by digitally signing an output of the form token, thus digitally signing, at least in part, the form. The blanks can be completed using at least one of: providing an identification and a public key; a countersignature of a third party; and a Merkle proof that it is part of a Merkle tree and further providing (i) a Merkle proof that the identification is one of a Merkle tree identifications and (ii) a script that can solve the Merkle root. At least a portion of a body of the form can be a hash of its string and/or content. as an input to a transaction, such that it can be processed by script. Additionally or alternatively, the template of the body can be provided in an establishment transaction or a set-up record. The template of the body can be provided as part of the database establishment transaction. The template form, at least in part, can support a Ricardian contract. A Ricardian contract is a method of recording a document as a contract at law, and linking it securely to other systems, such as accounting, for the contract as an issuance of value.

The database establishment record can include data in the form of an existing database, which defines at least one of the database format, database content, database entity and parameter and/or information related to the modification of said database. The data can take the form of a set of instructions that enable a database management system to compile a database, existing or otherwise. The token-issuing blockchain transactions (MTx) in the writechain can provide instructions for expanding an existing database. To be clear, a pre-existing database can be formatted and packaged in a database establishment transaction and a token minted in association with the pre-existing database. With the knowledge of the parameters of the pre-existing database, the token can be used to update, modify etc said database. This enables an existing database to be seamlessly transferred on to a blockchain without interruption to its maintenance because the ledger infrastructure already exists and is scalable, while a newly created token can immediately begin to create transaction outputs having data in the form of instructions that can maintain the database.

According to another aspect of the invention there is a method of determining and/or amending a database from at least one blockchain-implemented transaction, the method comprising: retrieving data from a plurality of token transactions in a writechain from a blockchain, said write chain including a token-issuing blockchain transaction (MTx), wherein said data includes: a token-related output (UTXO), which represents a respective token (T) issued by a Token Issuer (TI) and specifies a) at least one of a database format, entity and parameter and/or information related to the modification of said database, and b) a quantity of token-related cryptocurrency (TRC) associated with the respective token (T); and determining and/or amending the database using the chronological order of the transaction data in the writechain. The data retrieved includes data output from transactions. The blockchain can be a cryptocurrency ledger and/or a token ledger. The token-issuing blockchain transaction can include at least one Issuer-related output (I-UTXO) associated with issuance data (IData) relating to a Token Issuer (TI) that Issued the token (T).

Tokens are used to create the transaction data as outputs, which can be retrieved and used as instructions for a database. The instructions, which can determine the content of a database, can have outputs that are dead-ends, such that they are not processed any further on the ledger—in other words, said token transactions are said to be ‘hanging’, such that the tokens associated with outputting data for a database can be referred to as hanging tokens. The data can further include at least one of a database establishment record (token definition transaction), inaugural transaction and token issuance transaction.

The writechain can include at least one of: an Issuer-related output (I-UTXO) comprising issuance data (IData) associated with the Token Issuer (TI); at least one input comprising a quantity of cryptocurrency (C); at least one input comprising the issuance data (IData), preferably wherein the Issuance data is provided in the same or a different input that comprises the quantity of cryptocurrency (C); a mint record of the or each token; an authorisation key, said key configured to provide said blockchain transaction with a status level; and a database establishment record including at least one of: ownership information; name; type; and attributes of the database.

The data retrieved from the writechain can include a token related output defining a table of the database. The data retrieved from the writechain can include a token transaction output defining information related to the modification of the table and/or database. By way of example, the information can comprise an instruction to at least one of amend a database by adding, deleting or modifying at least one of a row, column or record.

The data retrieved from the writechain transaction can include a token transaction output defining at least one of: creation of the database format and/or a master token, wherein the database format and/or parameters includes at least one of the database name, ownership rights and wrapper; an administration writechain, including an administration token, wherein the parameters and/or output of the token define access rights and/or authorisation levels; a modification of access rights of any token derived therefrom on the writechain; creation of a further writechain, including a further token, said token assignable to a person and/or a process; creation of an entity of the database, wherein the entity is assigned a name and/or reference; an update to an entity of the database, wherein a new parameter is added to the database and/or an existing parameter is updated; a termination output indicating that any further transaction from said token is null and void, thus indicating the end of the writechain

At least one of the creation, modification and termination of an entity and/or parameter of the database can be established in an output of a token transaction. Said output contains data providing an instruction to the database compiler. The or each output can be an individual FALSE RETURN output.

The token related output can determine a write token, i.e. the creation of a write token, said write token having a quantity of token-related cryptocurrency (TRC) represented by one of the one or more token-related outputs (dT-UTXOs), and said write token having write-only authorisation over the database content.

The token related output can determine an administration token, i.e. the creation of a write token, said administration token authorised to at least one of: administer and write database content that was created by said administration token or a write token derived from said administration token, thus enabling the administration token output to modify the database, including, in relation to administration and/or write tokens, create a new token in an output, nullify a token and modify a token's authorisation; and create a write token from the administration token in a subsequent blockchain transaction, said write token having a quantity of token-related cryptocurrency (TRC) represented by one of the one or more token-related outputs (dT-UTXOs), and said write token having write-only authorisation over the database content.

The token related output can determine a master token, i.e. the creation of a master token, said master token having at least one of: authorisation to create a write token (wT) having a quantity of token-related cryptocurrency (TRC) represented by one of the one or more token-related outputs (dT-UTXOs), said write token having write-only authorisation over the database content; authorisation to create an administration token (aT) having a quantity of token-related cryptocurrency (TRC) represented by one of the one or more token-related outputs, said admin token having administration and write authorisation over the database; administration and write authorisation over any database content (mT); authorisation to add, modify or remove any token derived therefrom, such as an admin token or a write token; and authorisation to modify or undo any action taken by a token, such as an admin token or a write token, upon the database.

Each instance of token creation can be accompanied by at least one of a minting transaction, database establishment transaction and device set-up record. A token is created on the output of a transaction. Additionally or alternatively, an instance of token creation can be determined from an edge connection with an issuance transaction. The initial transaction in a writechain can be a minting transaction defining a root transaction. A token's provenance can be determined by tracing the series of transactions it has made in the writechain back to the minting transaction and/or a database establishment transaction.

A master token can be derived from the output of a genesis transaction, which is a root transaction for all tokens derived therefrom. A genesis transaction can be the root node on a token ledger. An administration token can be derivable from (i) a genesis transaction, or (ii) a subsequent transaction output from an administration token, the transaction defining a root transaction for all tokens derived therefrom. A write token can be derivable from (i) a genesis transaction, or (ii) a subsequent transaction output from an administration token, the transaction defining a root transaction for said write token.

The subsequent blockchain transaction can include data associated with a previous transaction, including at least one of: a public key of the transaction, and a unique identification; an input, including a signed public key of a previous transaction, creating an edge connection with a previous transaction; an identification of a previous transaction; and an output including an update to a parameter of the database and/or a database instruction.

Each subsequent token transaction can be considered a child transaction that depends from a previous transaction, which can be a parent transaction. Each child transaction on the writechain has an edge connection with a previous token transaction

The or each edge can be a parameterised edge that references data outside the database, wherein the edge includes a specification for a wrapper; and/or the or each edge can be a query inclusive edge, wherein the returned data is the result of a plurality of queries.

The determination of a database from blockchain-implemented transactions can include retrieving data from at least one of: a master writechain, originating from a genesis transaction, and including an output having (i) the database establishment record and (ii) at least one of a database format, entity and parameter and/or information related to the modification of said database; an administration writechain, originating from an administration token, and including an output having (i) the database establishment record and (ii) at least one of a database format, entity and parameter and/or information related to the modification of said database; a data entry writechain, originating from a write token, and including an output having at least one of a parameter and/or information related to the modification of said database.

The compilation of a database from blockchain-implemented transactions can include data, said data: determining through validation whether the criteria for a multiple-signature verification has been met by at least M signatures signing a set of N public keys using an operation-code, said operation-code including a signal; retrieving M signatures from corresponding transactions, said signatures corresponding to a plurality of the set of N public keys; for each of the M signatures, extracting from the signal information on the position of the corresponding public key. The signal can be provided at the beginning of the data. The data can be implemented in an opcode e.g. script.

The data can be in the format of an OP_CHECKMULTISIG opcode, requiring an ordered input from the following data elements: <signal>; <signature a> <signature b> . . . <signature M>; <N>; <pubkey 1> <pubkey 2> . . . <pubkey N>; <M>; OP_CHECKMULTSIG; and the <signal> contains a list of the position of each signature M within the list of public keys N.

The signal can be represented by a concatenated list of fixed length integers where the maximum integer value is greater than M. The format of each integer in the <signal> can be binary.

The minting transaction and/or said database establishment record can include a form including (i) a template component, and (ii) a data-entry component, wherein data-entry is implemented in one or more transaction outputs of a form token. The data-entry component can represent blanks where data is to be entered/provided on the form.

Said data-entry component can be completed by retrieving the transaction output from a form token. Said output can be digitally signed. At least a portion of a body of the agreement can be a hash of its string and/or content. The template component can be provided as an input to a transaction. The template component can be at least a portion of a Ricardian contract.

The database establishment record can include data in the form of an existing database, which defines the at least one of the database format, entity and parameter and/or information related to the modification of said database. The token-issuing blockchain transaction (MTx) in the writechain can expand and/or modify the existing database. The token-issuing blockchain transaction can include at least one Issuer-related output (I-UTXO) associated with issuance data (IData) relating to a Token Issuer (TI) that Issued the token (T).

According to another aspect of the invention there is a method of performing a threshold signature check, wherein performing said action is conditional upon at least M private key signatures matching corresponding public keys held in a set of N public keys, wherein M is fewer than N, and wherein the method includes retrieving: a signal, said signal indicative of the position of each public key, corresponding to each M private key, in the set of N public keys; a set of M private keys; and a set of N public keys, the verifying that at least M private keys match public keys in the set of N public keys. The method uses an OP_CHECKMULTISIG operation-code. The signal can provided at the beginning of an operation-code.

The operation-code can be an OP_CHECKMULTISIG, requiring an ordered input from the following data elements: <signal>; <signature a> <signature b> . . . <signature M>; <N>; <pubkey 1> <pubkey 2> . . . <pubkey N>; <M>; OP_CHECKMULTSIG, and the <signal> contains a list of the position of each signature M within the list of public keys N.

The signal can be represented by a concatenated list of fixed length integers where the maximum integer value is greater than M. The format of each integer in the <signal> can be binary or hexadecimal. Preferably, M<(N/integer bit length).

According to another aspect of the invention, there resides a digital wallet arranged and configured to use, process or perform a threshold signature. According to another aspect of the invention there is a computer implemented method of performing a threshold signature check, as described herein, said method including generating, storing, processing and/or maintaining a computer-based resource (R) of a plurality of token-related blockchain transaction outputs (T-UTXOs), wherein each of the outputs (T-UTXOs). The computer-based resource (R) can be generated, stored, processed and/or maintained off-chain. According to another aspect of the invention, there resides a computer network comprising a plurality of nodes, wherein each node in the computer network comprises: a processor; and memory including executable instructions that, as a result of execution by the processor, causes the system to perform the aforementioned method. According to another aspect of the invention, there resides a non-transitory computer-readable storage medium having stored thereon executable instructions that, as a result of being executed by a processor of a computer system, cause the computer system to perform the aforementioned computer-implemented method.

Overall, each of the token applications and methods, as described and claimed, determine an efficient use of the computation necessary to process token transactions and the associated validation and/or interaction on a blockchain, said efficiency achievable through use of the underlying cryptocurrency units as the medium of transfer.

As described above, assets or resources can be tracked and/or managed using one or more blockchain transactions in which token-related outputs, representing tokens, function to determine the status of an asset. The status can, for example, indicate at least one of ownership, access rights to a secured asset, data, instruction, state, operation, configuration and value of an asset or resource, such as an amount of token-units.

According to another aspect of the invention involves a method of controlling a device, or said device, wherein an entity is responsible for a control system, which can reside entirely within a single device comprising sub-components or be distributed globally, or anywhere in between. Through a set of token transactions the entity can establish its authority with a digital signature, define the tokens and their operational scope of the control system, and issue tokens to manage and/or monitor the status of the devices within the control system. The entity is responsible for the set of transactions that issue a token. An individual controller that manages the token and/or the device can be connected, and preferably embedded, within a device of the control system.

Overall, the authenticity of the status of the asset and its history can be determined through verification that the token is derived from an issuer responsible for the asset and/or an inaugural establishment transaction, which can be verified, for example, from the token's relationship with at least one of the Issuer-related output (I-UTXO) associated with the issuer of the token and/or output that created the token i.e. token authentication is via a relationship with at least one of the inaugural transaction, token definition transaction and the token issuance transaction. Authentication can include a Merkle proof.

The method of operating a system having a device or a controllable device within such a system is configured to process a blockchain-implemented token generation, transfer and/or verification method. This method operates by processing and/or generating a blockchain transaction. The blockchain transaction includes one or more token-related outputs, each of which represents a respective token issued by a Token Issuer and specifies a quantity of token units, which represent access to the asset to be controlled, token-related cryptocurrency (TRC) associated with the respective token (T). The token transaction can also include at least one Issuer-related output comprising issuance data associated with the Token Issuer, or a proof that the token is derived from the Issuer.

According to an aspect of the invention there resides a blockchain-implemented method of operating a system having a device, the method comprising: using, processing and/or generating a blockchain transaction (MTx) having: one or more token-related outputs (T-UTXO), each of which represents a respective token (T) issued by a Token Issuer (TI) and specifies a) at least one of the operation, status and data that determines the configuration of the device; b) a quantity of token-related cryptocurrency (TRC) associated with the respective token (T).

Assets can be tracked and/or managed using one or more blockchain transactions in which token-related outputs, representing tokens, function to determine the status of an asset. The status can, for example, indicate at least one of ownership, access rights to a secured asset, data, state, operation, configuration and value of an asset.

Token transactions can output data, such as script including instructions. The linear transaction history, which determines a relationship with the set of transactions that created the token, can be referred to as a writechain.

The at least one of the operation, status and data that determines the configuration and/or status of the device can be determined from instructions on the output of a respective token's blockchain transaction. A device operating according to a token's status can retrieve instructions directly from a controller managing the token transactions and/or from the blockchain ledger. The format of the instructions can be script in the form of the underlying cryptocurrency protocol, said script determining how an asset secured by a token can be accessed. The script can be Bitcoin script, and preferably Bitcoin SV script.

The operation and/or status of a device can be determined by the state of a token operating according to a finite-state machine, said states of the state machine being defined in a token transaction, and preferably the token definition transaction. Additionally or alternatively, the device can have a controller configured to determine the status us a device, wherein the controller has a finite-state machine. The finite-state machine can have two or more operable states, wherein said the transition between states is determined by a token transaction and/or the controller.

At least one token can be provided for a device within a system to be controlled. The controller of a device can be used to manage a token's transaction. Management of the token includes receiving and verifying inputs from other devices, which can include digital signatures sent from said input devices and received by the device. Further, the controller can determine whether the token can change state according to the output script from the previous token transaction, which can lock the status until the correct conditions are met i.e. the correct digital signatures are received to sign the UTXO of the token. The controller can also manage the creation of the output script from a token transaction that places the token in to a new state and sets the input requirements in order for the token to change in to its next state, as determined by the finite-state machine of the token and/or device.

The system can include an input device having an input token. The input device and/or input token can be configured to create a token transaction output including data corresponding to at least one of an event, physical event and characteristic change of the input device. The input device can be a sensor. In this way, a token transaction output can represent the status of an input device. An input device can be a sensor. The signature can be indicative of a signal, which can represent at least one of an event, physical event and characteristic change into a signal. The token transaction output can include a signature indicative of the at least one of an event, physical event and characteristic change of the input device. The input device can hold a plurality of key-pair signatures, and each key-pair can correspond to a status or condition of the input device e.g. on or off.

The system can include an output device having an output token. The output device can be an actuator. The output device and/or output token can be configured to create a token transaction output determining at least one of the operation, status and data that determines the configuration of the output device. The input to an output token transaction, for changing the status of an output device, can be received from an input device and/or an input token managed by the input device. The input can be retrieved from the status of an input device token transaction. Additionally or alternatively the input can be received directly from an input device, such as a sensor, which can send at least one of a signal and a digital signature, indicative of its sensing or input status. The token transaction input is a signature indicative of the at least one of an event, physical event and characteristic change of the input device.

The token of the output device can require input from two or more input device token transactions and/or input from two or more signals. Upon receipt of the required input signatures and/or signals the output device token transaction receives the input/signature from an input token(s) or input device(s) and can spend the output into a new state. The new state can determine the inputs required to further change the state i.e. what signatures are needed from which input devices to effect a change. The output token transaction can be written by the controller of the output device managing the token, and write the script for the output of the token transaction.

A controller of a device can function, at least in part, as a digital wallet configured to manage token transactions. The device, whether it be in input device or an output device, can have at least one of: a control system configured to manage blockchain token transactions representing the status of the device; a memory holding key-pair signatures for signing the UTXO of a token to change the state of said device using the token and the device it represents; a secure mechanism for generating key-pairs for use in signing the UTXO of a token. The secure mechanism can include a program unrepeatable function (PUF).

The input device or the output device can be a sub-system having two or more devices. A device can be configured to include both input device functions and output device functions. A respective token can determine the at least one of the operation, status and data that determines the configuration of two or more devices. Two or more respective tokens can determine the at least one of the operation, status and data that determines the configuration of the device. A system of any size can be configured according to the method and devices disclosed herein, with the or each device's operation being determinable according to a token's status that is changeable according to a finite-state machine, the corresponding input signatures and token transaction output script.

A system having a device can be operated using tokens as described herein. Operation of a device's token can be managed e.g. embedded within a controller of a device. The status of a token transaction output is recorded on-chain, and a device can additionally or alternatively retrieve the state of the token according to its finite-state machine from the token ledger.

Additionally or alternatively, a system can operate according to the status of a token having a finite-state machine, wherein the status is held in a database. The blockchain transaction can further include at least one of a database format, entity and parameter and/or data related to the creation and/or modification of a database, said database capturing at least one of the operation, status and data that determines the configuration of the output device. The or each token related output can define, at least in part, a portion of a relational and/or graphical database. The or each token related output can be an instruction for the modification of the table and/or database, the instruction determining at least one of (i) amending by adding, deleting or updating and (ii) modifying at least one of a row, column or record. A token transaction and each subsequent token transaction can define, at least in part, a writechain. The writechain enables a transactional database to be determined.

Generally, a system, sub-system or device can be configured to implement the methods herein. A system, sub-system or device within a system, in particular an output device, can change state in response to at least one of: a signal from an input device, such as a sensor; the change of state of an output from an input device's token transaction, recorded on the token ledger; and an update recorded in a database, said database monitoring the system being controlled and the status of the respective tokens representing the status of the assets and/or devices therein.

In other words, a transactional database gathering the status of each token can provide a record of the status of each token/device within the system, and indicate the change of status and trigger for said change. The database can be a transactional database and function as a repository of the status of tokens representing the status of devices within a system. The database can be a transactional database configured as a repository for instructions, which a device can refer to determine an action to be taken.

A transactional database can be deterministically formed from token transactions and their writechains' extracted from a token ledger.

According to another aspect the invention resides in a device, operable in a control system, said device having: a controller configured to processing and/or generating a blockchain transaction (MTx), said blockchain transaction having one or more token-related outputs (T-UTXO), each of which represents a respective token (T) issued by a Token Issuer (TI) and specifies a) at least one of the operation, status and data that determines the configuration of the device; b) a quantity of token-related cryptocurrency (TRC) associated with the respective token (T). The blockchain transaction can further comprise at least one Issuer-related output (I-UTXO) comprising issuance data (IData) associated with the Token Issuer (TI). The controller can process instructions on the output of a respective token's blockchain transaction. The instructions can be script. The controller can have a state machine, said state machine having two or more operable states, wherein said states are determined by the controller processing the output from a token transaction. The controller can have a state machine, said state machine having two or more operable states, wherein said states are determined by the controller processing the output from a token transaction. The device can be an input device configured to manage an input-token and create a token transaction output including data related to at least one of an event, physical event and characteristic change of the input device. The token transaction output can include a signature indicative of the at least one of an event, physical event and characteristic change of the device.

The device can be an output device configured to communicates with an input device (i) directly and/or (ii) is configured to read the latest token transaction from an input device to determine the status of the input device. The output device can be configured to process the response from the input device to create a token transaction in which the output determines at least one of the operation, status and data of the output device. An output device contacting an input device can receive a response from the input device which can be a signature indicative of the at least one of an event, physical event and characteristic change of the input device.

The device can be: a sub-system having two or more devices; the respective token (T) of the device can determine the at least one of the operation, status and data that determines the configuration of two or more devices; and/or two or more respective tokens can determine the at least one of the operation, status and data that determines the configuration of the device.

According to another aspect the invention resides in a system having a device configured to manage one or more token-related outputs (T-UTXO), each of which represents a respective token (T) issued by a Token Issuer (TI) and specifies: a quantity of token-related cryptocurrency (TRC) associated with the respective token (T); and at least one of the operation, status and data that determines the configuration of the device. The system operation can be defined by the methods and device operation described herein.

Each system and/or device can be configured to manage at least one token on a cryptocurrency blockchain and create a token transaction that indicates the operation, status and data that determines the configuration of at least one device.

According to another aspect the invention resides in a method of monitoring a control system having a device, wherein said operation, status and data that determines the configuration of the device is determined by a token transaction on a cryptocurrency blockchain, wherein a chronological series of transactions determine a writechain of token transactions, and wherein the method retrieves and collates the outputs from the token transactions on the writechain in a database.

According to another aspect of the invention, there resides a digital wallet arranged and configured to manage the token transaction of a token that determines the status of a device.

According to another aspect of the invention there is a computer implemented method of performing a token transaction of a token that determines the status of a device, said method including generating, storing, processing and/or maintaining a computer-based resource (R) of a plurality of token-related blockchain transaction outputs (T-UTXOs), wherein each of the outputs (T-UTXOs). The computer-based resource (R) can be generated, stored, processed and/or maintained off-chain.

According to another aspect of the invention, there resides a computer network comprising a plurality of nodes, wherein each node in the computer network comprises: a processor; and memory including executable instructions that, as a result of execution by the processor, causes the system to perform a method disclosed herein, such as a token transaction of a token that determines the status of a device.

According to another aspect of the invention, there resides a non-transitory computer-readable storage medium having stored thereon executable instructions that, as a result of being executed by a processor of a computer system, cause the computer system to perform the aforementioned computer-implemented method disclosed herein, such as a token transaction of a token that determines the status of a device.

Overall, each of the token applications and methods, as described and claimed, determine an efficient use of the computation necessary to process token transactions and the associated validation and/or interaction on a blockchain, said efficiency achievable through use of the underlying cryptocurrency units as the medium of transfer.

### BRIEF DESCRIPTION OF THE DRAWINGS

Aspects and examples of the present disclosure will now be described, by way of example only, and with reference to the accompany drawings, in which:

FIG. 1 is a flowchart illustrating steps in an example of the disclosure.

FIGS. 2 and 3 shows illustrative examples in accordance with the present disclosure, some of which utilise an intermediary register and some which do not.

FIG. 4 shows the Inputs and Outputs of a Token transfer transaction (TTTx), in which tokens go into and out of the same VOUT index in the same blockchain transaction and retain their exact token; moreover, tokens that are sent into a wallet in respect of a given exchange or transaction may not (in fact, most likely will not) be the same tokens that will be sent for onward transfer to a recipient.

FIG. 5 further illustrates the TTTx of FIG. 4, and how individual tokens having various token values can be transferred via numerous blockchain transactions but retain their exact same token units and are not split/recombined. This illustrates the fungible nature of tokens formed in accordance with the present disclosure.

FIGS. 6 and 7 illustrate examples of the disclosure in use.

FIG. 8 shows an overview of a validation process which may be used in accordance with an example of the disclosure.

FIG. 9a illustrates a logical sub-ledger of associated tokens issued by the same issuer and implemented on a blockchain ledger e.g. the Bitcoin blockchain. Such a logical sub-ledger may be referred to as a Token Ledger, while FIG. 9b illustrates the relationship between a token ledger, including a sub-ledger, a cryptocurrency ledger and a database management system.

FIG. 10 illustrates an arrangement in which a change component or service provides users with change for denominated tokens when needed. This enables users to exchange tokens for others with different token units.

FIG. 11 illustrates an example of a Minting transaction where the source of the issuer authority is from public keys held in a UTXO not otherwise tied to the minting transaction. Validation is performed by checking that the signatures in the minting action validly use the public keys tied to the identities of the issuer authorities in the referenced transaction.

FIG. 12 illustrates an example of a Minting transaction where the source of the issuer authority is derived from control of a token or Issuer Certificate. Validation is performed by tracing the history of the issuer certificate back to the Token Ledger establishment transaction.

FIG. 13 illustrates a process that involves a sender and receiver creating a blockchain transaction, and comprises steps taken by the receiver to use a 3rd party service to validate the tokens.

FIG. 14 illustrates a multiparty group blockchain transaction of the type a third token processing party can use to obfuscate the parties to a transaction by grouping many smaller exchanges into one large transaction. This is done using SIGHASH_SINGLE|SIGHASH_ANYONECANSPEND on all tokens being spent, which locks each input/output pair but allows the processing party to have the freedom to stack them into a single large transaction, or even to break them out into multiple separate transactions.

FIG. 15 illustrates two separate blockchain transactions being paid via a register and showing that the register holds the funds for the users, and the user only provides the register with a signature. Signatures are signed using SIGHASH_NONE|SIGHASH_ANYONECANPAY as the output destination is not determined at the time the tokens are signed. The register then takes other, separate tokens that have been pre-signed by other register users and spends them out to the fund recipients in a group transaction.

FIG. 16 illustrates a process by which physical tokens with specific details regarding their serial number and value can be destroyed and re-issued as digital items that carry the serial number and value of the original note into the token ledger.

FIG. 17 illustrates a process by which a digital token with a unique identifier e.g. serial number and token value can be locked into a script controlled by an issuer who can then create sub-tokens, which can be physical or digital representations of the digital tokens. These can be verifiably linked to the digital token, and then destroyed by depositing them back into a register controlled by or associated with the issuer and removing the digital token from the locking script.

FIGS. 18a and 18b illustrate the use of a blockchain transaction to melt i.e. destroy a token formed in accordance with an example of the present disclosure.

FIG. 19 illustrates the use of a blockchain transaction to re-mint i.e. re-issue a token formed in accordance with an example of the present disclosure.

FIGS. 20a to 20d illustrate further examples of a blockchain transaction to re-mint i.e. re-issue a token formed in accordance with an example of the present disclosure.

FIG. 21 shows an establishment transaction which spends a UTXO into an issuer certificate which contains the identities and digital signatures of the Issuer's authorised representative(s).

FIG. 22 shows an establishment transaction that generates a root node that contains the signatures and digital signatures of the Issuer's authorised representative(s).

FIGS. 23a and 23b shows an illustration of an example of an example use case which implements a voting process as described below.

FIG. 24 shows a sub-ledger which is formed as a subset of a token ledger in accordance with one or more examples.

FIG. 25 illustrates a minting transaction for three dynamic tokens, each having a zero-point value of 1000 satoshis.

FIG. 26 illustrates a transaction between an issuer and a customer of 300 token units, represented by satoshis, wherein the zero-point value is 1000 satoshis.

FIG. 27 illustrates a transaction between an issuer and a customer, wherein 1000 token units from a customer's static token are provided to the issuer in exchange for 1000 token units being provided into the customer's dynamic token.

FIG. 28 illustrates an exchange of 500 token units from a user to an issuer in exchange for a non-fungible token.

FIG. 29 shows actions taken by two parties during a transaction between two dynamic tokens.

FIG. 30 illustrates a transaction in which a combination of static and dynamic tokens is used in a transaction.

FIG. 31 illustrates a transaction in which a dynamic token is used to generate a single-use token.

FIG. 32 illustrates a transaction in which a dynamic token is used to create four single-use sub-tokens while retaining token units.

FIG. 33 illustrates a transaction in which a two single-use tokens held in a wallet are used together with a dynamic token to output a combined total of token units.

FIG. 34 illustrates a transaction in which a two single-use tokens and a dynamic token held in a wallet are used together to output a combined total of token units.

FIG. 35 illustrates a transaction in which a two single-use tokens and a dynamic token held in a wallet are used together to output a combined total of token units in the form of one dynamic token and one single-use sub-token.

FIG. 36 shows actions taken during a transaction in which two single-use tokens are added to a dynamic token by two parties during a transaction between two dynamic tokens.

FIG. 37a shows actions taken during a transaction in which two second-order sub-tokens are created from a dynamic token, and FIG. 37b illustrates how second-order functionality can be nested in token transaction output script.

FIG. 38 shows actions taken during two transactions in which a second-order sub-token can be propagated through a transaction.

FIG. 39 shows a transaction sequence used to removing the linear chain of history that ties a user to their token.

FIG. 40 shows a transaction in which two FALSE outputs are created to adjust the management of tokens in the transaction.

FIG. 41 shows a chain of transactions in which a dynamic token is used to create a single-use sub-token that, in turn, is used to create two further single-use sub-tokens before one of said further single-use sub-tokens is paid into a dynamic token.

FIGS. 42 and 43 show FALSE outputs that are used to terminate tokens.

FIGS. 44a to 56 are a mixture of diagrams illustrating token transactions in which database instructions are output and examples of the relational database derivable from those transaction outputs, when compiled by a database management system.

FIG. 57 is a JavaScript Object Notation (JSON) of the establishment of a weather database.

FIGS. 58 and 59 are diagrams of the different token transaction output structures for recording the status of an asset.

FIG. 60 illustrates an example of a device having a controller and a control system.

FIG. 62 illustrates a token transaction in which the token for the pump control relay PU100 and control valve HV100 are minted.

FIGS. 63 and 64 illustrate the finite-state machine for the output devices for the pump control relay PU100 and the control valve HV100, respectively.

### DETAILED DESCRIPTION OF ILLUSTRATIVE EXAMPLES OF THE DISCLOSURE

Examples of some possible examples and use cases are now provided for the purpose of illustration, without limitation. As explained above, for the sake of convenience only, we will refer herein to “Bitcoin” for our examples as it is the most well-known and widely used blockchain protocol. Examples of the disclosure may be implemented on the Bitcoin protocol, platform and ledger, although this and the references to Bitcoin are not intended to be limiting and the scope of examples of the present disclosure is not thus restricted.

The following description relates to Tokens (T), and in particular their creation, use, re-creation and destruction. Tokens can be created having different properties and their different types include:

tokens created with a fixed value that remains static during a transaction, in which it is transferred from one user to another, which are referred to as static tokens (sT);

tokens created with an initial value that is changeable during a transaction, and can be retained by a user and, preferably, is not transferred during a transaction and involves the transfer of the units within a transaction, which are referred to as dynamic tokens (dT); sub-tokens derived from a dynamic token (dT) during transactions that can reside in digital or physical form that can be spent into any compatible dynamic token (dT) during a transaction, these sub-tokens being configurable in a number of formats, including:

transferrable and configured for single-use, which are referred to as single-use sub-tokens (suT);

configured with secondary functionality, as described below, and are referred to as second-order sub-tokens (soT) when they have an attribute value or zero-unit token e.g. zero-satoshi tokens (zsT), said second-order sub-tokens having at least one of a static value, single-use configuration or dynamic value; and

write tokens, which also have a deterministic relationship with the minting transaction that enables its authentication and/or a linear transaction history to be determined, said write tokens creating transactions with output that functions as an instruction to a transactional database, wherein a series of write token transactions determine a writechain, said writechain residing on the blockchain the instructions from which can be retrieved and used to determine a transactional database management system.

In each of the examples of the invention, the minting transaction provides data that determines the functional operation of a token—which can, at least one of, manage an asset, record information in transactions and subsequently enable compilation of transactions on a writechain into a functional record deterministically. Further, the interaction with a ledger, such as a cryptocurrency ledger, inhibits corruption and optimises use of a scalable platform in an efficient and cost-effective manner

The Establishment Transaction

One or more examples of the disclosure may involve the use of an Establishment Transaction (ETx). The establishment transaction can be a token definition transaction, that defines the tokens to be created and subsequently issued. The establishment transaction can precede or include a minting transaction. The establishment transaction can define a database or a device set-up record in a control system. The establishment transaction, which functions as a token definition transaction, preferably references an inaugural transaction. The inaugural transaction can function as a root node holding digital identities and/or digital signatures of the issuer and/or authority responsible for the tokens, which can also include additional signatures from, for example, a governmental or regulatory authority. The inaugural, definition and issuance transactions can, collectively, be referred to as a minting transaction.

In practice, it is a transaction that issues a token for the first time that functions to mint a token. However, the input to the minting or issuance transaction that effects token transfer and/or verification has an input that from at least one of the definition transaction and the inaugural transaction. Each token transaction, including and proceeding an issuance transaction i.e. a minting transaction, therefore, is linked in a linear transaction history on the blockchain to at least one Issuer-related output (I-UTXO) associated with issuance data (IData) i.e. the toot node that relates to a Token Issuer (TI) that Issued the token (T). Further, each token transaction, including and proceeding an issuance transaction, includes an asset i.e. a quantity of token units (TU) specified in the definition transaction, and token-related cryptocurrency (TRC).

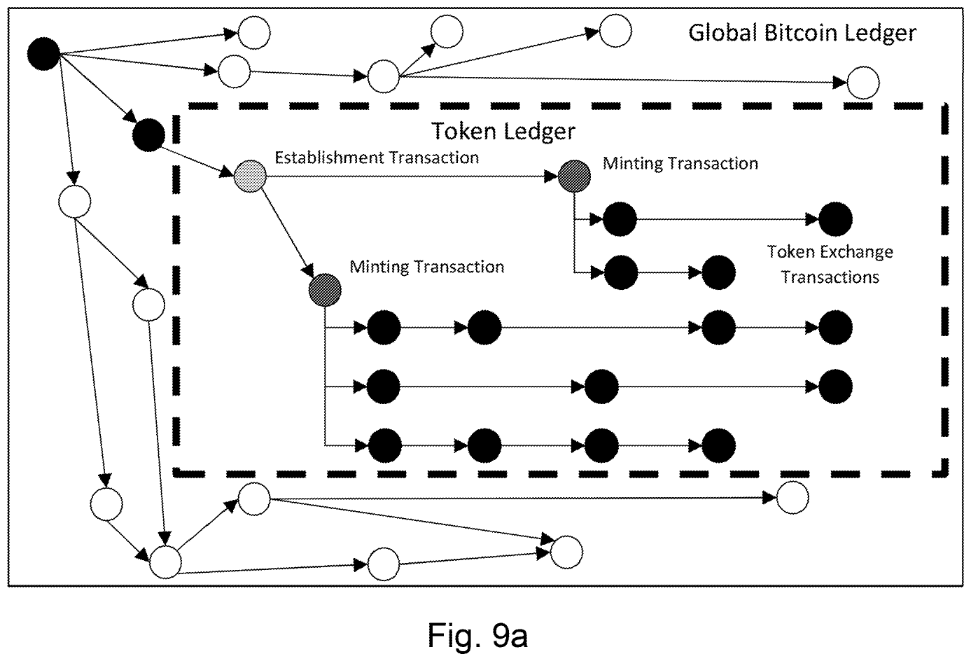

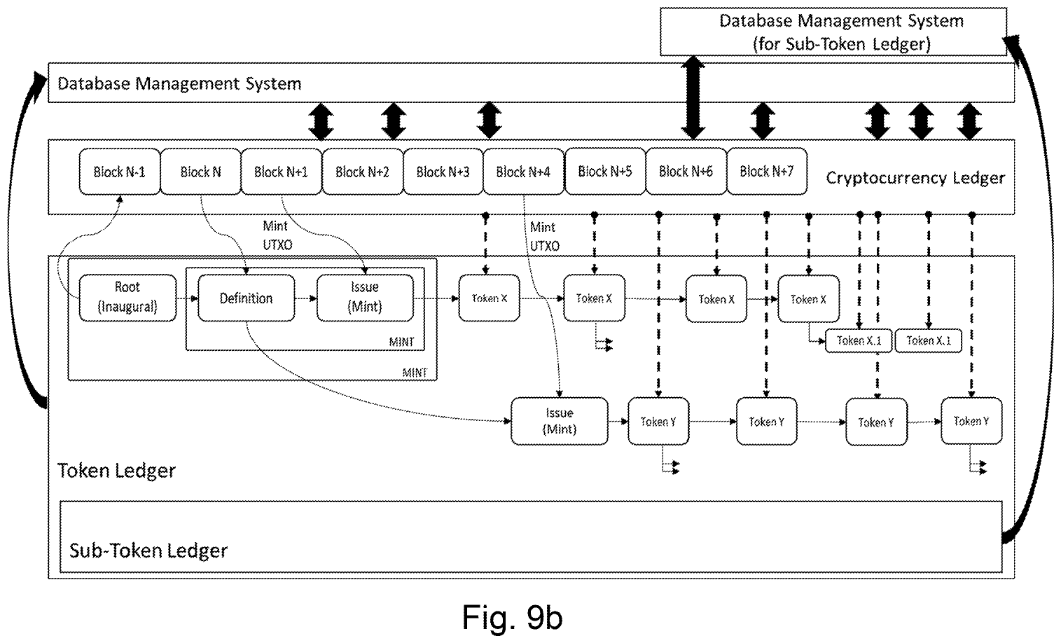

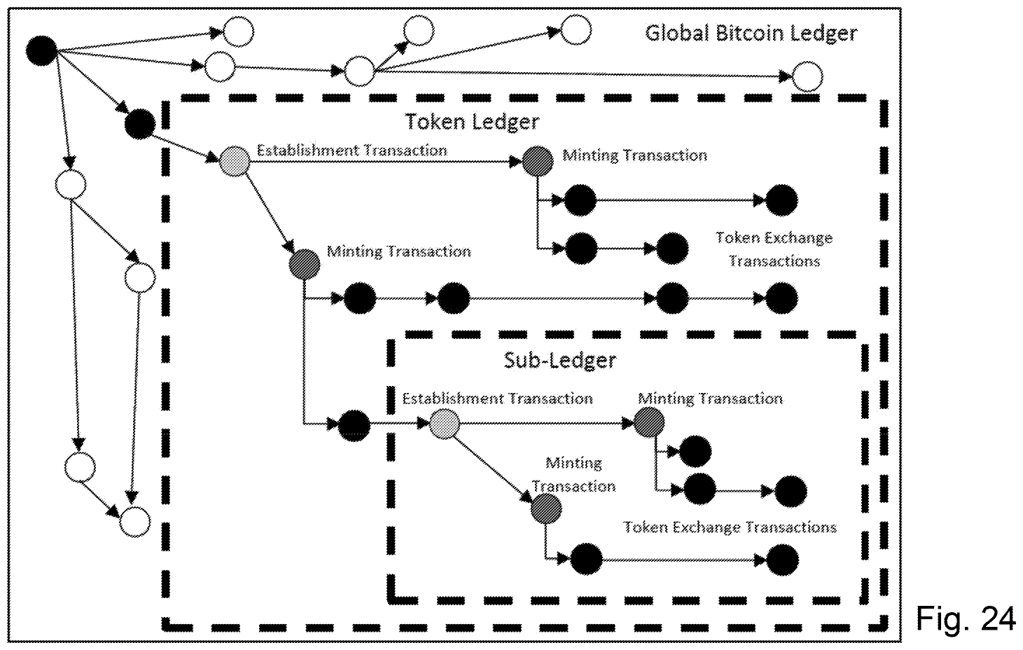

An example of an ETx in use is shown in FIGS. 9a, 9b and 24. The ETx's function is to provide the necessary authorisation data and record from which the issuer (TI) will derive their authority, and which then enables issuer-performed actions such as minting of tokens (T) to be carried out. As illustrated in FIG. 9a, a single ETx can be used in the creation of more than one Minting Transaction (MTx) for a given token ledger. The Establishment transaction is different from the minting transaction in that it is a single event that marks the first action within a Token Ledger whereas an MTx is subsequent to the ETx and represents the act of creating the tokens (T), which will be transacted within the Token Ledger. It is the linear history that can link every token in the token ledger back to a specific Minting Transaction and every minting transaction back to the authority created in the Establishment Transaction that gives the disclosure some of its most important properties including low overhead, simple traceability and unique yet fungible tokens.

FIG. 9b illustrates an alternative representation of the ledgers shown in FIG. 9a, wherein the cryptocurrency ledger and token ledger are shown arranged in parallel, and the relationship between the token ledger transactions indicated. Further indicated is a database management system, which can retrieve token transactions made by tokens created within the token ledger and recorded on the cryptocurrency ledger.

Token transactions can be retrieved and analysed for any application of the token, such as the status of the asset that it controls, and non-limiting examples of securable assets are described herein, such as static tokens, dynamic tokens, tokens for creating a transactional database and control tokens, which determine the operational state of a machine. The status can be at least one of the operation, and data that determines the configuration of the asset or resource.

A database management system can be operated by the authority or issuer supporting the token ledger, or by an agent on their behalf. The database management system, therefore, has access to token ledger information including at least one of: the signatures defining the token ledger in the root node; the token definitions; the issuance transactions and the tokens that were minted, or sub-minted; the identities of each token; and the key-pair signatures associated with each token. Token transaction outputs can be configured for compilation into a database, and an example of a transactional database is provided below.

A database management system can access and process data from the token ledger and associated one or more sub-ledgers. Although not shown, said sub-ledgers are implemented in the same way as a convention ledger and based on the same tokens, except that the sub-ledger is dedicated to an additional function attributed to a token output transaction script e.g. a second-order function, as described below. Additional functionality e.g. second order functionality can be implemented by a different authority or issuer. As illustrated, an optional separate database management system can be implements to retrieve data from the sub-token ledger.

As shown in FIG. 9b the process of creating and minting a token has a root node that functions as the inaugural transaction and includes one or more digital signatures of the authority/issuer and to represent the authority. The root node transaction is recorded in the cryptocurrency ledger i.e. ‘on-chain’. The root node can include a definition of the tokens to be minted, or the definition transaction can be made separately on-chain and digitally referenced to the root node, while also being recorded on-chain. The definition transaction can include a minting transaction and/or a minting transaction can be made separately. The minting transaction that functions to issue the digitally references the definition transaction that established the tokens and/or the root node, either directly or indirectly.

A minting transaction also has at its input an amount of cryptocurrency, such that each subsequent token transaction can be authenticated. Authentication occurs at two levels. Firstly, via a token ledger, wherein a recipient of a token can verify its authenticity by determining its relationship with the or each of the transactions in the set of transactions that created the token i.e. by determining that the token to be received was derived from a linear transaction history including a ‘mint’ transaction. This first level of authentication applies, as viewed in FIG. 9b, by the relationship between the tokens e.g. Token X, token X.1 and Token Y. Secondly, each token transaction includes an amount of cryptocurrency and, therefore, the authenticity of the UTXO is determined by miners processing the transaction. Through this relationship, a recipient can determine the authenticity of a token's cryptocurrency UTXO, as illustrated by the hashed lines between the tokens and the cryptocurrency ledger—however, the recipient or machine using a token, e.g. a digital wallet, priorities the authenticity of the asset managed by the token ledger, which is typically of greater importance and/or value than the underlying cryptocurrency.

As described below in greater detail, token transaction outputs represent an asset, which can be an asset controlled by the token itself, a sub-token or even additional token functionality, which can be conditionally provided. It can do so by referring back to its own creation, i.e. the set of transaction(s) that created the token, and do so independently of the underlying cryptocurrency, thus resulting in a faster and more efficient computational process of authentication. This efficiency can be achieved because the token has a linear transaction history i.e. the token transaction history from the latest transaction to the issuing transaction involves no forks or loops.

Irrespective of whether the root transaction, establishment transaction and minting transaction are combined or performed separately they determine the beginning of a linear transaction history for subsequent token transactions derived therefrom.

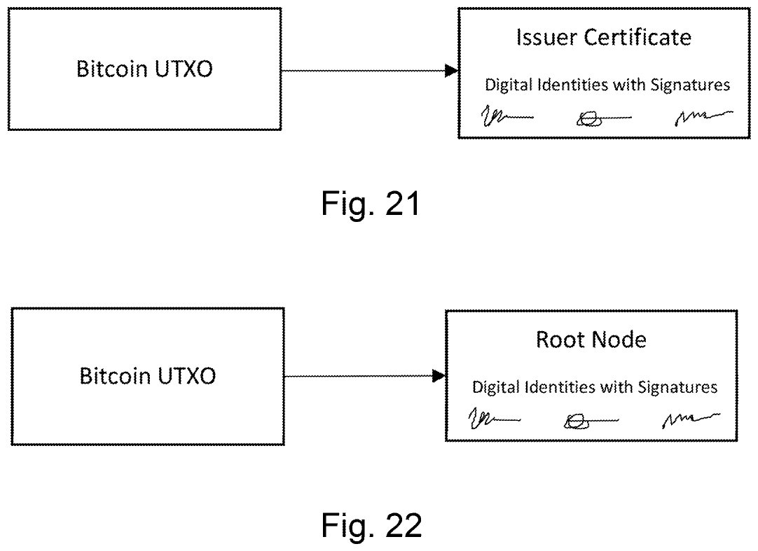

The establishment transaction (ETx) in the example includes at least one input whose script is signed by all relevant, participating parties and comprises at least one output that becomes an issuer certificate for the Token Ledger. This is shown in FIG. 21. In this example, issuer certificates are each represented by a UTXO held in a script controlled by an authorised representative of the issuer which allows for the underlying cryptocurrency tokens to be transferred, or minted and transferred thereafter. Each time the issuer performs an action such as the minting of tokens the UTXO and/or the transaction identification i.e. the transaction is used as an identifying edge, which holds the certificate and is used as an input to the transaction that performs the action, and the certificate is transferred into a new UTXO that is an output of that transaction. In this way the certificate can be re-used an unlimited number of times and retains a linear history back to the token ledger's establishment transaction.

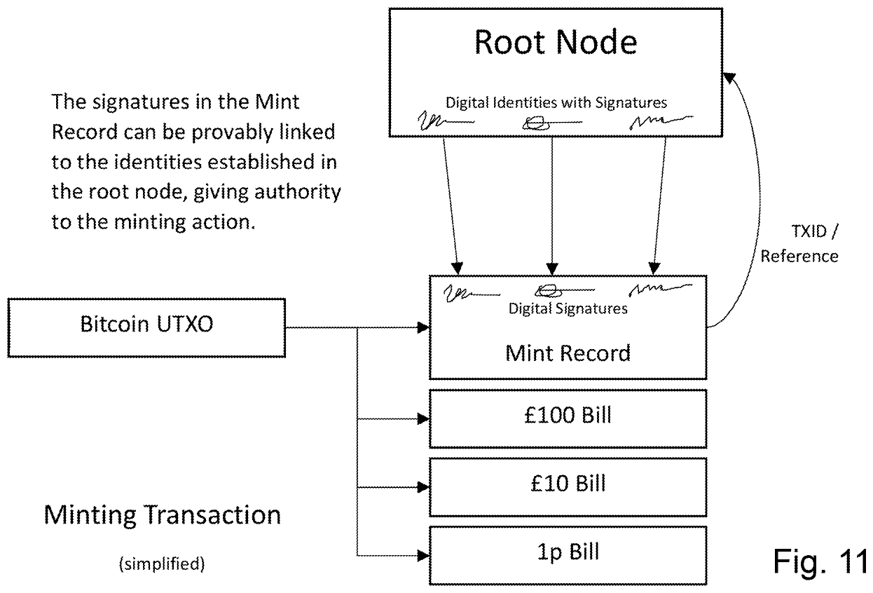

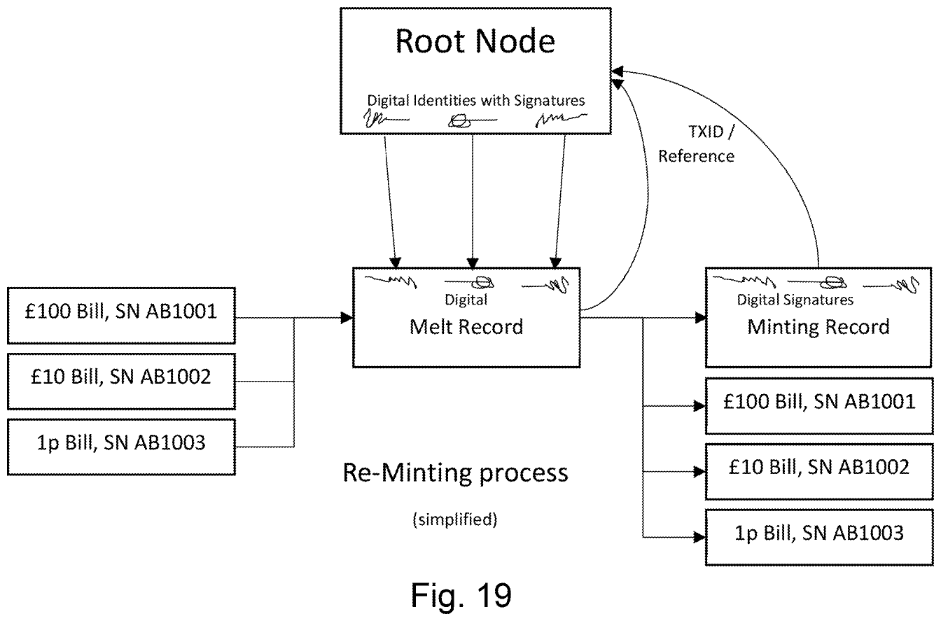

Another example comprises an Establishment Transaction (ETx) which creates a root node using data carried in an output script. In the context of the present disclosure we are using the term ‘node’ as a way to describe a node in a graph or tree of blockchain transactions rather than computers within a network. Examples of root nodes being used can be seen in FIGS. 11, 18, 19 and 22. In this example, the root node contains details that can be used to establish the identity of the issuer, their representatives and the requirements that must be met for those representatives to generate valid issuer transactions within the token ledger. In this example, issuer actions such as the minting of tokens are performed by an issuer or their authorised representative(s) applying their digital signatures to the transactions in a way that can be both detected and verified by users of the token ledger.

Another example establishes a root node using the Metanet Protocol as known in the art (see https://wiki.bitcoinsv.io/index.php/Metanet_Protocol) and uses Metanet children of the Root Node to mark issuer-related transactions such as minting transactions.

The nature of the requirements can be agreed by participating parties and signed prior to publishing the establishment transaction to the network. In a different example, data such as text of the agreement can be transcribed directly into the root node as ASCII or JSON formatted text, as an embedded file in an acceptable format (e.g. PDF), stored prior in a separate transaction that is referenced within the Root Node, or held in a document that is stored offline and validated by signing parties using a document hash or other knowledge proof which is stored in the Root Node. Other types of data and insertion mechanisms can also be used.

In one or more examples, the UTXO that is used as the input to the establishment transaction must be created and committed to the ledger before the agreement is signed. This action can be performed by one of the participating parties, or by a third party with knowledge of the requirements of the establishment transaction's input script.

The establishment transaction input can be structured using Bitcoin script to enable the participants to choose a multiplicity of outcomes.

Example: Simple contract

```
DEPTH 2 EQUAL IF
  2 <customer_pubkey> <contractor_pubkey> 2 CHECKMULTISIG RETURN
<accepted>
ELSE
DUP <customer_pubkey> CHECKSIG IF
  TRUE RETURN <rejected_by_customer>
  ELSE
    <contractor_pubkey> CHECKSIG RETURN <rejected_by_contractor>
ENDIF
ENDIF
```

This script allows for parties to negotiate on the outcome prior to accepting the agreement, and for either party to reject the agreement, ending the negotiation process. The selection of an outcome is provable on-chain.

The Issuing (Minting) Transaction

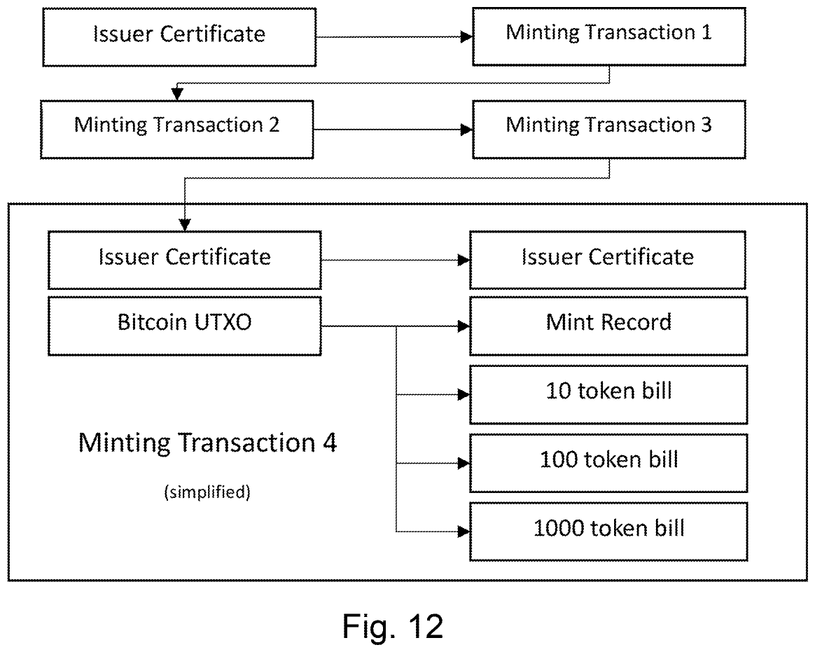

In accordance with one aspect of the disclosure, one or more blockchain-implemented tokens (Ts) are created by an issuing source (“Issuer”) via a blockchain transaction which we will, for the sake of convenience, refer to as a “minting transaction” (MTx) or “issuance transaction” because its submission to the blockchain mints i.e. generates/issues/creates new tokens which can be subsequently transferred on-chain between parties. FIGS. 11 and 12 provide illustrations of how a Minting transaction can be used to generate tokens.

Once minted, these tokens can be provided to users. A token can be established for onward transfer, which we may refer to as putting the tokens into “circulation”, because they can be shared and exchanged between parties who have wallets that are configured or arranged to operate in accordance with the present disclosure. Alternatively, a token can be established to be held by a user, and rather than the token being transferred between parties the token is held in a wallet and it is token units associated with a token that are exchanged between parties.

As illustrated in FIG. 9a, and discussed in more detail below, once a minting transaction puts tokens, sub-tokens or token units into circulation, they form a sub-ledger on the underlying blockchain in that they reside and are recorded on the blockchain as per traditional UTXOs, and are transferred from one transaction to another. However, the tokens or token units carried by the UTXOs are logically linked or associated with each other due to their common issuer and/or minting transaction. It should be noted that an issuer may use more than one Minting Transaction to generate tokens of a particular type. Conversely, a single minting transaction can be used to generate tokens of different types. Herein we will use the term “token ledger” to refer to a set (sub-ledger) of tokens residing on the blockchain and logically linked or associated by virtue of their common minting source.

As per traditional blockchain transactions, the Minting Transaction comprises input(s) and output(s) as detailed below. In this way, a given blockchain (e.g. Bitcoin SV) may provide the foundation layer for one or more token ledgers. Each token ledger may manage its own set of unique tokenised resources (digital objects). Each token ledger is spawned by and traceable on-chain to an establishment transaction or root node. This is advantageous because it enables an organisation to utilise the attributes (security etc) of an existing blockchain. By creating such a layer on top of an underlying, public blockchain, an issuer is able to mint tokens onto a sub-ledger with minimal complexity or resource requirements, and then observe that transfers have been performed. However, privacy for parties to the transfer is preserved in the same way as per a fiat cash transaction.

Minting Transaction MTx Inputs:

In accordance with certain examples of the present disclosure, the minting transaction digests a quantity of cryptocurrency (C) and also a portion of issuance data (IData) via one or more transaction inputs. In one or more examples, these are received into the Minting Transaction via the same input, while in others they are provided via separate inputs.

In some examples, however, the only input may be a transaction input that provides the cryptocurrency units required for the creation of the token(s). While it is possible to issue tokens in a ledger, this requires use of a particular UTXO as a ‘certificate’. However, no satoshis can be derived from said UTXO. Such a token would have to be spent into and out of the transaction and, therefore, did not carry any minting data. Therefore, in one example, the Minting Transaction has issuance data in an output but not in an input. In this way the issuer's authority is established in the minting data.

The issuance data comprises one or more portions of data that attests and/or relates to the Issuer (TI) of the token(s), and/or the Issuer's authority to issue them. This issuance data could be referred to, in the alternative, as an “authority token”, “authority node” or “certificate”. The term “certificate” may be used herein for convenience. The certificate functions as a means for maintaining and controlling the flow of issued tokens into and subsequently over the token ledger.

The incoming quantity of cryptocurrency (C) e.g. Bitcoin or bitcoin satoshis, is received into the Minting Transaction from a previous transaction on the blockchain. It is used by the Minting Transaction to generate the underlying, supporting transfer mechanism or vehicle which, after minting, enables control of the token(s) or token unit(s) to be transferred from a sender to a receiver. If more than one token (T) is to be minted in a given minting transaction, the quantity of cryptocurrency will be split into sub-quantities at least some of which are allocated to respective Tokens. In this way, the quantity of cryptocurrency may be thought of as analogous to a print media or coinage in the field of traditional minting techniques, in which a portion of raw material is supplied to a coin stamper for processing into smaller, individual portions (coins) each comprising a sub-portion of the original coinage material and thus its own associated, intrinsic value.

The Issuer can impose any desired restrictions on the usage of the tokens via the minting transaction. This can be achieved via the use of a smart contract, for example. The Issuer can, for example, determine the type of token that is minted and determine whether a token is static, in which case the number of token units held by the token is fixed, and the entire token is transferred during a transaction, or whether the token is dynamic and created to be held, and the token units therein are changeable such that token units are transferred during a transaction. Furthermore, the Issuer can determine whether, for example, a dynamic token can calve off a sub-tokens, such that create single-use sub-tokens and/or second-order sub-tokens, which are described in more detail below.

Advantageously, the Issuer's ownership rights, and ledger usage control can be managed and preserved via the underlying blockchain network and its protocol. The token ledger may be created via a transaction which comprises a (smart) contract or a pointer to a contract that is recorded on the blockchain and which is referenced when new tokens are minted. Authorised signatories related to the Issuer may cryptographically sign the certificate/issuance data/node to provide a verifiable record of authorisation.

Minting Transaction (MTx) Outputs:

The minting transaction also comprises a plurality of unspent transaction outputs (UTXOs).

In an example, at least one of the UTXOs provides, comprises or is associated with the certificate. The certificate is the means by which the Issuer's authorisation to issue the tokens is injected into the system. It is also the means by which authenticity of the tokens can be verified in subsequent use, after minting. The certificate can comprise any type, format or content of data that is required for the purposes of the particular implementation.

In some examples, the Certificate could be passed to an output from an input with the same VOUT/VIN indices. In some examples the Certificate exists in a UTXO which is not spent in the issuance transaction and identifying details (e.g. transaction ID, Vout index, public key or keys) are reproduced within the minting transactions and used in to create digital signatures to link the minting transaction to the token issuer (TI).

In some examples the certificate may be a public key or other knowledge proof which is provably linked to the issuer through means external to the blockchain database and which are used to generate digital signatures to link the minting transaction to the issuer.

However, in one example, neither the certificate (IData) or minting record (MR) is used in the token or token unit transfer itself, and there is no authorisation certificate required for subsequent transfers once tokens are minted. Thus, the minting information is used in the minting and subsequent verification processes, but not for token or token unit transfer purposes. As minting information is not attached to, or carried forward by, the transfer transactions a user is required to verify the authenticity of a particular token by tracing its history back to the minting transaction and checking the information from there. This provides the technical advantage that authenticity and verification of source can be assured, and security of tokens improved, because if minting/issuer related information was carried forward with the token on each exchange a malicious third party could exploit that to counterfeit the token. Although this requires the user's wallet to expend some resources to perform the check, the linear transaction history and techniques such as SPV keep that overhead to a minimum. Techniques that minimise the overhead can enable the verifier to discard any or all vin/vout pairs that are not associated with the tokenised assets. In some ways, the need for this check is analogous to the sort of checks performed by merchants when they are handed a bank note from a customer. If, for example, a merchant chooses not to check that a customer's £50 note was genuinely issued by the Bank of England and not a forgery, they take the risk of receiving a counterfeit token. Therefore, most merchants would opt to make a small amount of effort to verify the authenticity of the bank note e.g. checking the note's serial number or holding it up to the light to look for a watermark etc.

Additionally, in some examples, the same or at least one different UTXO provides, comprises or is associated with token generation data, which we may refer to herein as a “minting record” (MR). In such examples, the minting record may comprise data that relates to the token(s) that are issued by the minting transaction. This may include a list of all tokens created by the minting transaction and/or any desired data relating to those new tokens such as details of the tokenised assets that they represent, the amount of cryptocurrency associated with each token, a unique identifier such as (but not limited to) a serial number, any related artwork or specific constraints on use. The minting record may be provided as a pointer, reference or representation of the list or token-related data, and may be provided within the locking script of the minting record's output(s). In some examples, it may be provided as metadata at a location within the token-holding output(s) e.g. within a locking script of the UTXO, possibly after a FALSE RETURN output e.g. an OP_RETURN opcode.

Token Outputs (T-UTXOs):

The plurality of outputs also comprises at least one (but typically a plurality of) token related UTXOs which we might refer to as T-UTXOs for convenience to distinguish a token-carrying output from an output that comprises a certificate and/or minting record. A T-UTXO is a UTXO which represents a token (and thus a tokenised resource) in accordance with examples of the present disclosure. We may refer to an output that comprises the certificate (IData) as an I-UTXO.

In respect of a typical example of the present disclosure, in which the Minting Transaction generates more than one new token, the underlying, cryptocurrency value of the newly minted coins are a sub-portion of the incoming quantity of cryptocurrency (C). However, in an example where only one coin is to be minted by the issuing transaction, the whole of the incoming quantity may be allocated to the newly minted coin. In all cases, whether one or more coins are minted, any remaining change will be returned as mentioned above. As described above, fees and other non-token inputs and outputs are not considered part of the transaction unless specifically mentioned. Fees can be an overhead require for a transaction but independent of the tokenised asset and/or information.

All of the tokens being minted by a given MTx represent token types and unit quantities that the issuing authority is permitted to issue under the conditions of the contract that established the token ledger. A token has two types of “value” or units/quantity of resource associated with it:

1. The quantity of units (“token value” or “token units (TU)) of the tokenised asset/resource being represented by the token; this can be any type of asset, entity, item or resource. (For ease of reference hereafter we will simply use “resource” as including all of these terms). For example, but without limitation, the resource could be:
a physical resource such as car, house, racehorse, cinema ticket etc;
a legal right or obligation such as a license to use some resource such as a car, or run some software or download some content (e.g. movie) for a specified period of time; or an obligation to perform conditions of a contract; a share of a patent right;
a virtual and/or digital asset such as a right to access a computer network or file, or cryptocurrency, or a digital ballot paper or selection in a voting system; and/or
financially or corporate-oriented assets such as fiat currency, commodities, stocks and shares etc
   2. The non-negative portion of underlying cryptocurrency that has to be transferred as an essential mechanism of blockchain transactions;
   blockchain protocols operate via the transfer of some Satoshis (or other form of cryptocurrency units) from an output in one transaction to an input in another transaction; therefore, the skilled person will readily understand that while this is the underlying mechanism or vehicle that makes the disclosed blockchain-examples work in practice, the known art of cryptocurrency transfer is not the novel or inventive aspect of the disclosure; instead, the innovation lies in the disclosed tokenisation techniques, systems and protocols which utilise those known blockchain mechanics.

Tokens or token units are spent by transferring the underlying cryptocurrency, or portion thereof, (e.g., Satoshis) into a new owner's address using a Bitcoin script. Control of the satoshis (or other form of cryptocurrency units) represents control of the token. It should be noted that:
Tokens minted in the same transaction can have different underlying satoshi values.
A token can be configured as a static token, wherein each token's token value (i.e., quantity of resource units) does not change after minting irrespective of the number of times it is transferred.
A token can, alternatively, be configured as a dynamic token, wherein each token's token value (i.e., quantity of resource units) is changeable after minting irrespective of the number of times a portion of the token units within the dynamic token are transferred.
A static token cannot be split after minting, in that its value is fixed. Therefore, in an example, the underlying quantity of cryptocurrency units associated with a given static token cannot be changed after minting. However, in other examples the protocol may permit alteration of the number of cryptocurrency units in certain ways as long as the token's original token value specified by the minting transaction is not altered. For example, an issuer could issue a token with X underlying Satoshis and then create an output that contains X+Y Satoshis. This would enable a user to draw down on Y to pay transaction fees for transferring that token on condition that the number of Satoshis never reduces to below X as a balance. In this way, the token value can be supplemented but is retained.
A static token can be configured such that it's satoshi value is disconnected from its token value such that it may be transferred from an output containing satoshis into an output containing zero satoshis which contains a script which may or may not be spendable. This would be effected by placing the token into a register which gives the register operator control of the token. The satoshis in this process may be consumed in transaction fees allowing the underlying satoshi value to be disposed, leaving just the non-transferrable right to the token.
A dynamic token can be split after minting, in that its value is changeable. Just like static tokens, they are defined as tokens that exist in their current state within an unspent transaction output (UTXO) attributed to the token units therein. In order for the tokens to be transferred or otherwise used, they must be spent from their existing location in the UTXO set into a new receiving script. A dynamic token has a number of tokens units that are analogous to the balance in a bank account, wherein the balance is updated each time it is used. The history of the token is stored as a series of input-output pairs which can be linked either linearly or through the matching of a keychain to outputs mixed across a series of transactions. The use of mixing can be managed within a ledger with the assistance of a trusted third party which can be the token issuer or another institution that is assisting the user to manage their tokens.

The tokens can be created such that the output scripts require any desired variation of signatories. This provides a significant benefit in terms of flexible script options for receiving tokens into, and enhanced functionality. Bitcoin-implemented examples include, but are not limited to:
Example 1: Simple cash output
   <pubkey> CHECKSIG
   This is one of the simplest scripts in Bitcoin—a single signature check against a public key can transfer ownership/control of the tokens
Example 2: Joint Account
   1 <husband_pubkey> <wife_pubkey> 2 CHECKMULTISIG
   This script allows either the husband or the wife to transfer ownership/control of the tokens
Example 3: Corporate Account
   <department_VP_pubkey> CHECKSIGVERIFY 1 <engineer_1_pubkey> <engineer_2_pubkey> <engineer_3_pubkey> 3 CHECKMULTISIG
   This script allows 1 of 3 engineers to sign before passing to their department VP for countersignature to transfer ownership/control of the tokens

Token Sub-Ledgers:

With reference to FIG. 9a, examples of the disclosure provide the ability of the issuer to establish secondary, self-contained Token Sub-Ledgers within their Token Ledger. This can be performed through the performance of an establishment transaction within the primary token ledger that uses the issuer's authority (depending on the example) of the main establishment transaction to create a sub-ledger to manage a particular set of tokens from the primary token ledger. Tokens transferred into the token sub-ledger can be given additional properties or different properties relative to those in the primary token ledger or can be used as a reference or source for the minting of new tokens of different types. These additional or changed properties are defined in the establishment transaction in the same way as the primary Token Ledger's properties are defined.

Where no additional or changed properties are defined, the token sub-ledger retains the same properties of the token ledger within which it was created. When tokens are issued within a token sub-ledger, the use of those tokens is restricted to the bounds of that token sub ledger. Tokens created in a token sub-ledger cannot be transferred into the primary token ledger. However, tokens from within the primary token ledger can be used as inputs to a token sub-ledger minting transaction and broken down into smaller token sub-units or sub-types within the token sub ledger.

For example, consider a scenario in which a company creates software. The company can build a token which represents a license to install a particular piece of software. Each time a user purchases a license, one of the tokens holding the license rights is used as an input to a new token sub ledger. Each time that customer uses the software in such a way that a record is created, that record is created within their own private sub-ledger which exists within the company's primary token ledger. Records can represent events and actions such as additional in-application purchases, the performance of software updates or the creation of files and other information.

By way of example, the token holding the license rights can be a static token. Said static token can be configured to expire or be annulled (e.g., in a register). This application embodies an example of a token that has a ‘zero-value’ output, which allows a controlling entity to provide access via a token that is not created to be transferrable e.g., an access code to a resource, certification, a qualification or award. When the zero value outputs can be spent, the token can be configured with functionality that enables the token to be withdrawn or rescinded. A token can be withdrawn or rescinded by creating a zero-value output with a script that can be solved, allowing the output to be presented as an input to a valid transaction. A token can also be withdrawn by spending an output containing information that annulled its validity e.g. a ‘FALSE’ output.

In this valid transaction, the token may be spent into a false output or some other script to reflect the changed conditions of ownership or the termination of a token's lifespan.

Transferring & Validating Tokens on a Blockchain

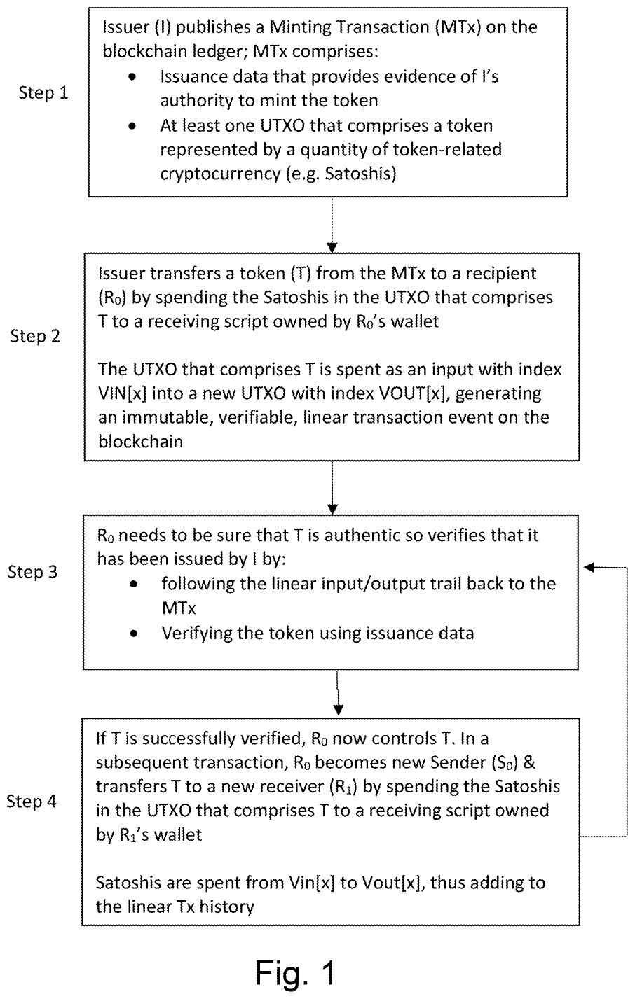

As shown in FIG. 1, after a token has been minted it can be transferred or “spent” from a sending party to a receiving party. The first transaction will spend the token from its T-UTXO in the Minting Transaction output list to an input in a further transaction. From there, the token can be spent to another recipient and so on, generating an evolving transactional history on the blockchain with each spend event. When a dynamic token is used, it can be retained, and it is the token units within that token that are exchanged (unless the token is exchanged as a whole).

While variations of aspects and examples will be readily apparent to the skilled person, all tokens minted in accordance with the present disclosure share at least one of these features:
Each token is generated as an unspent transaction (T-UTXO) that is included in a minting transaction (MTx) formed in accordance with the present disclosure.
Each T-UTXO comprises a specified amount of cryptocurrency in compliance with the underlying blockchain protocol; in the Bitcoin protocol this would be zero or more Satoshis. This may be referred to herein as a quantity, amount or portion of token-related cryptocurrency (TRC) to distinguish it from the cryptocurrency (C) that is spent from a previous transaction into the Minting Transaction to enable the individual T-UTXOs to be created.
Each token represents a tokenised resource; therefore, it has an associated value arising from or associated with that resource. This may be referred to herein as the token's “face value”, “denomination”, “token units” or its “token value” to distinguish it from the value or quantity of the underlying cryptocurrency that carries the token for the purpose of enabling transfer over the blockchain in accordance with the underlying blockchain protocol.
In use after minting:
Each token is represented as a UTXO in a blockchain transaction; these transactions and UTXOs do not deviate in terms of formatting or appearance from conventional TXs and UTXOs. Examples of the disclosure do not require any deviation from, or alteration of, the underlying blockchain protocol.
Each user's tokens are stored using a script in accordance with, and specified by, the issuer's requirements. As the skilled person will appreciate, this can be achieved using known techniques such as multi-signature scripts, using accumulator scripting to capture different authorisations and structures or a simple standard P2PKH script or otherwise.
Each token, or the token unit, can be traced back, via its history on the blockchain, in a linear fashion to the Minting Transaction that created it; this enables authorisation and source to be verified to prevent counterfeiting and other unauthorised usage.
Each static token is transferred from a sender to a recipient by spending the UTXO that comprises it into an input in a subsequent blockchain transaction. Each time a token is transferred over the blockchain, a linear transfer is performed in that transaction graph i.e. history of the token does not contain any splits or re-combinations.
Each dynamic token has token units that are transferrable from a sender to a recipient by spending the UTXO that comprises it into an input in a subsequent blockchain transaction. Each time a token unit is transferred over the blockchain, a linear transfer is performed in that transaction graph of the token unit.
In order to ensure that the token, and the token unit therein, is a genuine, authorised token/token unit for the purpose and of the source expected by the recipient, the transactional history of the token can be verified easily, quickly and efficiently by tracing it back to the Minting Transaction which issued it and checking it against the Minting Record and/or certificate.

When a token is to be sent to a receiver (which would initially be the Issuer, and subsequently a different owner) the sender's digital wallet can spend the UTXO to a locking script controlled by the recipient's digital wallet.

In an example, the receiving wallet has been arranged and configured in accordance with the protocols and methods of the present disclosure. Therefore, the receiving wallet knows that it is expecting a token, or a sub-set of the token units therein, in accordance the present disclosure and must verify that this is the case either upon receipt or before the transaction. The receiving wallet knows the VOUT index of the UTXO that the token is contained in, so initiates a verification check of the token's history by checking that the cryptocurrency that was spent to that UTXO came from an input residing at the VIN index that matches the UTXO's VOUT index, and that this in turn came from a UTXO whose cryptocurrency came from an input residing at the VIN index that matches its VOUT index and so forth until the token MTx is reached.

The scanning process continues until a blockchain transaction is reached where the VOUT holding the token has no corresponding VIN. In other words, the linear transaction history terminates. If the transaction does not have a corresponding VIN, either the transaction is the minting transaction, or the token is invalid. From here, the scanning process reads the Minting Record from the corresponding/designated output and validates that the token is genuine and was minted in a transaction that carries the signature of the issuing party's representative.

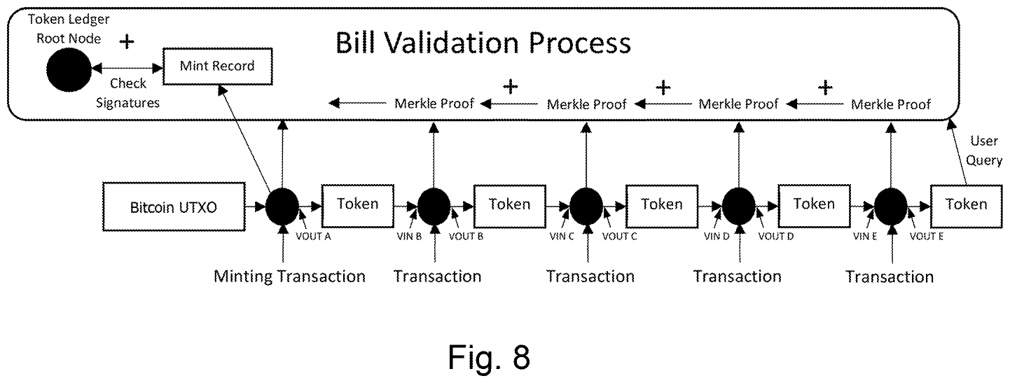

Thus, in order to verify a token's history, the wallet uses the aggregate Merkle proofs of each transaction it has been used in on the blockchain since it was minted. This is illustrated in FIG. 8. As each token is created within a unique UTXO and is transacted without splits or combinations, its history is linear and can be quickly checked on the ledger. By way of example, a token with a 1000 transaction history would carry approximately 1 MB of history assuming 100 billion Txs/day on the Bitcoin blockchain due to the size of the Merkle proof data. As the Bitcoin ledger is publicly inspectable, wallets and third parties are able to verify tokens on behalf of other parties and users.

It should be noted that the disclosure does not preclude the use of conventional UTXOs as inputs, nor the creation of conventional UTXOs as outputs in transactions that include the transfer of tokens. Therefore, a transfer transaction can also comprise one or more UTXOs and/or inputs that are not formed or used in accordance with the present disclosure, for example, inputs created by other token protocols.

Group Transactions

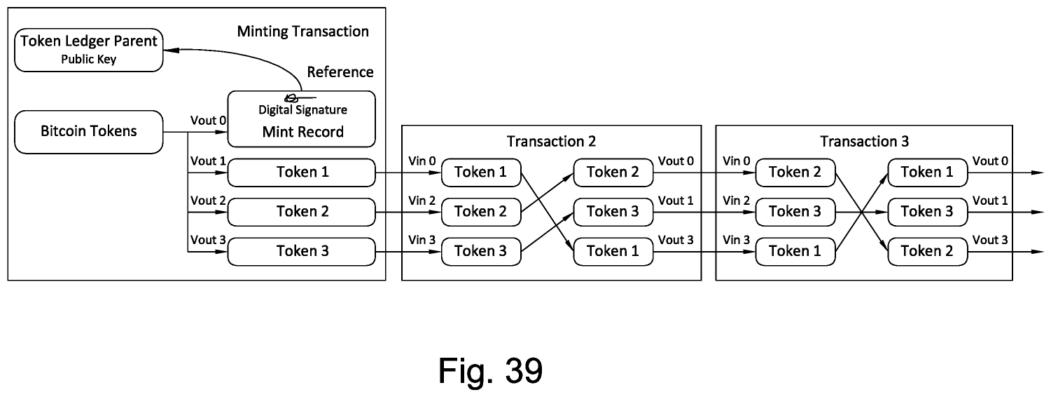

In some situations, more than one static token may need to be transferred, or token units from different dynamic tokens are to be combined within a transaction. Additionally, or alternatively, a service provider (e.g. payment processor) may elect to take transactions from several parties and merge them into a single transaction for the sake of efficiency and resource management. This also provides the advantage that tokens can be mixed, and ownership obfuscated. This can provide security benefits because a malicious party cannot identify the owner of a particular token and thus target an attack. Therefore, a transaction can be used to take token inputs from multiple users and send different tokens to the desired receivers other than the ones signed by the spending party. Similarly, in relation to dynamic tokens, the initial value of token units in a transaction is visible to the receiver and information can obfuscated using a transaction as described in relation to FIG. 39, below.

For example, as explained above, an individual token has a token value. If a user wishes to transfer a given amount of token value, but no single static token has been minted of sufficient token value or a particular user's wallet does not control a single token of that value, multiple tokens with smaller token values will need to be sent so that they add up to at least the desired overall token value. In such situations, the sending party's wallet selects tokens that it controls and (at least partially) signs multiple token UTXOs in a blockchain transaction (Tx) which add up to at least the required overall value. We may refer to this transaction as a “group transaction” (GTx) because it groups or clusters token outputs together into one blockchain transaction. Thus, there may be a need to generate blockchain transactions which mix tokens, and tokens transferred to a given receiver may not be the same ones that were received from the sender. This gives the advantage of enhanced privacy (as token distribution is obfuscated) and improved efficiency.

If required, a sender can cryptographically sign static tokens that add up to a higher value than required. Depending on the implementation required, such scenarios will result in change being sent back to the sender. In examples which are implemented on a Bitcoin blockchain, the user's signature uses SIGHASH_ANYONECANPAY and SIGHASH NONE. This effectively creates a signature that can be applied to any signed UTXO that can be applied to any input in any transaction. Other flags, instructions or OPCODES may be used to provide the same technical result in accordance with alternative blockchain protocols.

In some examples, transactions may be processed in a payment channel. When a user's wallet receives new tokens they can be stored for onward payment at a later date. If the user needs to make a transfer for a certain overall token value, tokens can be selected from the wallet and added to the group transaction. The transaction may have a time lock mechanism (e.g. nLocktime) that prevents it from being mined by the blockchain network until a particular time, or until the subsequent block is found. Tokens are added to the payment channel. When a group transaction is being updated in a node's public mempool, the wallet evaluates the TXID of the transaction that was included to check which version of the group transaction was recorded and begins building a new transaction for the payment channel.

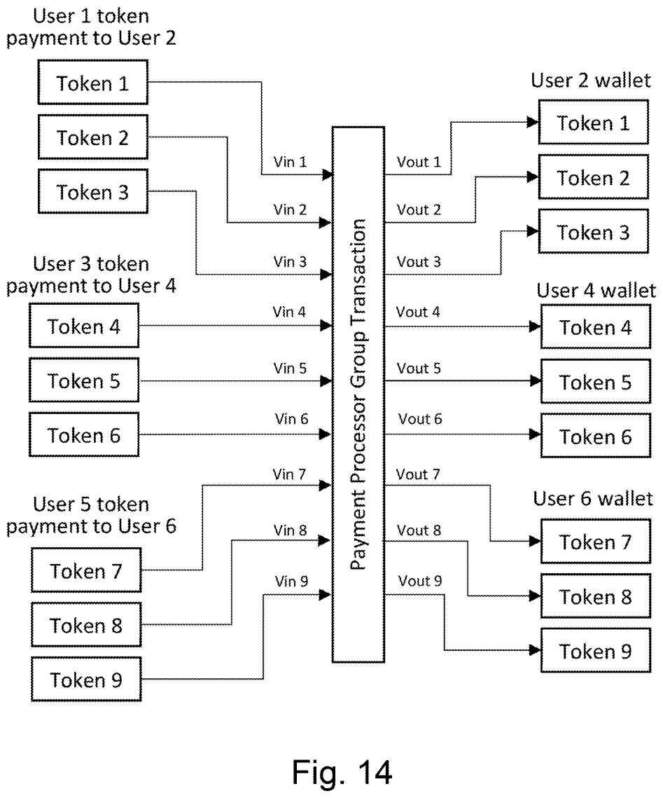

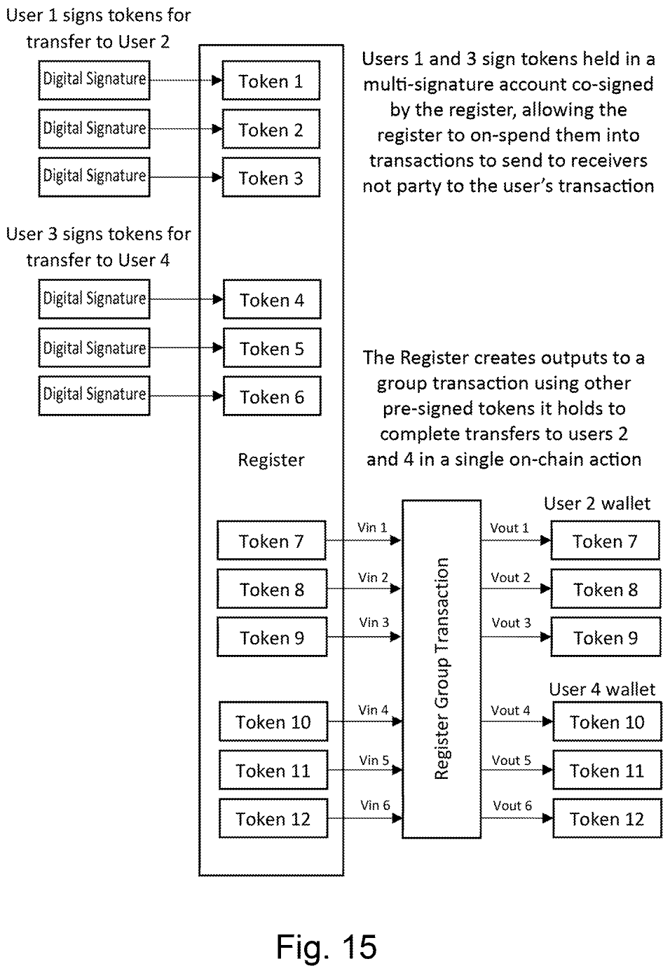

The “group transaction”, GTx, process is illustrated with reference to FIGS. 14 and 15 in which, solely for the sake of convenience and ease of understanding, static tokens are shown which represent fiat currency banknotes and coins. Additionally or alternatively tokenized units that reside in a dynamic token can be placed into a payment channel. This can function to lock the dynamic token. We use fiat currency for the examples in FIGS. 14 and 15 because cash bills and coins are readily understood and familiar. FIG. 5 also illustrates how static tokens retain their token value regardless of the number of times they are transferred.

Re-Stamping or Destroying Tokens

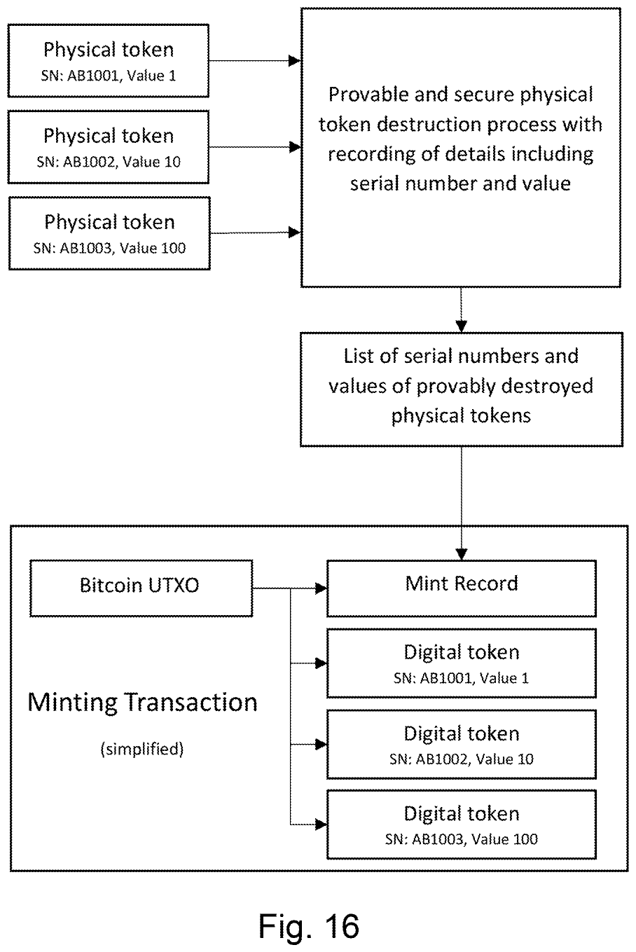

Tokens can exist digitally or physically, and FIG. 16 illustrates a process in which 3 physical tokens having their own distinct value and identification are controllably destroyed in a process that records their details and destruction. Using the recorded details, equivalent digital tokens can be minted in a minting transaction, preferably performed by the issuer, thus creating a mint record. The mint record occurs separately from the destruction (which can be physical) and provides a new mint record that can be used to validate a token's authenticity. The digital tokens can have the same serial numbers and values. The UTXO from the controllably destroyed tokens can be used in the creation of the new digital tokens. In this way the transition from physical to digital is seamless and has no impact on the linear transaction history, except that verification of the authenticity of the digital tokens extends back to the most recent mint record i.e. a record of the physical tokens will have been created, and a subsequent MTx can be the most recent further minting transaction of the digital tokens.

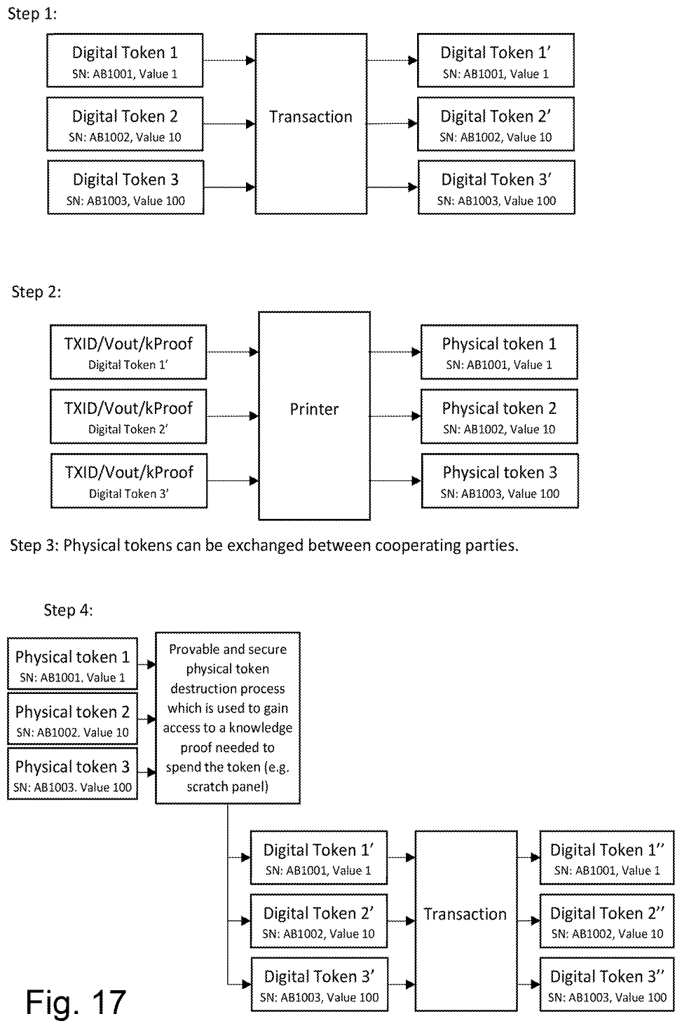

Each token can have a unique identifier e.g. serial number and token value, which can be locked into a script controlled by an issuer who can then create sub-tokens, which can be physical or digital embodiments of the digital tokens. This unique identifier can be outside of the identifying issuance transaction identification and vin/vout index pair. These unique identifiers can be verifiably linked to the digital token, and then destroyed by depositing them back into the control of the issuer. The format of the transfer can be one of four different types, or steps, as shown in FIG. 17. Step 1 involves a simple digital transaction from a digital-to-digital format. Step 2 involves processing a digital token and its information output from a transaction, such as the transaction identification, output from the transaction and/or knowledge proof. This information can be used to print or otherwise create physical tokens. Step 3 is not shown and involves the handover of physical tokens from one person to another. Step 4 shows a combination of the conversion of physical tokens to digital tokens, and a subsequent transaction using the digital tokens thus demonstrating that token identities and values can be maintained as tokens are exchanged between formats.

FIG. 16 has been described above as physical tokens, wherein said tokens are a physical representation of a digital token. Each of the physical tokens can alternatively be fiat currency e.g. three £10GBP notes with serial numbers. By way of example, an authority such as the Bank of England can take physical monetary notes, record their serial number and destroy them before subsequently minting digital tokens, as disclosed herein, with the same serial number and same monetary value.

In the examples of FIG. 17 the token identification and value has remained the same. It is feasible, however, to amalgamate the tokens, by combining the value, or sub-dividing the value. For example, digital token 1′ and digital token 2′ can be consolidated into a single token having a value of ‘11’. In another example, digital token 3 can be divided into equal parts to become digital tokens 3a and 3b, each with a value of ‘50’.

Tokens can be spent into a transaction, and then the format is corrected within the same transaction. In this case, the satoshis that represented the tokens being re-used to utilise the same tokens after breaking their linear history.

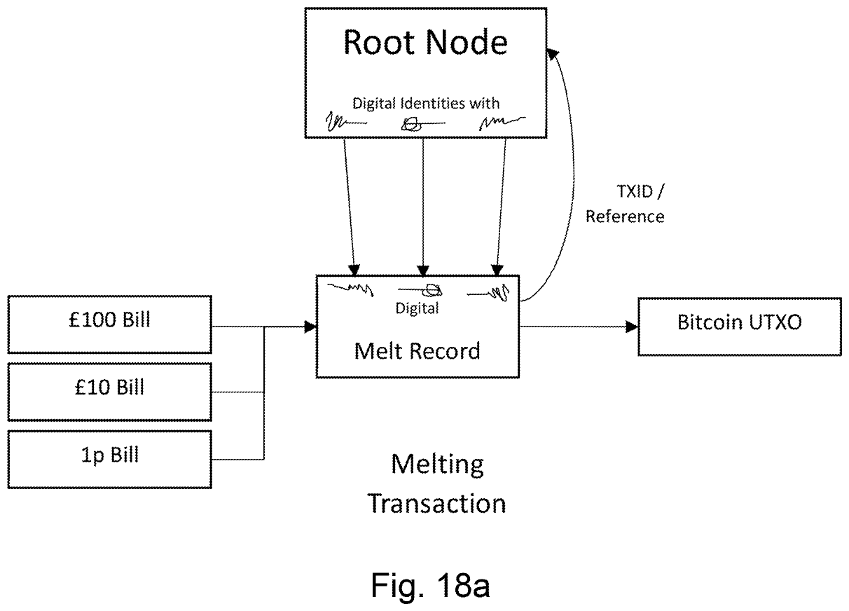

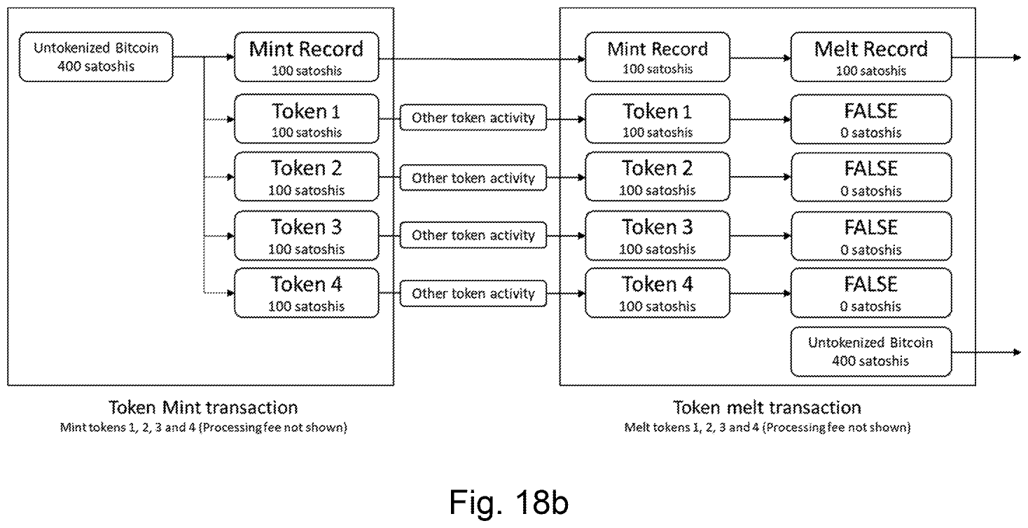

Under some circumstances token issuers may wish to remove tokens from circulation. FIGS. 18, 19 and 20a illustrate the use of transactions to perform melting and re-minting operations.

In examples of the system where the issuer controls the tokens directly by holding them in a single register, the tokens can be removed by the issuer by spending them out of the register into a Melting transaction, removing the tokens and the underlying cryptocurrency from the token register, as shown in FIG. 18a. FIG. 18b illustrates the step of a melting transaction in more detail, wherein the melt transaction includes the mint record and a melt record, such that the destruction of the tokens is recorded on the ledger. It is to be noted that during a melt transaction the tokens can be spent into FALSE outputs, or otherwise resulting in their destruction.

Update Tokens

While tokens can be destroyed, or melted, and their UTXO can be retained to be spendable outside the tokenized system, any subsequent re-minting can replace the tokens with new tokens. In this case, the previous tokens are spent in such a way that verification of the token's authenticity requires a validation of the most recent minting record, such that the linear history is broken. Alternatively, the previous tokens are updated having the same, or new, identity and equal total value i.e. same value and serial number, except that the issuer is not involved. In both cases, the previous tokens are spent in such a way that verification of the token's authenticity requires a validation of the most recent minting record, such that the linear history is broken. However, by updating the previous tokens they are spent in such a way that verification of the token's authenticity is retained, with the linear history interrupted.

In the latter example, however, the tokens are preferably ‘updated’ rather than re-minted. While the UTXO is reused or re-minted, the process functions to replicate existing tokens, wherein said replication utilizes a re-mint action the update or replication does not require a return to the issuer. A re-mint action involving the issuer and/or authority can be considered as analogous to a re-boot or re-installation of an operating system of a computer controlled device e.g. a CNC machine, while an update to such an operating system involves significantly fewer interruptions or operations resulting in a more efficient and cost effective process—it follows, therefore, that the inventor has sought to improve upon the re-minting techniques herein.

As described above, a token with a 1000 transaction history would carry approximately 1 MB of history assuming 100 billion Txs/day on the Bitcoin blockchain. When a recipient of a token unit verifies the authenticity of a token unit its full transaction history is checked using a Merkle proof. As the transaction history becomes longer the burden on the verification check becomes greater. Therefore, re-minting resets the transaction history by involving returning the tokens, reminting the tokens and re-issuing the tokens. As illustrated, the specific details, such as serial number and value of the token can be ‘reset’ and re-issued. Transactions that perform these re-stamping or re-minting actions can be performed by the issuing authority.

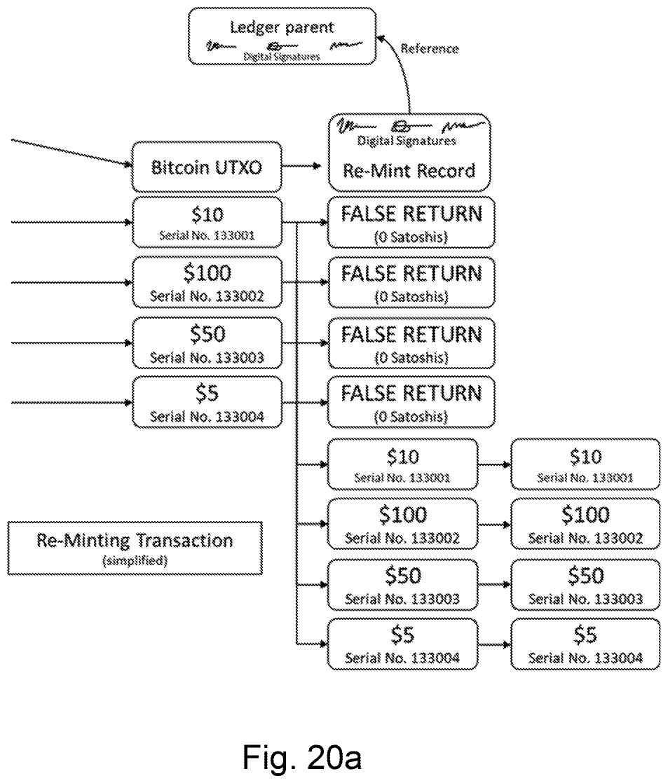

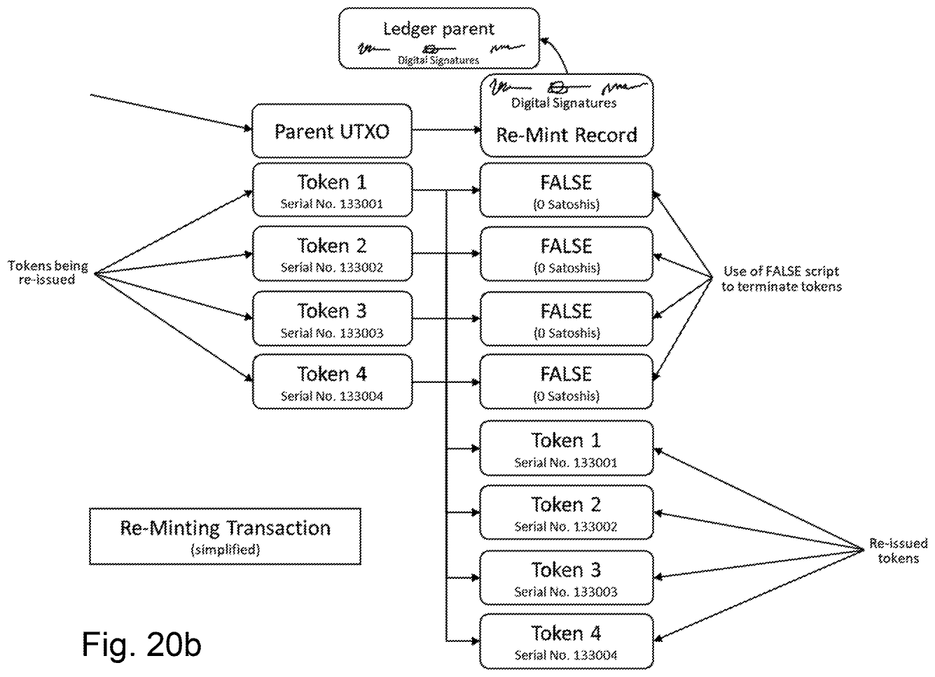

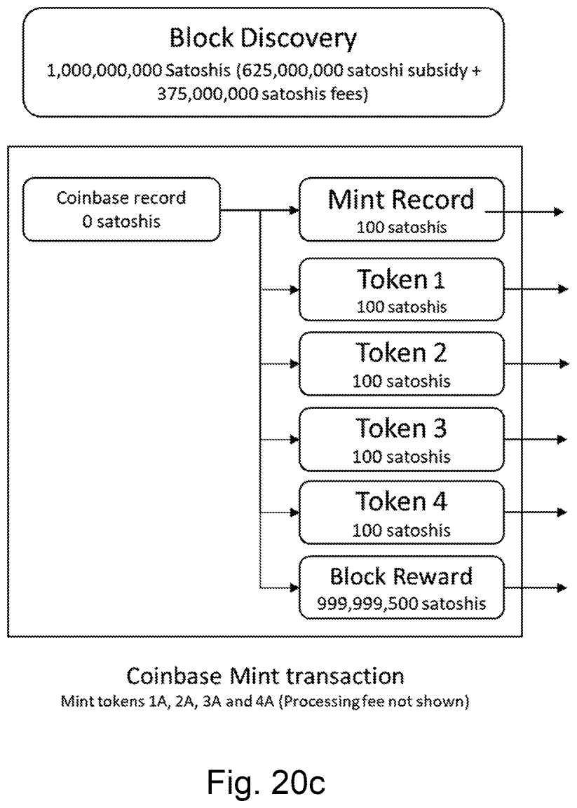

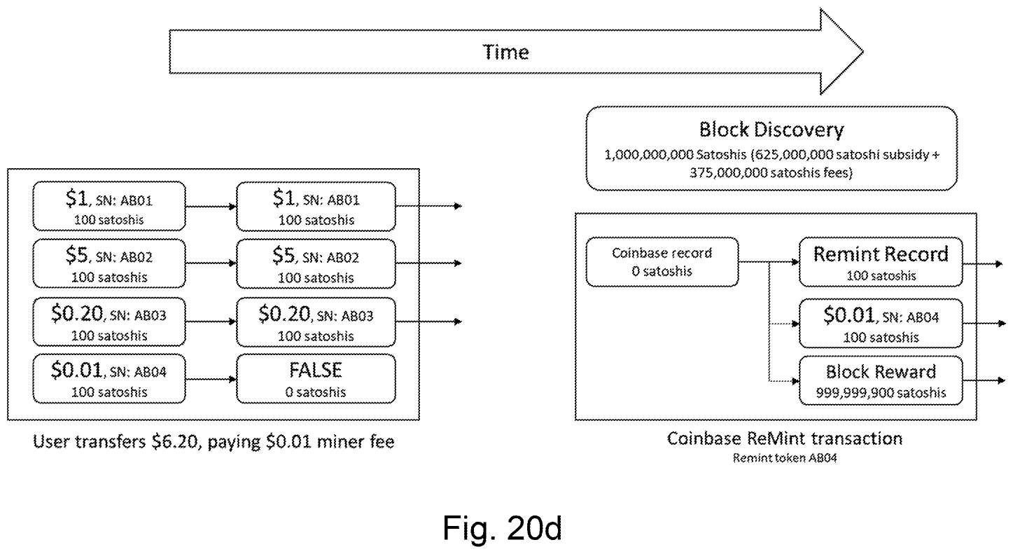

FIGS. 20b, 20c and 20d illustrate the use of transactions to perform updating operations, which functions to re-mint and replicate a token in a fewer transactions. To prevent users from fraudulently stamping them with incorrect information any update of a token to reset its history must also include a ‘Minting Record’.

An issuer may not have the ability to remove tokens, and the issuer creates the mint record as a spendable UTXO. When tokens need to be removed from circulation, the mint record can be spent into a new output that contains details of the expired tokens. In this way when a user does a validation check on the linear history of the token they can see if the token is still current. A user can also validate the signature check on the transaction (node) edge. During an update of a token, the issuer's certificate can be spent into a new output or the signatures of the issuing authority, as per the specifications of the particular token ledger, can be included in the update transaction that functions to replicate the token.

In yet another example, the issuer may publish information regarding the removal from circulation of tokens with certain properties and offer replacement tokens of the same value to users who transfer the obsolete tokens back to the issuer's control. This method allows the tokens to continue to circulate naturally, allowing people to hold the old versions as collectible items or simply as untouched savings without risk to the token value.

In another embodiment, tokens may be spent into a transaction, and then ‘refreshed’, re-issued or updated from within the same transaction, as shown in FIG. 20b. In this case, the same satoshis that represented the tokens being re-minted are re-used to create the same tokens, with a refresh reference that is analogous to a minting record, such that the tokens are updated. The refresh reference is enabled by at least one of the root node, ledger parent or issuer certificate signing the transaction, said signature functioning like a minting transaction by enabling authentication of a token to verify the linear transaction back to the refresh reference. Additionally or alternatively, the transaction that updates tokens can be performed by an agent of the issuer/authority, which can be a delegated to a node or miner that holds a digital signature of at least one of the inaugural transaction, token definition transaction and the token issuance transaction, said signatures created as spendable UTXO.

This method keeps the same tokens in existence while minimising the overhead needed to handle them. The overhead is minimized because the refreshing can be implemented in a single transaction and avoid the need for the creation of a melt record and/or other associated transaction costs associated with a full minting transaction, such as new token creation or re-minting. In a refresh transaction the linear history is re-set such that the authentication of a refreshed token only needs to follow the linear transaction history back to the most recent refresh transaction.

Token ‘melting’ actions, re-minting actions or token ‘refreshing’ (updating) actions can be performed (i) by the issuer, (ii) by a node operator, or (iii) by a node operator who has been given permission and the authority to do so by the issuer. Token melting, re-minting or refreshing can be performed not only to reset the linear transaction history, but also to processes tokens that are ‘locked’ or unusable as a result of an incorrectly formatted transaction, or even through the loss of control of the keys needed to spend the tokens by the party holding them.

In the event that re-minting or refreshing (updating) of a token is handled by a node operator, each time a node discovers a new block within the on-going chain of proof of work that represents the blockchain, the node receives a reward in the form of some bitcoins that are distributed as a network subsidy, plus the transaction fees which have been paid in each transaction in the block. The node allocates these tokens to one or more outputs in a transaction called the ‘Coinbase’ which is the first transaction in the block's merkle tree. The node operator has the freedom to allocate these satoshis to as many outputs as are needed. When building a coinbase transaction, it would be possible for an issuer to collaborate with a miner in order to issue tokens directly within the block's coinbase transaction, including a mint record or refresh record as described herein.

In another example the issuer may have a contract with Bitcoin node operators who can remove the tokens from circulation by transferring them directly into a melting transaction, effectively transferring the tokens and the underlying currency from the user's wallets and back to the issuer. FIG. 20c illustrates a coinbase mint transaction, in which the node's reward is 1 billion satoshis, the coinbase record is zero satoshis and four tokens are output together with a minting transaction, each with a value of 100 satoshis, leaving the node with a block reward of 999999500 satoshis.

Transaction fees are normally paid in the same cryptocurrency of the blockchain on which the transaction is to be recorded. However, a token user can pay for transaction processing costs using tokenized assets, such as a token representing an item of legal tender, wherein the block winning miner who has a contract relationship with the issuer can re-issue those tokens using satoshis taken from a coinbase reward. An example implementation is shown in FIG. 20d, wherein a user transfers three tokens having a value of $6.20, and spends one token with a value of $0.01 i.e. SN.AB04, in to a false output. The winning miner can create a re-mint record in the coinbase transaction and award themselves the $0.01 token by way of a transaction fee.

Single Use/Sub-Tokens

Specific aspects of the dynamic token (dT) and the sub-tokens that can be derived from a dynamic token e.g. a single-use token (suT) and a second-order token (soT) will be described in more detail.

As described above, static tokens (sT) exist in their current state within an unspent transaction output (UTXO). In order for the tokens to be transferred or otherwise used, they must be spent from their existing location in the UTXO set into a new receiving script. Static tokens are analogous to a fiat note, such as a $1 bill, which is a fungible unit that carries a unique serial number. When the static tokens are used, there is no way to split or combine them, requiring tokens to be spent in large quantities for even small transactions. This is seen as an impediment to scaling the system using such static tokens beyond niche use-cases. Therefore, a dynamic token (dT) provides and an alternative and complementary token to a static token.

Dynamic tokens exist in the same way as static token, in that they are minted in a minting action in which the properties such as ID/serial number and denominated unit are defined. The dynamic tokens can be defined in denominations corresponding to static tokens. The token can be used to hold a dynamic token value which corresponds to a function of the satoshi value held in the token which tracks the number of token units held in the output. The history of the token is stored as a series of input-output pairs which can be linked linearly.

Alternatively, the history of the token can be linked through the matching of a keychain to outputs mixed across a series of transactions. A keychain is a deterministic chain of private keys, derived in a deterministic fashion from a root key. The keychain is used to manage passwords, by keeping track of and protecting the passwords, account numbers and other confidential information. An app can be used to manage and view the keychain. It functions as a secure and encrypted repository.

This is affected when participants in a transaction that is exchanging sub-units or full amounts more than two dynamic tokens at the same time agree to exchange their output positions to obfuscate their identities. Each user's wallet would use SPV records in the transaction plus a keychain or identity token, which holds the combinations of keys needed to unlock each UTXO held by the wallet. Because the wallet knows what script it used to lock the token, it can easily identify the output which contains its dynamic token even if it was unable to look for it until the transaction is finalised by another party.

Dynamic Tokens

Dynamic tokens can be minted in a similar manner to static tokens, in that they must be created by the issuer in order to hold quantities of denominated tokens. The tokens cannot be created or destroyed by their users unless through negligence or deliberate action.

During the creation of dynamic tokens, the issuer performs a minting transaction with a minting record. The tokens are defined as being created in a transaction where each new token is defined in an output for which there is no corresponding input indexed, and in which the first output is a valid minting record with the issuer's correct signature applied. All tokenized base units must be created inside a dynamic token minting action in order to be transferred between dynamic tokens.

The outputs from these creation or minting actions can be created as single-use dynamic tokens, created to be used with an already existing dynamic token in some subsequent transaction. In this way, the single-use dynamic token functions as a mechanism for distributing satoshis value to other dynamic tokens, while avoiding the unnecessary creation of a surplus of dynamic tokens that are not intended for further use.

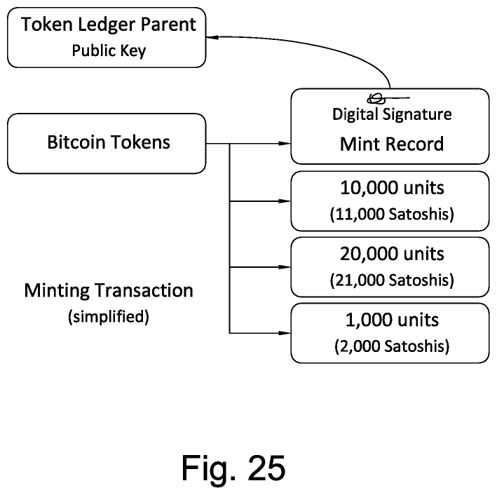

FIG. 25 illustrates a Minting Transaction in which three dynamic tokens that created. Each token is created with a ‘zero-value’ quantity. The zero-value quantity can be different among tokens with the same issuer and base token value. The zero value must be recorded as a parameter in the token's minting action. In FIG. 25, each dynamic token issued has a zero-point value of 1000 satoshis. Ideally, a dynamic token is represented as a UTXO with a zero satoshi value to indicate a zero-token quantity. While this is technically possible within the Bitcoin protocol, the implementation of this function is currently unsupported by nodes and expected to be supported in approximately 12 months' time.

The value of a dynamic token having a zero-value of 1000 satoshis can be calculated by taking its ‘zero point’ value in satoshis and subtracting it from the satoshi value of the output and multiplying the result by the denominated token value. By way of example, if a dynamic token denominated as 1 c per satoshi, contains 5,000 satoshis and has a zero-point value of 1,000 satoshis, the token's value is calculated as follows: Value=(5,000−1,000)×1 c=4,000×1 c=$40.00

Dynamic tokens can be denominated in any value but can only be used in transactions with tokens from the same issuer which are denominated in the same value.

There is no limit to the number of dynamic tokens used in a transaction outside of the restrictions imposed through the underlying blockchain protocol and consensus network. Therefore, a single dynamic token transaction can move value to/from multiple dynamic tokens without restriction as long as the transaction correctly balances the satoshi values of each dynamic token. In other words, the sum of the Vin and the sum of the Vout of all related dynamic token-units must be the same. Transactions costs are not taken in to account because they are external to the function of the token transfer mechanism.

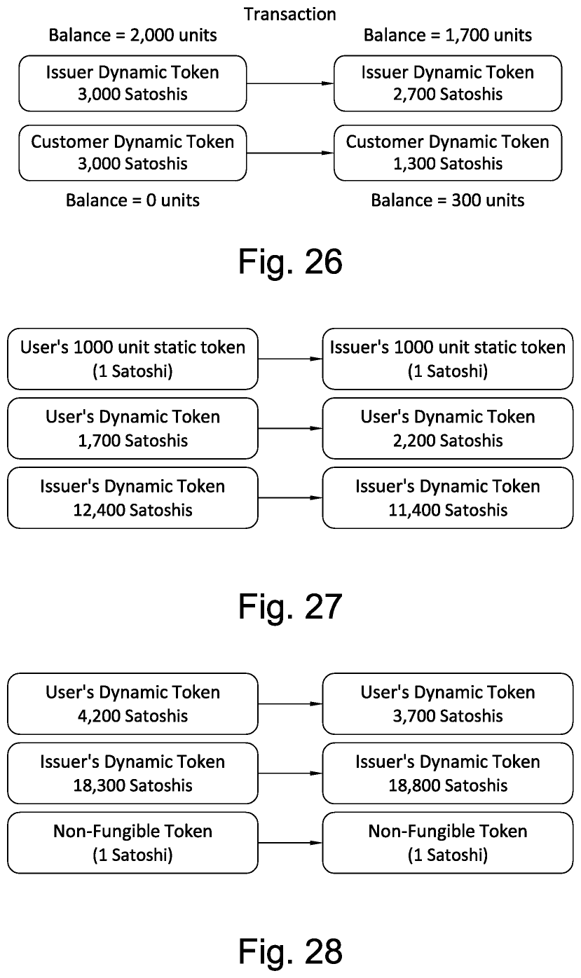

FIG. 26 illustrates the balance between the Vin and Vout, wherein a transaction moves 300 units of a dynamic token (having 3000 satoshis) from an issuer to a customer's dynamic token (having 1000 statoshis). In the transaction 300 satoshis are deducted from the issuers' dynamic token and 300 satoshis are added to the customers' dynamic token UTXO. The sum of Vin is 4000 satoshis, and the sum of the Vout is 4000 satoshis. This transfer can be considered a sub-element of a larger transaction which can include additional token inputs and outputs as well as un-tokenized bitcoin inputs and outputs.

An issuer may create sub-ledgers under which multiple sub-issuers are authorized to issue dynamic tokens that carry the same denominated token value, and these dynamic tokens can be used in transactions together, as long as there is a common parent issuer.

Dynamic and static tokens can also be issued which are fungibly interchangeable with each other. For example, a static token with a fixed value of 100 units may be exchanged in a transaction that applies 100 units to a dynamic token using the same token type. In this way, dynamic tokens can be used to manage small value transfers while static tokens can be used to carry larger amounts without requiring a heavy use of Bitcoin Satoshis to manage the full values of all tokens in the system.

FIG. 27 illustrates a user using a 1000-unit static token in a transaction to transfer 1000 units into the issuer's control in exchange for a 1000 unit increase to their dynamic token's token value. In this case the sum of the Vin is 14600 satoshis and the sum of the Vout is also 14600, thus the transaction is balanced.

During a transaction using dynamic tokens, the parties must assign new values to each which represent the updated balance of the tokens being used. Dynamic token outputs must balance to the satoshi in order to be considered valid. Using dynamic tokens in this way allows them to be mixed with tokens of other types, such as static tokens, tokens created with other token protocols and un-tokenized Bitcoin.

FIG. 28 illustrates an exchange of 500 token units from a user to an issuer in exchange for a non-fungible token, such as a collectible card, or access code for accessing a resource. As before, the sum of satoshis in Vin balances with the sum in Vout i.e., 22500 satoshis on each side of the transaction. It is to be noted that unless specifically mentioned non-token related inputs and outputs, e.g. associated with the fees, are not taken in to account in examples.

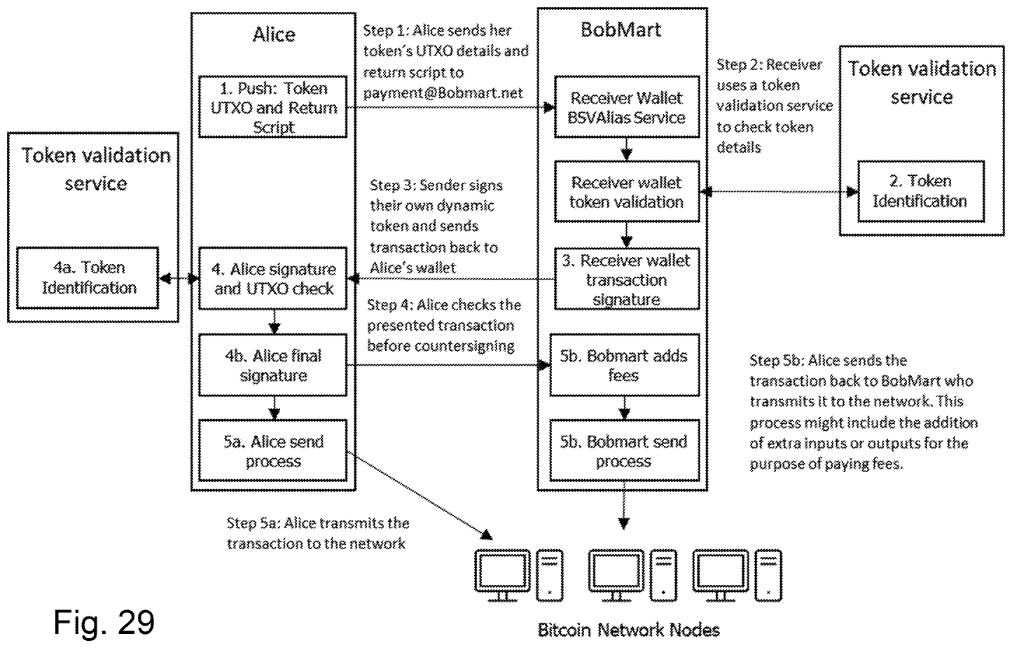

FIG. 29 illustrates an example of a transaction process between Alice (shopper) and BobMart (retail outlet), wherein transactions are signed by both parties and both parties must validate that the counterparty tokens being presented are correctly minted dynamic tokens. This example illustrates that a fungible exchange token can be used to hold units of a token that was exchangeable for a good or service. A dynamic token can be used alongside static tokens to create a multi-token transaction. BobMart is a large supermarket offering in-store facilities, such as pharmacies.

BobMart has a loyalty program that hands out small quantities of ‘loyalty’ token units associated with purchases that are made and uses a dynamic token to hold and distribute said token units to shoppers. Shoppers typically accumulate lots of small, diverse amounts thus the creation and management of static tokens down to the smallest denomination for all transactions would be inefficient and impractical. In the example of FIG. 29, Alice purchases $99 worth of groceries from BobMart and receives 99 loyalty points into her dynamic token.

In the process of BobMart providing the loyalty points to Alice a number of actions take place, including:

1. Alice prepares and sends her dynamic token UTXO details and a return script detailing the bitcoin script to use as the output for Alice's dynamic token to Bobmart, which can be via an email that Bobmart can access.
2. BobMart has a receiver wallet to provide the loyalty point service and uses a token validation service to verify Alice's token details. Token wallet validation can be performed by BobMart or a third-party support service, and functions to confirm Alice's token is the correct type of token e.g., a Bobmart loyalty token.
3. BobMart's receiver wallet builds a transaction that uses both Alice's and their own dynamic token which pays out the correct satoshi balance to the respective tokens. BobMart signs their own dynamic token—using SIGHASH_ANYONECANPAY|SIGHASH_ALL. BobMart can attach a fee input and pay change out within the transaction. BobMart then sends the partially signed transaction back to Alice for final signature and sends the transaction back to Alice's wallet.
4. Upon receipt of the transaction built by BobMart, Alice (a) checks the validity of BobMart's token, or uses a third-party support service to do so, before (b) checking the presented transaction and applying her final signature.
5. After signatures are applied, either (a) Alice can transmit the transaction to the network that holds the ledger, or (b) Alice signs and send the transaction back to BobMart, who will transmit the transaction to the network that holds the ledger.
6. Minting Transactions can include static tokens, dynamic tokens or a combination of both. If the token value of the static tokens is denominated in the same token type as the dynamic tokens, then they can be used in conjunction without any impact on the token ledger. The static tokens are fungible, while the dynamic tokens have token units that are fungible. In practice, when large purchases are involved e.g., a holiday or a vehicle purchase, a loyalty program can use static tokens to enable large numbers of loyalty points to be exchanged without tying up large amounts of Bitcoin in dynamic tokens. When the loyalty tokens are spent, the large value static tokens can be spent in the same transactions as the small denomination dynamic tokens for a fungible amount.

Token validation can be provided by at least one of: token validation services; scanning the ledger history; and sharing/receiving a full transaction history in preparation of a transfer.

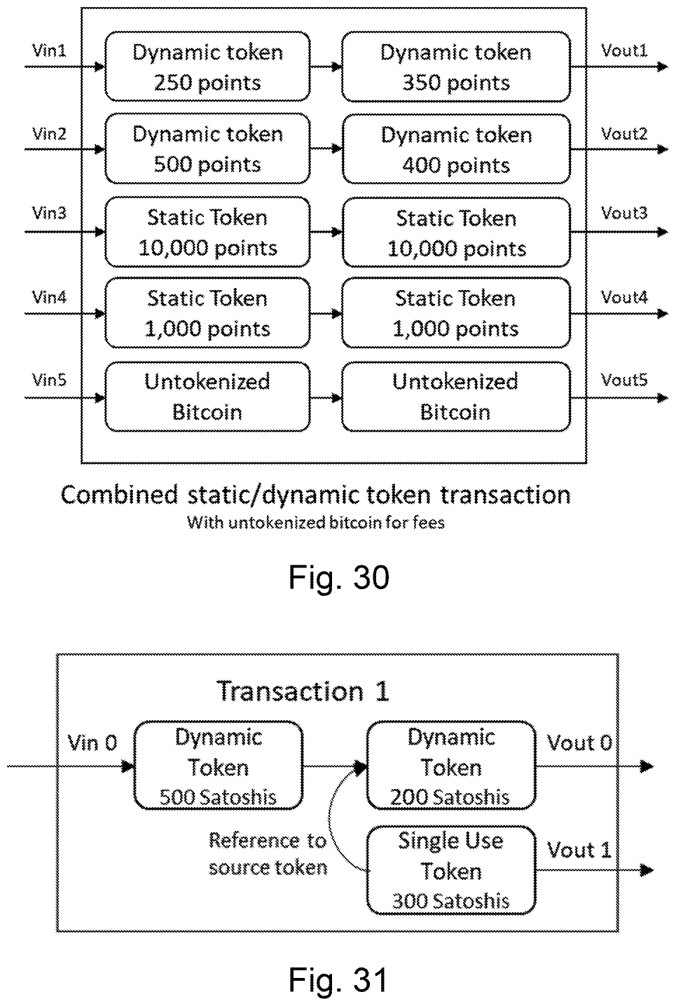

FIG. 30 illustrated a transaction in which Alice wishes to use 11,100 loyalty points in the BobMart store. Neither static nor dynamic tokens are suitable for use alone. Therefore, Alice uses a combination of a 10,000-point static token and a 1,000-point static token and spends them in conjunction with 100 satoshis from a dynamic token to reach the exact amount Alice wishes to use. In the transaction, BobMart's dynamic token is Vin1, and Alice's is Vin2. Static tokens occupy Vin 3 and Vin4, while Vin5 is an amount of untokenized bitcoin to pay mining fees. The static tokens (worth 11000 points) are paid into BobMart's holding wallet and can be either recycled or redistributed, while 100 points are transferred from Alice's dynamic token to BobMart's dynamic token.

Static tokens could be minted with the smallest denomination of token units or points; however, it would result in a less efficient use of Bitcoin and reduce the efficiency of transactions and, ultimately, the ledger.

Single-Use Sub-Tokens

To optimize the use of the tokens and system of the invention a further token is disclosed i.e., a sub-token. Static tokens are suitable for large or bulky transactions and dynamic tokens provide a degree of flexibility. In a further example, a sub-token in the form of a single-use sub-token (suT) can be created from a dynamic token to create a single-use fungible token that is digitally or physically transferrable to a dynamic token utilizing the same type of token units. The single-use sub-token value can be set at any value up to the maximum number of token units held in the originating dynamic token.

A single-use dynamic sub-token is created by splitting the satoshis held in a dynamic token. Through the dynamic token from which it was created, the single-use sub-token has a history traceable back to a minting action. This can be achieved through its relationship with the dynamic token that created it. A single-use sub-token is created by spending from a dynamic token (or tokens) into a transaction with one or more extra outputs. A dynamic token must be used in a transaction that receives or ‘picks up’ the outputs from a sub-token, which can be enabled with minimal complication via script, which can reduce the overall cost. A dynamic token receiving a single-use sub-token must have the same base value i.e. they must share the same correlation between the quantity of base token units and the underlying cryptocurrency.

A single-use sub-token holds UTXO. When spending said UTXO it must be spent in full thus transferring all the cryptocurrency units e.g. satoshis into a dynamic token.

The satoshis can be spent into a new single-use dynamic sub-token in the same transaction, and the base token protocol, such as the BSV protocol, regards this as two separate actions. The first action happens on the input side, where the dynamic token owner claims the single-use sub-token. The second action happens on the output side where the dynamic token owner creates a new single-use sub-token.

In some examples, the token type description in the Minting action would include a permission e.g. by way of a data flag, for the dynamic tokens to be split to form single-use tokens, and the wallet software that is using the token would know how to create and use single-use tokens.

In one example of the single-use sub-token, it is ‘minted’ as a child token that references the parent dynamic token by referencing which output it is in the transaction. The minting of a sub-token can be identified by the absence of an input. Further, script can be used to identify the sub-token e.g., the type, the resource to which it has access, the value, evidence of the minting transaction, the permission to be provided to a third-party. A single-use sub-token is created by spending some of the satoshis contained in the dynamic token into a new output. The dynamic token holder can use the right conferred to them by the token issuer in the minting action to do this. In some examples, this might be an administratively applied right which is understood by the wallet, but not validated by the Bitcoin consensus network, but in other examples it can be a function which is implemented as an OP_TX style lookback signature check.

FIG. 31 illustrates a transaction in which a single-use sub-token is created from a dynamic token. Vin0 is 500 statoshis within a dynamic token and the output is split between said dynamic token that receives 200 satoshis in change on Vout0, and a single-use sub-token having a value of 300 satoshis on Vout1. The single-use sub-token inherits the token properties of the parent, using its linear history back to the minting action to determine the token type and denomination.

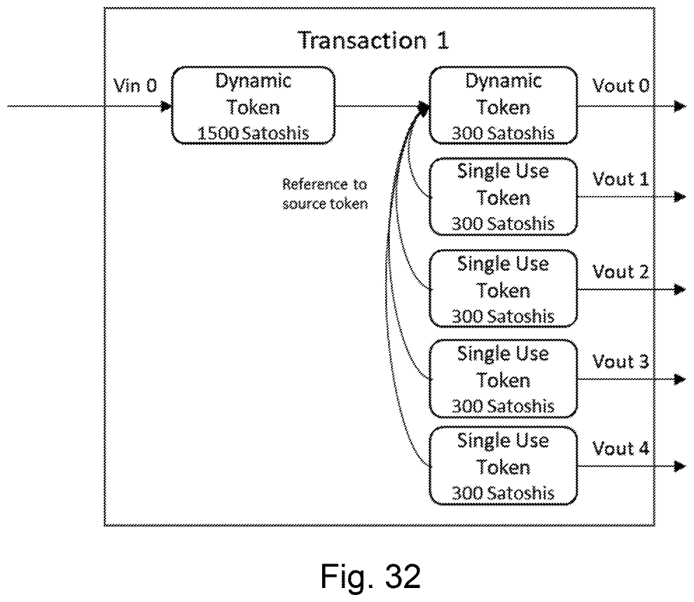

FIG. 32 illustrates a transaction in which four single-use sub-tokens of equal value are created from a dynamic token having a Vin0 value of 1500 satoshis, that is split between Vout0, wherein 300 satoshis are returned to the dynamic token in Vout0, while 300 statoshis are output on each single-use sub-token on Vout1, Vout2, Vout3 and Vout4. Each single-use token inherits the token properties of the parent.

Single-use sub-tokens must be spent in a transaction with another dynamic token, in order to be used. In practice, a user can accumulate multiple single-use sub-tokens, each of which can hold a different value, and choose which one to spend in which transaction.

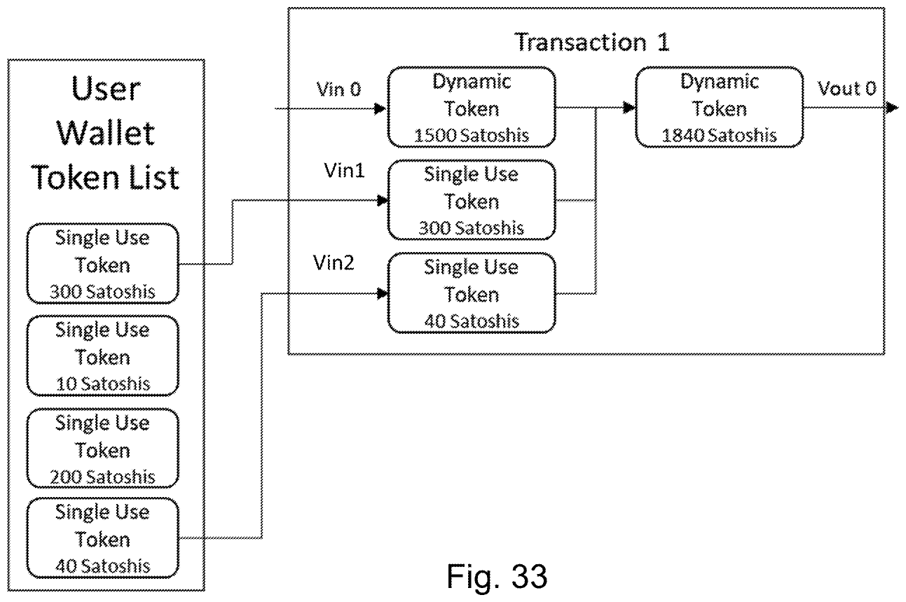

FIG. 33 illustrates a transaction in which a user selects two, from four, single-use sub-tokens from their wallet and spends the single-use sub-tokens in a transaction with their own dynamic token to increase the value of the satoshis held in their dynamic token. In this example Vin0 has an initial value of 1500 satoshis, two single-use sub-tokens having values of 300 satoshis (Vin1) and 40 satoshis (Vin2) are added to the dynamic token such that Vout0 value of the dynamic token is 1840 satoshis.

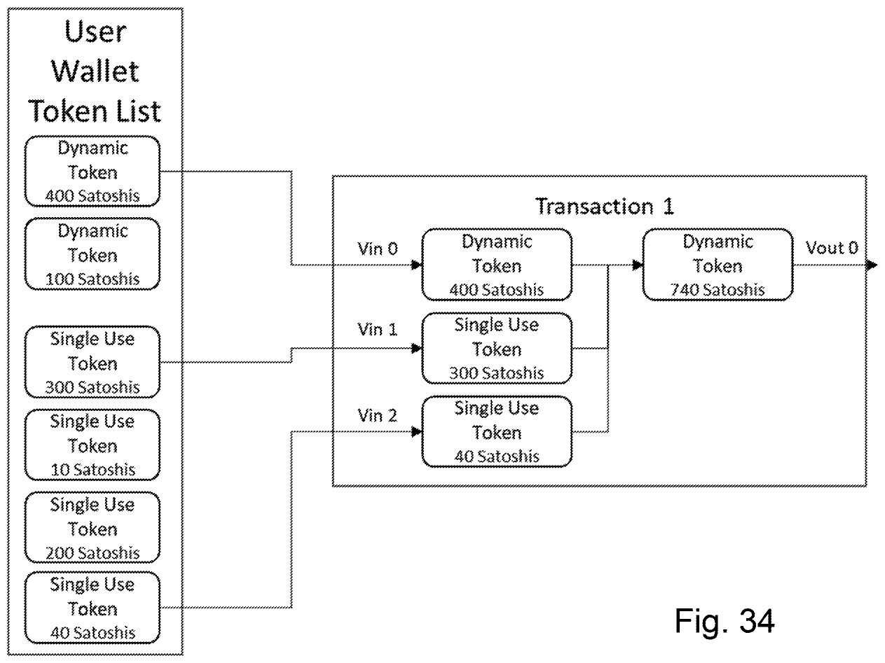

FIG. 34 illustrates a transaction in which a user selects two, from four, single-use sub-tokens from their wallet and spends the single-use sub-tokens in to one of two dynamic tokens in their wallet—this spend occurring in a transaction with their own dynamic token to increase the value of the satoshis held in that dynamic token. In this example Vin0 has an initial value of 400 satoshis, two single-use sub-tokens having values of 300 satoshis (Vin1) and 40 satoshis (Vin2) are added to the dynamic token such that Vout0 value of the dynamic token is 740 satoshis. A user having two or more dynamic tokens in their wallet can choose which dynamic token to use when signing a transaction. Not only can a user select which dynamic token to use to transfer funds they can select which dynamic token receives funds during a transaction.

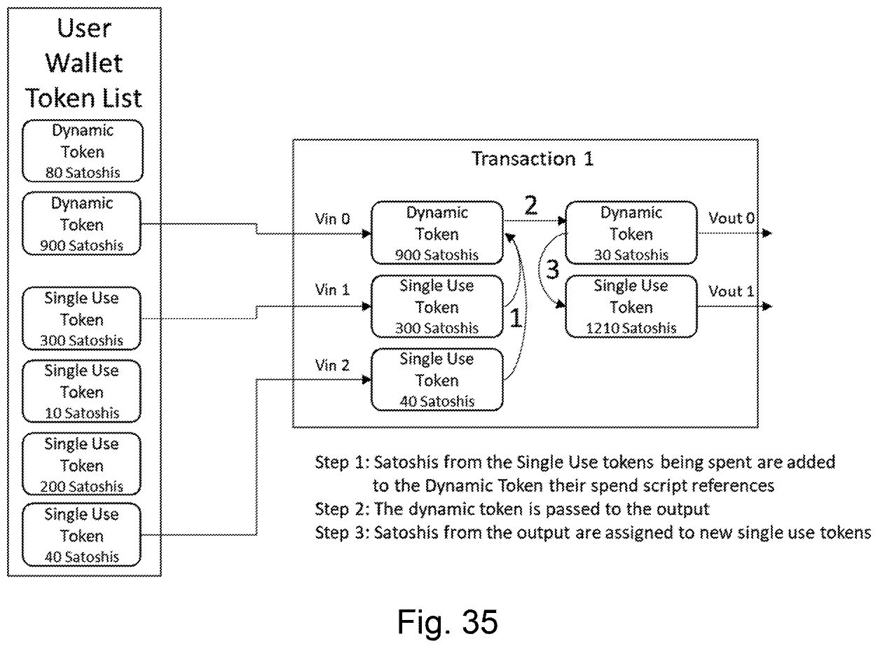

FIG. 35 illustrates a transaction in which a user selects two, from four, single-use sub-tokens from their wallet and spends the single-use sub-tokens in to one of two dynamic tokens in their wallet. In contrast to FIGS. 33 and 34, the spend occurring in the transaction with their own dynamic token does not increase the value of the satoshis held in that dynamic token. In this example Vin0 has an initial value of 900 satoshis, derived from a dynamic token, and two single-use sub-tokens having values of 300 satoshis (Vin1) and 40 satoshis (Vin2). A total of 1240 satoshis are input to the transaction, and these are output in the original dynamic token on Vout0 (30 satoshis) and Vout1 (1210 satoshis) in the form of a newly created single-use sub-token. The value of the new single-use sub-token on Vout1 can be created with a bespoke quantity of base token units correlating directly to those of the dynamic tokens, and having an integer value for a specific purpose, such as a purchase.

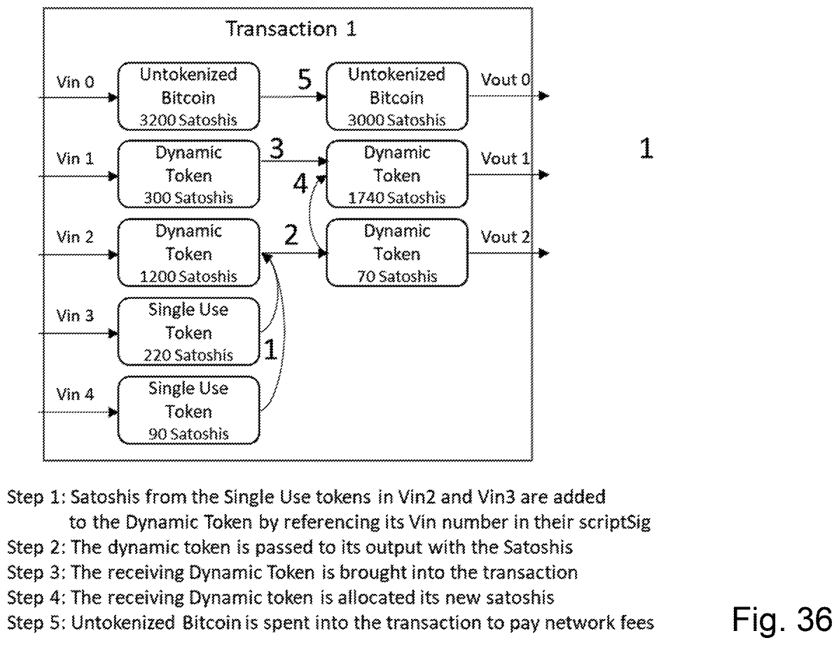

FIG. 36 illustrates that single-use sub-tokens can be associated with a dynamic token at Vin2 (1200 satoshis) and recognized as such within a transaction. In the transaction, two single-use sub-tokens at Vin3 (220 satoshis) and Vin4 (90 satoshis) are added to value input to the transaction by the dynamic token at Vin2. The purpose of this transaction is to spend value from a dynamic token at Vin2 into a receiving dynamic token, which has an input at Vin1 (300 satoshis). The receiving dynamic token is then allocated satoshis (1440 satoshis) that are added to the receiving dynamic token's existing satoshis at Vout1 (1720 satoshis). The balance in satoshis is returned as change to the spending dynamic token, which is paid out at Vout2 (70 satoshis). 200 satoshis of untokenized bitcoin are spent between Vin0 and Vout0 to cover transaction costs.

By way of example, the single-use tokens in FIG. 36 can be spent into scripts use a prescribed format outlined in the minting action to list which outputs are single-use sub-tokens, and from which dynamic token input the Satoshis originated.

In one example, this can be in the format:
<2> 2DROP <pubkey> CHECKSIG

The <2> is there to indicate that the parent dynamic token for this single-use token is input no. 2 in this same transaction. This is the same as the function of minting a new output except that the child token inherits 100% of its base token details from the parent.

The 2DROP opcode is there to drop the number 2 and an additional data item which is fed in by the scriptSig. Which is:
<signature> <4>

The 2DROP drops the 2 and the 4 leaving the <pubkey> and <signature> for the CHECKSIG to evaluate.

Examples that use this linking protocol with any possible permutation of scriptPubKey and scriptSig are possible. For example, a Pay to Public Key Hash can be modified to include this linking protocol by adding
<3> 2DROP

to the front of the template giving:
<3> 2DROP DUP HASH160<publicKeyHash> EQUALVERIFY CHECKSIG

Which indicates that the single-use token received its dynamic Satoshis from the dynamic token in input 3. When spent, the required scriptSig is:
<signature> <pubkey> <5>

Which indicates that the dynamic token in input 5 has picked up the tokens.

These scripts are provided by way of example, and are included in the output script of a token transaction. Instructions can be placed in the script in advance of the verification of the public key that releases the token i.e. spends the UTXO, such that a conditional transfer is imposed by the script. Upon receiving and/or reviewing the script a wallet, or device configured to process a token transaction can at least one of perform the necessary operations to comply with the requirements/instructions determined by the script, signing the UTXO and write the script on the transaction output.

Second-Order Sub-Token

Single-use sub-tokens can be issued without any additional information or limitations.

In order to implement conditions, restrictions, limitations or relationships with other tokens additional script can be added at a secondary level to a sub-token. Therefore, in another example, a sub-token can be created from a dynamic token and function as a ‘second-order’ sub-token (soT). A single-use sub-token can be described as a ‘first-order’ token if it has no additional script that provides additional functions. In other words the asset, or portion of the asset, controlled by a single-use sub-token of the first order is the same as the parent dynamic token.

A second-order sub-token can be issued within the rules of a single-use token i.e. it can be used once only—however, this second-order sub-token is analogous to the single-use sub-token, but has additional functionality that enables the implementation of conditions, restrictions, limitations or relationships with other tokens. The rules applied by an issuer's protocol to a single-use sub-token are similarly retained when a second-order sub-token is created. In other words, the protocol that governs the scope of use of a single-use sub-token are carried over, or inherited by, a second-order sub-token.

A second-order sub-token effectively wraps satoshis, which validly represent a quantity of units of a base token, in a secondary token function. In other words, the second-order sub-token places a limit or control on the use of the satoshis held in said token. By way of comparison, (i) a single-use sub-token contains satoshis that are a function of the token value, and these satoshis can be spent as described herein, while (ii) a second-order sub-token also contains satoshis that are a function of the token value, and these satoshis can be spent as described herein—however, further properties or conditions applied to the second-order token enable additional value e.g. access to a resource, to be unlocked when the holder of the token uses the second-order token according to predetermined conditions. Conditions for accessing additional value, or a further resource, can include, for example, spending a set number of second-order tokens at a particular store. The status of a dynamic token can determine its function and/or level of authority in relation to creating sub-tokens. In one example, a second-order sub-token can be created with functionality and use any quantity of the underlying token denomination. For example, second-order functionality can be applied to a single-use sub-token to create a second-order sub-token from a dynamic token. The second-order sub-token can be consumed by a dynamic token when used in a transaction, or at least use a portion of the quantity of the underlying token denomination can be consumed. The second-order functionality confers special rights to the holder of a second-order sub-token, allowing use for things such as discount coupons held as small value dynamic tokens in the base token layer which represent a static, or fixed value, second-order sub-token, or in the case of zero-satoshi second-order sub-token, holding its value as a static token with no underlying bitcoin value. To use the second-order static sub-token it can simply be spent by a dynamic token which re-incorporates its Satoshis, or in the case of a zero satoshi sub-token, spends the token without re-spending it out to a new script, or spending it to a FALSE script or a FALSE RETURN script.

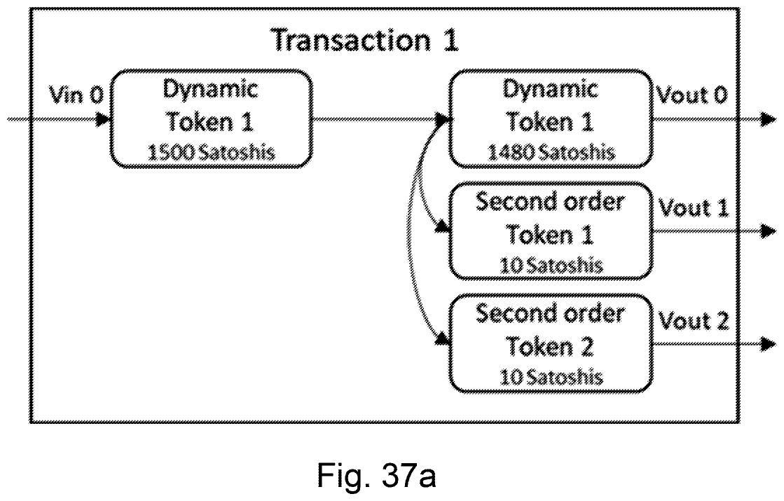

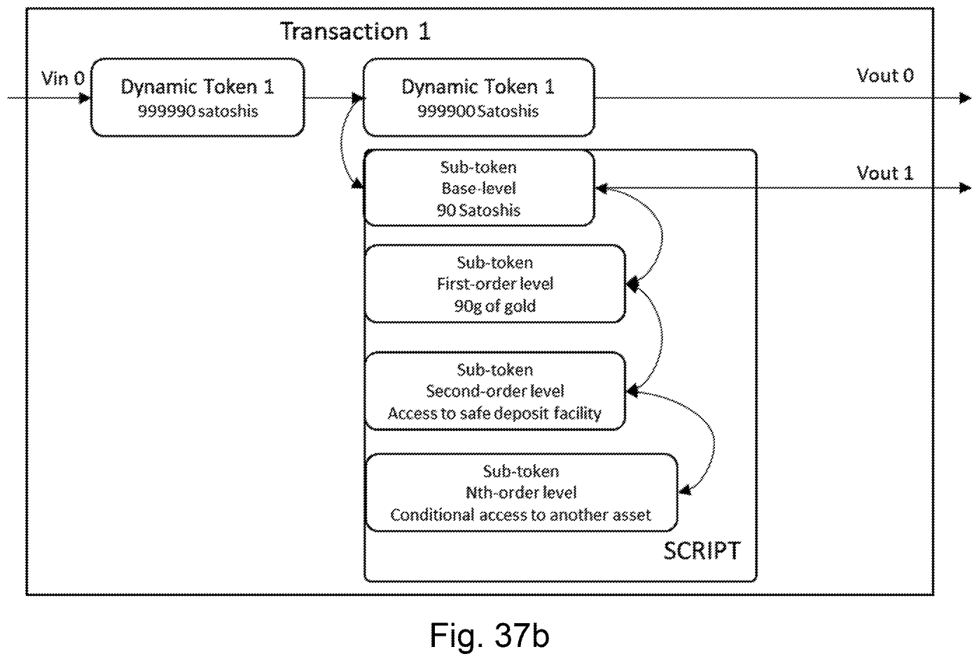

By way of example, FIG. 37a illustrates a transaction in which a dynamic token is used to create two second-order sub-tokens. The dynamic token begins with a value of 1500 satoshis at Vin0, returns 1480 satoshis in change to itself at Vout0, and creates two new outputs Vout1 and Vout2, each having a value of 10 satoshis and an association with the dynamic token that created them. The second-order sub-tokens appear like single-use tokens to the base token protocol and must be spent accordingly to prevent tokens in the first order token system from being invalidated. However, these second-order sub-tokens are created with additional data in their script, which can provide an added value.

By way of example, a single-use sub-token or a second-order sub-token can be used under the primary issuer's system or a third party's system and be recognized as having equal value in the primary token layer. For example, if these sub-tokens are spent outside of the primary issuer's system, they would revert back to their raw tokenized value, and be recognized only as the single-use sub-tokens, as issued. It is beneficial, therefore, that second-order sub-tokens are used within the system in which they were issued because it is only within that environment or system that the additional information in the script can provide secondary value or functionality.

For example, a single-use sub-token can be configured to provide unconditional access to an asset for a 24-hour period e.g. free access to Netflix for a trial period of 1 day. The issuer or authority responsible for the tokens e.g. Netflix, or their representative managing the tokens, decides that the standard single-use sub-token can be used to enable additional asset access if, for example, a predetermined condition is met, wherein said additional asset access is implemented as a second-order sub-token e.g. Netflix offers free access to their platform for a trial period of 7 days on the condition that adverts are permitted to be embedded within the viewable media. If the condition is not met, then the token reverts to its base function i.e. a single-use sub-token. Continuing with the Netflix example, if a user accepts the second-order sub-token, but fails to comply with the condition by deactivating the adverts, then the second-order sub-token reverts to single-use sub-token with different access rights. Second-order functionality can be applied or implemented to apply conditional use of any token, including sub-tokens. A single-use sub-token is a limited use portion of a dynamic token.

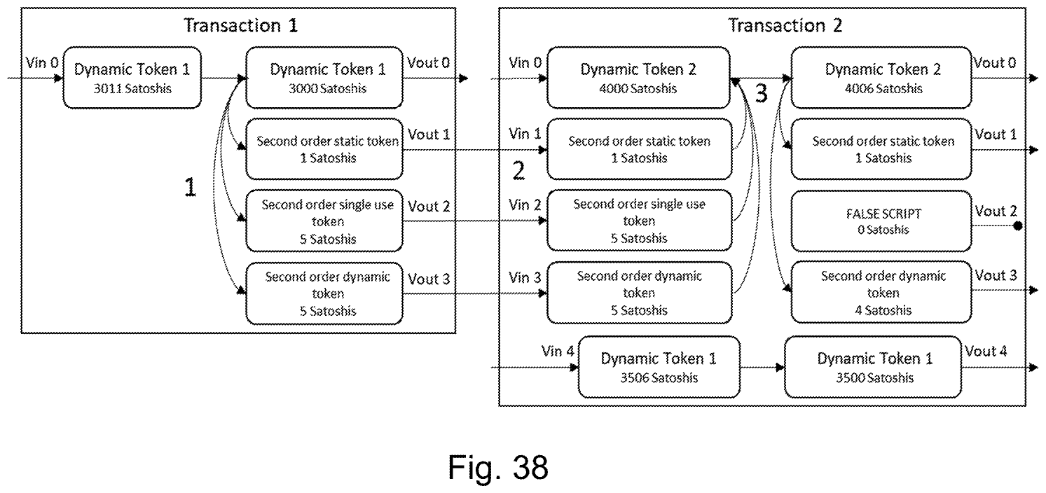

FIG. 38 illustrates two transactions involving a first and second dynamic token, wherein three examples of second-order sub-tokens are ‘micro-minted’ from the first dynamic token. Each sub-token can be issued as a physical sub-token. Alternatively, the sub-tokens can be held in the purchaser's digital wallet prior to being spent in to the second transaction. The sub-tokens can be retained as a ‘group’. In each case, the token can use a code, such as a QR code, to redeem a voucher.

In more detail, in the first transaction Vin0 (3011 satoshis) from a first dynamic token is used to create said three sub-tokens—namely (i) a second-order static sub-token, having a value of 1 satoshi, (ii) a second-order single-use sub-token having a value of 5 satoshis, and (iii) a second-order dynamic sub-token having a value of 5 satoshis—which are outputs are Vout1, Vout2 and Vout3, respectively. The remaining satoshis are issued as change to the first dynamic token at Vout0 (3000 satoshis). To provide a contextual example, the first dynamic token in transaction 1 is managed by a leisure center having a swimming pool that has digitally secure conditional access e.g., for safety purposes. It is to be noted that all the tokens and sub-tokens in this application can function to provide and/or represent a secure means to access or obtain a resource. The second dynamic can be managed by the same leisure centre, or by a leisure centre within the same group e.g., David Lloyd® leisure centers in the United Kingdom.

As part of a package offer, for a fixed price, the leisure center uses the dynamic tokens to generate, respectively, sub-tokens for offers, which by way of example are (i) fixed access for one swim session, said session being transferrable but restricted to a swim in the issuing leisure centre or another leisure centre that uses the same type of dynamic token, as per Vout1, (ii) a credit for a vending machine selling swimming equipment, said credit being restricted for a single sale in said leisure center, as per Vout2, and (iii) access to five separate swim sessions, that can be redeemed one at a time until there are none left, as per Vout3.

Each of the sub-tokens can be managed individually, or as a group. For simplification purposes they are shown in FIG. 38 as being managed as a group, wherein each of the second-order sub-tokens are spent in to a second transaction at Vin1, Vin2 and Vin3. A second dynamic token, managed by the leisure centre, inputs 4000 satoshis at Vin0, and the base token units from Vin1, Vin2 and Vin3 are taken into the second dynamic token.

The holder of the sub-tokens does not redeem the fixed access for one swim session, thus the same satoshi at Vin1 is spent into a new second-order static sub-token to output an equivalent at Vout1, which is made possible in the token base layer because the second-order sub-token protocol recognises this as the same second-order dynamic token. This is analogous to the customer retaining the fixed access for one swim session until a later date. If held digitally, this sub-token would be linked to the customers own dynamic token.

The second-order single-use sub-token input at Vin2 is consumed in the second transaction, wherein the output is consumed with a FALSE script to terminate said token correctly. The satoshis from said token are absorbed by the second dynamic token. Vout2 terminates. This is analogous to the customer using the sub-token to obtain an item from a vending machine in the center, wherein the ‘payment’ to the vending machine is spent into the dynamic token belonging to the center.

The second-order dynamic sub-token at Vin3 is, firstly, absorbed by the second dynamic token. Thereafter, only 1 satoshi is spent in to the second dynamic token, while the remaining 4 satoshis are output in a further iteration of the second-order dynamic sub-token. Said further iteration is not new, or re-minted, using the base token protocol this sub-token is assigned a new status and/or location, wherein it is assigned a new UTXO at Vout3. This is made possible because said second-order dynamic sub-token functionality enables a changeable value, which recognises that this sub-token provides permission for it to be continued while it has value. When the value reaches zero the token will cease to exist. This is analogous to the customer using the token to obtain access to one (from a total of five) swim sessions, spending 1 satoshi in to the second dynamic token, and the remaining four swim sessions remaining in the second-order dynamic sub-token.

As described, and shown in FIG. 38, 6 satoshis are spent from the second-order sub-tokens in to the second dynamic token having 4000 satoshis at Vin0 and 4006 satoshis at Vout0. Each of the second-order tokens must be incorporated in to a dynamic token before re-assignment and processing in to another format. In other words, the figure shows that when a dynamic token is input, it gathers the single use tokens it is consuming and then re-defines them as new single use tokens in the outputs. The arrows show that the dynamic token input controls all of the second order tokens. Second order tokens are derived from dynamic tokens and, therefore, a wallet must process and absorb these tokens before re-issuing them.

Transaction fees are handled by the first dynamic token that contributes 3506 satoshis at Vin4 and receives 3500 satoshis at Vout4. An amount of 6 satoshis is consumed by a miner between Vin4 and Vout4.

All of these actions are valid within the base token layer protocol but allow for a comprehensive set of second-order systems, or n^{th} order systems, to be built on an already tokenized base layer.

In one example, a merchant who takes payment from purchasers in a currency which is issued into dynamic tokens can use the ‘single-use sub-token’ feature of the currency to issue a purchaser with a second-order sub-token representing a future discount. The merchant can implement this by using a dynamic token where each satoshi represents 1 base unit of a common currency used in the merchant's workplace. When a purchaser visits the merchant and pays, their wallet receives a small amount of tokenized currency (e.g., 10c) which has been tokenized to represent one loyalty token. The purchase can spend this loyalty token as 10c in any store. Alternatively, if the purchaser returns to the same merchant and redeems 10 second-order sub-tokens with said merchant, then the merchant will offer something of greater value than $1, such as a cup of coffee having a value of $4.

Second-order sub-tokens can enable unique properties to be applied to any pre-issued token without the base token protocol being affected. These sub-tokens can be applied without issuer permission and without needing to create a separate sub-ledger. In one example, a student can obtain a second-order sub-token for passing an on-line test. After passing a set number of on-line tests required to progress to the next level of on-line tuition then the second-order sub-tokens accumulated can be used together to access to said tuition. In another example, a medical device connected to a healthcare system having a dynamic token can monitor the health of a patient e.g., measure blood pressure. With each measurement, a second-order sub-token can be generated from the dynamic token and be provided to the patient, said sub-token having secondary information associated with the patient, results and time of the test. As required, the patient can use the second-order sub-tokens to create a prescription for blood pressure control medication, wherein the second-order sub-tokens utilise the time, measurement, and frequency of the measurements to determine either (i) the medication to be prescribed or (ii) automatically arrange an appointment with a doctor. In another example, a motor vehicle test certificate that must be obtained for a vehicle each year is issued together with a second-order sub-token, issued from a dynamic token held by the garage performing the test. The second-order sub-token is proof that the vehicle passed the test, which is required to enable the vehicle owner to obtain insurance for the vehicle. However, if a vehicle owner obtains a set of three second-order sub-tokens from the same garage, then the tokens can be combined and exchanged for a complimentary service. In a further example, education colleges or testing facilities can hold dynamic tokens that issue second-order sub-tokens to students or equipment that pass tests, examinations or modules that represent that they are technically safe to practice or operate. Having ten second-order tokens, obtained from a mixture of colleges or testing facilities provides access/permission to operate in technical or safety critical operations. If, however, all testing or examination was carried out at the same facility, then only seven second-order sub-tokens can be required to gain equivalent access/permission.

In each of the token examples herein, the process of establishing tokens begins with at least one of: an inaugural transaction, establishing the authority behind the token, typically in a root node; a token definition transaction, that defines the tokens to be created; and a token issuance transaction, wherein a token is transferred to a user.

In a further example, an entity creates tokens providing access to gold, and in this example 1000 kg of gold is initially held by a single dynamic token. The process begins by establishing a root node including the digital identity of the entity who will issue, and/or the signature of the authority approving the tokens and the distribution of tokens, which can include, for example, the digital signatures of a bank holding the gold in their vault and a governmental authority approving the tokenization of the gold, such as the Financial Services Authority (FSA) in the United Kingdom. In this example the bank holding the gold and issuing tokens has high street branches offering traditional banking services, such as safety deposit boxes.

Following the establishment of the root node in an inaugural transaction, a further transaction defines the dynamic token and/or issues the token for use by the bank. Alternatively, the definition of the token and the issue of the dynamic token can occur in separate transactions—each, however, are related and form part of the writechain i.e. the linear transaction history with the root node.

The dynamic token is defined as having access to the 1000 kg of gold, which is proportional to an amount of underlying cryptocurrency. For example, the dynamic token can access 1000 kg of gold in denominations of 1 g such that the 1000 kg of gold is represented by 1000000 satoshis, and the dynamic token is secured by the UTXO of the underlying cryptocurrency.

The first-order value of the dynamic token is 1000000 statoshis determining access to 1000 kg of gold, and sub-tokens can be derived therefrom. Each sub-token also has a first-order value in that its value is access to a fungible amount of gold in multiples of 1 g units. The bank holding the gold and responsible for the tokens agrees to provide second-order functionality in the form of access to a safe-deposit box within the bank's premises on the condition that access to at least 50 g of gold is held simultaneously in a sub-token or collection of sub-tokens.

When a first user purchases access to 10 g of gold the bank uses its dynamic token to create a transaction: the input to the transaction is 1000000 satoshis, signed by the bank; one output from the transaction creates a sub-token having access to 10 g of gold and 10 satoshis, which can be accessed by a user's signature; and another output returns 999990 satoshis to the dynamic token held by the bank.

When a second user purchases access to 90 g of gold the bank, once again, uses its dynamic token to create a transaction. This example is illustrated in FIG. 37b, which shows that script defining the output of a token transaction can secure access to different assets, as described below. Each of the levels in the figure are shown dependent upon the level/order below, although the conditional access to an asset can be based upon different dependencies e.g., multiple conditions, and the example below suggests one non-limiting example of how a sub-token can have different levels of access.

The input to the transaction is 999990 satoshis, signed by the bank. One output from the transaction creates a sub-token having access to 90 g of gold and 10 satoshis, which can be accessed by a user's signature. The bank additionally provides second-order functionality to said sub-token in the form of access to a safe-deposit box within the bank's premises. The second order functionality is achieved by creating a token transaction output that defines said sub-token having conditional access to the safety deposit box. The different levels of functionality are implemented in the script. At a base-level, the script of the sub-token controls access to 90 satoshis, while said script associated with the 90 satoshis is segregated in a base sub-section of the script, and metaphorically ‘wrapped’ within the script output. At a first-order level, the output script includes a first-order sub-section of the script that secures access to 90 g of gold, and this too is ‘wrapped’ within the script output by the second-order level of script that conditionally enables access to a safety deposit box. Another output returns 999900 satoshis to the dynamic token held by the bank.

The user holding said sub-token securing access to 90 g can present their sub-token at said bank and, in a conventional manner, transfer access to at least 1 g of gold in a conventional token transaction, as described throughout the application. Additionally, or alternatively, a user can present their token to a security system controlling access to a secure room and safety deposit box, wherein the security system reads the output script of the token and reads the second-order level of script and the user to prove that they have the signature to unlock the second-order script, and upon confirmation permit access.

If a user were to transfer access to 80 g of gold back to the bank, then the output of that token transfer transaction would remove the second-order level of script, such that they could no longer access their safety deposit box. The bank can oblige the user to empty said box prior to the transaction. The functionality implemented by a second-order level of script can be limited to the use of resources controlled by the entity managing the dynamic token. The functionality implemented by a second-order level of script can be time-limited and/or single-use.

The second-order functionality can be implemented by the script of the sub-tokens created from a dynamic token. The script from transaction outputs imposes conditions such that the additional functionality is revoked if said conditions are not complied with.

In context, each token has a base value in the cryptocurrency it holds, which is secure by the corresponding UTXO, while a ‘first’ order token secures an asset, as represented by the non-limiting examples of tokens taught herein i.e. the static, dynamic, tokens used in establishing a transactional database or tokens used in a control system. Second-order functionality can be applied to any first-order token to provide additional and/or conditional access to another asset or resource. When second-order functionality is withdrawn, or expires, the token reverts to its first-order condition. When first-order functionality is withdrawn, or expires, the token reverts to its base value.

Any number of functions can be added to a token, such that a n^{th} order token can be provided with additional functionality and/or asset access in the output script of an nth order token transaction that creates a (n+1)^{th} order token. When (n+1)^{th} order functionality is withdrawn, or expires, the token reverts to its n^{th} order condition. The functionality can be implemented in layers of script, wherein the base-level controls access to the UTXO of the underlying cryptocurrency while the first-order level of script controls access to an asset. Further layers of script provide conditional access to further functions. The layers can be nested, and one or more functions conditional on holding assets.

A token having multiple levels of script, and therefore multiple functions, can be used to access any of the respective functions enabled by the script of the token, although this is conditional upon each of the higher order functions being accessible. In other words, an n^{th}-order function is dependent upon the function of the (n−1)^{th}-order script being valid and accessible. Using the ‘gold’ example of FIG. 37b, access to the safety deposit box depends on both the access to the 90 g of gold and the 90 satoshis. If access to the 90 g of gold is lost e.g. private key temporarily lost, then then access to the dependent sub-token functionality of the safety deposit box is also lost.

Each of the token levels and/or functions are implemented in the script on the output of a token transaction. As described elsewhere herein, in relation to a database management system (DBMS), script can be retrieved from token transaction outputs and used to compile a record, such as a database. A DBMS can be configured to retrieve token transactions from the or each sub-token nth order level, as indicated by example using a single sib-token ledger and separate DBMS as shown in FIG. 9b.

The additional functionality can be applied to any token and a controllable asset and is not limited to access to gold and/or a safety deposit box.

Privacy+Tokens

As described above in relation to FIG. 29, a sender (Alice) and/or receiver (Bob) can validate a token on the ledger by scanning the ledger history, using a token validation service and/or determining the validity from a full transaction history shared in preparation of a transfer.
This validation checks that Alice's dynamic token is valid and uses the same linear scanning technique used when validating a static token.

However, Bob is not receiving Alice's dynamic token. Instead, the respective dynamic tokens are held by Alice and Bob and it is the token units that are transferred. In a transaction, Alice spends the change (the original amount minus the amount she is spending to Bob's token) back to herself and Bob, similarly spends token units from the transaction into their own dynamic token i.e., back to themselves (Bob receives his original amount plus the amount received from Alice). The particulars of the dynamic tokens (e.g., serial number) are not necessarily required for the users to participate in the transaction.

During the transaction, Alice and Bob will have visibility of the original amount of token units held by the other's dynamic token prior to the transaction occurring.

To mitigate a security risk, a dynamic token can be spent into and out of different Vin/Vout positions i.e., into and out of different tokens in a transaction managed by Alice's wallet, as long as the Vin of the Vout being used was also occupied by a dynamic token of the same type. If Alice had a large amount of token units e.g., 10,000,000 satoshi in her token, then this could pose a security risk to Alice. The security risk is such that it could expose her level of wealth e.g. if her transaction history revealed she held a dynamic token of significant value. By swapping the inputs and outputs Bob is unable to determine who controlled assets in an earlier transaction, thus cannot determine Alice's level of wealth i.e. which assets Alice can control.

FIG. 39 illustrates an example in which three tokens of identical type have been created in a minting transaction. The three tokens are all transacted in subsequent transactions with each token being referenced from a particular Vin and being spent to a different Vout, where each Vin-Vout pair still carries a direct linear historical link back to a minting transaction of the correct token type. This technique of inter-transactional payment can enhance user privacy during a transaction by removing the linear chain of history that ties a user to their token and/or the value within that token. It can provide a way for users to have the same certainty of validation that comes with static tokens. In this way, large pools of dynamic token outputs can be mixed to keep user privacy when conducting transactions. Using this technique requires a minimum of two dynamic tokens to be spent into a transaction, and there must always be the same number of dynamic token outputs as there are inputs, and the technique forces correct application.

In order to manage dynamic tokens, an issuer can implement limitations and/or controls upon their use. This is done by issuing rules on the use of the token in the minting action. These instructions describe how the dynamic tokens can be used, and can be used to define whether it can be used to create sub-tokens, whether it is fungible with some other type of token (e.g., some particular static tokens associated or otherwise via Minting or Issuance transactions) or more. User wallets must know how to interpret and follow the rules correctly. If you do not follow the rules on use, your coins may be invalidated. Coins can be repaired but this requires the direct involvement of the issuer. To repair them, the user who invalidated them must be able to pass the satoshis they contained back to the issuer, or the issuer must get untokenized bitcoin, re-create the tokens and give them back to the user in a re-minting or refresh transaction.

For example, if a dynamic token is used incorrectly, either through an imbalance in the number of satoshis output or by spending it to an output that does not have a dynamic token at its matching input index, the token is rendered invalid. Where an issuer has control over the token, it can be spent into a new minting action that destroys the old tokens and repairs the issue. However, where tokens are not controllable by the issuer they must be blacklisted. When other users of tokens from within the same ledger request the status of a blacklisted token, they must receive a response that it is invalid.

In order for two users to perform an exchange using dynamic tokens, there is additional information which the first user requires over and above a regular output script as per a regular Bitcoin transaction. That is, in order to perform a transaction where two dynamic tokens are used and in which they directly exchange value, the parties must each know the other party's dynamic token balance and UTXO so that they can sign the transaction. This is especially important if the dynamic token output order is being obfuscated such as in FIG. 39.

The process of two dynamic tokens being spent together is explained in FIG. 29.

False Scripts

To facilitate the automated ordering of inputs and outputs, a user's wallet can be configured to generate FALSE outputs corresponding to the inputs from single-use tokens or single-use second-order tokens. The FALSE outputs simplify the transaction and the record held on the ledger because they create a situation in which the input/output pairs are matched, thus the history of each token is clearly identifiable. This is especially useful when multiple participants are each submitting multiple items to the transaction which need to be input/output pair matched to maintain the token protocol.

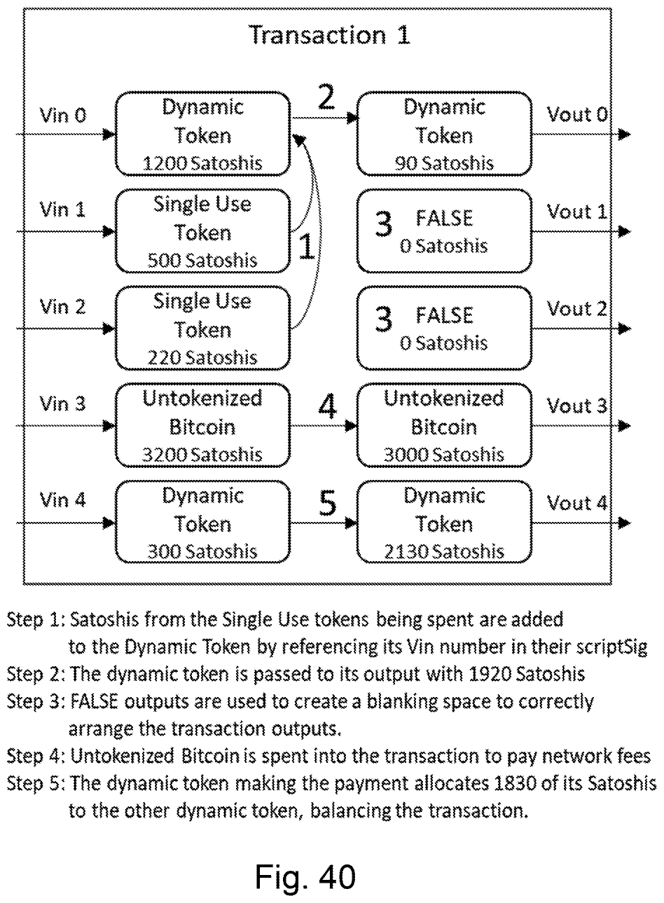

By way of example, FIG. 40 illustrates a transaction between Alice, who controls the dynamic token at Vin0 (1200 satoshis), and Bob, who controls the dynamic token at Vin4 (300 satoshis). Alice additionally inputs two static tokens at Vin1 (500 satoshis) and Vin2 (220 satoshis), that are first attributed to her dynamic token taking the sum of Vin0, Vin1 and Vin2 to 1920 satoshis. Alice spends 1830 satoshis to Bob's dynamic token and the transaction gives Alice 90 satoshis change at Vout0. It is to be noted that Vout1 and Vout 2 are false outputs having zero satoshis in value. Bob acquires control of the 1830 satoshis such that the output Vout4 gives him control of a total of 2130 satoshis. Vin3 and Vout3 are used to pay a 200 satoshi network fee.

Splitting Single-Use Tokens

In one example, an issuer can authorise the holder of a single-use sub-token to split said single-use sub-token into more single-use sub-tokens for the purpose of making payments without needing to use a dynamic token. The issuer can further specify a depth to which a single-use sub-token can be split away from a single chain of history back to a valid issuance.

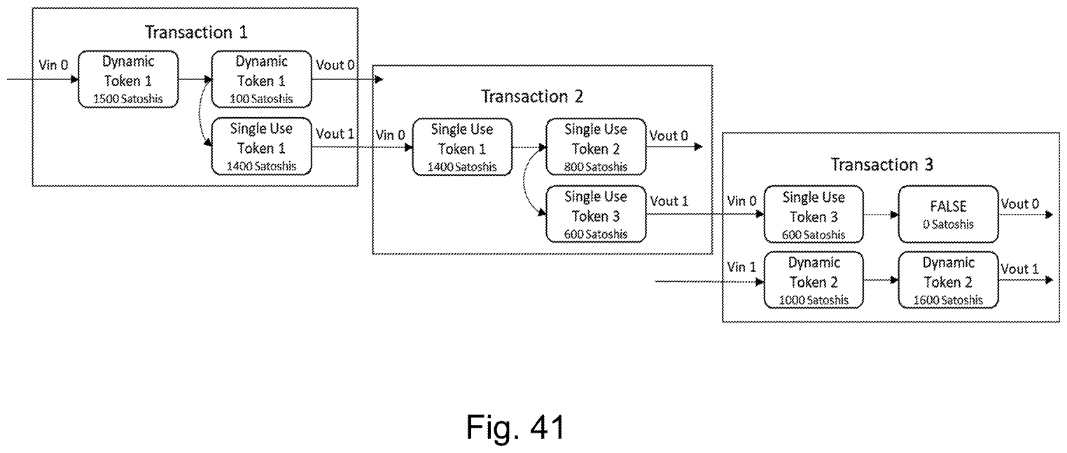

FIG. 41 illustrates a chain of three transaction through which a single-use sub-token is created, then split before being spent back into another dynamic token.
In the first transaction a dynamic token (dT1) attributes 1500 satoshis at Vin0, and spends 100 satoshis back to itself at Vout0, while creating a single-use sub-token (suT1) of 1400 satoshis that is output at Vout1.
In the second transaction, the single-use sub-token (suT1) at Vin0 is split, to create two single-use sub-token outputs—namely a single-use sub-token (suT2) of 800 satoshis at Vout0, and a single-use sub-token (suT3) of 600 satoshis at Vout1.
In the third transaction, the single-use sub-token (suT3) of 600 satoshis is spent at Vin0, and received by another dynamic token (dT2) having an initial value of 1000 satoshis and an output value at Vout1 of 1600 satoshis. To balance the transaction, a false output of zero satoshis is output at Vout0.

The system of static and dynamic tokens, and the depth to which a dynamic token can be split into sub-tokens can be unlimited. Dynamic tokens can be created, or split, to have a denomination that matches an individual token unit value held by a dynamic token. In other words, use of dynamic tokens does not preclude an issuer from creating static tokens all the way down to the smallest denomination. In practice, the extent to which a tokens, whether static or dynamic, can be divided can be selected to ensure efficient use of Bitcoin.

False Outputs+Tokens

In some examples, tokens and sub-tokens can be spent into a FALSE output which is an output containing simply the opcode ‘OP_FALSE’. These outputs effectively cause the tokens at the corresponding input to cease to exist.

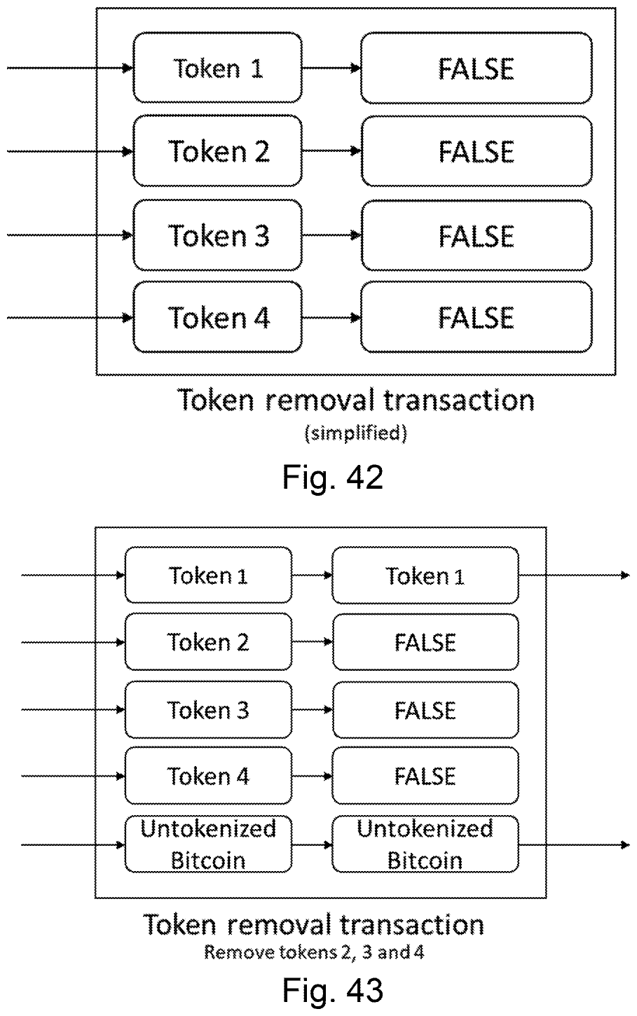

In cases where it is necessary for the transaction to control the output index of certain token outputs the ‘OP_FALSE’ output is the most efficient way of creating a null or unspendable output. They are also the most efficient possible way of ‘stubbing off’ a token that has a linear timeseries progression defining its history. This might be used in a Token Removal transaction as shown in FIGS. 42 and 43.

In some examples these false outputs may also be used in scripts that transfer the tokens to a new output to perform a token update. Updates may be performed to clear token history or in order to re-issue tokens with new properties.

This opcode gives anyone a way to generate low weight outputs which can help to terminate large numbers of tokens. This can be done to terminate incoming tokens in a token re-issuance transaction or simply as a way to allow wallets to specifically create particular tokens from the circulating set. This false output can be used to end the lifetime of a token of any variety (e.g., static/dynamic etc.) but is not required. If the token is spent into an unspendable output then it is effectively destroyed, so this mimics the behavior of spending a token input into a transaction without any corresponding output.

One example of single-use tokens would enforce a rule where the dynamic tokens using them would be forced to either make them or grab them up, but not at the same time.

Write Tokens, Transactional Database and Database Management System

The aforementioned tokens, such as the static, dynamic and sub-tokens, as well as the associated techniques, protocols and systems for creating, using, processing, and transferring tokenised assets or resources via a blockchain (ledger) are configurable for alternative uses and applications. Like previous examples that supported the controlled access to a resource, the inherent integrity of a blockchain ledger and the secure and traceable nature of said tokens is additionally or alternatively suited to the management or monitoring of a resource. The authority a token enables, either itself or through its digital relationship with a parent token, an asset or dataset to be monitored. Tokens and their transactions can be used to build a transactional database (TXDB). A transactional database can collect transaction outputs representing any information, data or status of an asset, which can include the static values, dynamic values and the authority to write data to establish a transactional record of data, such as information and/or instructions e.g. for a transactional database (including the sub-division of those assets). The status of an asset can be analogous the status of a machine. The machine can be a computational machine and/or a physical machine having real-world sensors and devices to manage a set of physical outcomes. For example, a monitored asset can be the operation of a finite-state machine.

Token related blockchain transactions include a token output (UTXO), said output representing a respective token (T, sT, dT) issued by a Token Issuer (TI), or derived therefrom. The output also specifies a quantity of token units (TU) and token-related cryptocurrency (TRC) associated with the respective token (T, sT, dT). A token unit (TU) in one token can be transferred in a transaction to another token, or a token unit can be transferred in a transaction back to itself. Either way, the linear chain of history ties the transactions and/or tokens together.

Tokens created from a minting transaction MTx, or derived therefrom, can be configured to represent different token types having a “value” or units/quantity of resource associated with it. As described above, the value can be at least one of:
A ‘status’ indicator, wherein the quantity of units (“token value” or “token units (TU)) of the tokenised asset/resource is represented by the token. This can be any type of asset, entity, item or resource, including but not limited to: the representation of a legal right; an obligation such as a license to use some resource; component tracking and inventory; contract development and management; a virtual and/or digital asset such as a right to access a computer network or file, or cryptocurrency, or a digital ballot paper or selection in a voting system; and/or financially corporate-oriented assets such as fiat currency, commodities, stocks and shares etc. The transactional database can be a flexible, simple, and scalable database architecture, preferably using a cryptocurrency blockchain, such as the Bitcoin blockchain, e.g. the BSV blockchain.
A non-negative amount of cryptocurrency that has to be transferred as an essential mechanism of blockchain transactions.

While the ‘status’ of a token can be represented by a token unit and cryptocurrency, a token's status can be determined from the public key alone, said public key associated with the cryptocurrency held by the token. The lineage of the token can be derived from the public key such that its status can be determined. During the assembly and/or management of a transactional database the details of each token are known, thus the status of a token and its influence on the database content can be determined by minting certificate or issuance certificate of a token, which created said token and/or the database management system.

The tokens herein can be used to (i) determine a database entry and/or (ii) determine the formation of a database through one or more token transactions by a token on a ledger, such as a blockchain. The transaction creates a record that functions as a storage media holding an instruction for the generation, modification and/or verification of a blockchain-implemented database. The transaction can be used or processed during the determination of a database and/or the database content. Using the token transactions, which are based on a ledger, such as a cryptocurrency blockchain ledger, and the connections, or edges, between the transactions a database can be determined. The connections between the transactions enable the order of the creation of the database to be tracked. A database can be determined using a database management system that is configured to retrieve the transaction information and the connections between the transactions from a blockchain.

A transaction can include a database establishment record, which initially established or configured a database. Or if the transaction is a subsequent transaction in a series of linearly connected transactions then there is a connection to said database establishment transaction through the edges in a writechain. A series of linearly connected transactions defines the writechain.

Additionally or alternatively, a log of the minted tokens can be compiled during a minting transaction. This log is a record of what tokens were created along with the status and any other details, such as the format of the database being created or the database that it is to be associated with. Therefore, when the database management system builds the transactional database it used the log to associate tokens with content.

A database can be encrypted e.g. by using the keypairs that create each transaction. The key pairs can used elliptic-curve cryptography (ECC) keys. The creation of the tokens can use key generation and management techniques to at least one of: enable the owner of a database to recover any key combination used in the database from a single master keypair; create a transactional database that contains a combination of encrypted and unencrypted writechains; encrypt individual nodes or parameters within transactions;
control the access rights of tokens such that the holder of a token can be selectively able to view and/or control a writechain created by another token, including encrypted data from another writechain, without being given access to the private key used to encrypt that data; and enable threshold keys to be used in order to allow multiple users to encrypt and view data across multiple chains with discretionary provisions.

Controlling the access rights of tokens can be achieved through the use of software agents, such as the database management system, which can hold the full, unencrypted database in memory. The DBMS can serve the native data out to the users, and can also govern to whom it shows what data based on the access tokens that those users provide. In this way the DBMS functions as a gatekeeper or governor that controls the full database and controls access to all or part of the database.

The requirement for a threshold key is established during a transaction. By way of example, a farm owner can manage a token that enables them to record multiple parameters of each cow in his herd. Their ownership of the token is recognisable by the DBMS such that the farm owner can access recorded details of their own herd. However, during the transaction conditional access can be configured if particular conditions are met. The conditional access can require a third party to communicate with a network of connected computers to request a shared signature of a known message. If the third party can prove to the DBMS they control the key, by satisfying the conditions of a threshold signature, then they have access to that token's records. To continue with the example, the farm owner can provide conditional access to neighbouring farm owners who form a co-operative group. For example, the farm owner may be surrounded by five neighbouring farms, and access to said farm owner's data on the database can be conditional on three out of five neighbouring farmers validating the identity of a request to access the token's output on the database.

Each transaction has one or more token-related outputs (T-UTXO), each of which represents a respective token (T) issued by a Token Issuer (TI). Each transaction includes a) at least one of a database format, entity and parameter and/or information related to the modification of said database, and b) a quantity of token-related cryptocurrency (TRC) associated with the respective token (T). The first in a series of transactions in a writechain that creates a token can include the token-related output that comprises a mint record of the or each token created.

A token transaction created on a writechain can establish a set of parameters that can be referenced within the database. The parameters can be, for example, a table or any other database feature. The transaction ID can be the hash of the parent transaction from which it was derived. Any updates to the transaction can include that transaction hash as a reference back to minting transaction that created the token.

A transaction can include a header followed by a set of parameters. The parameters can include instructions that a database management system can recognise and use to modify a database. The instructions can be referenced, performed, followed or implemented. The instruction scan be said to determine the database content. For example, the set of parameters might include an instruction to create a new table, add a new node to a database, modify a parameter, or add or remove information.

When the set of parameters includes adding information, the format of the instructions can include at least a key:value pair. Parameters can include instructions that can be referenced, performed or otherwise followed to add modify a transactional database e.g. add a table or modify an entry. By way of example the key can be a string value e.g. ‘Name’, ‘Date of Birth’, ‘Photo’, and the value can be any type of data, or node:parameter/txid:vout data that creates an edge.

Each token has a level of authority or ‘status level’ that is associated with the entity controlling the token. The highest status level is attributed to the master or admin token from which all others are derived. New tokens are created by an entity, such that the parent token and the minting record hold a record of the status of the token that created a transaction. In other words, the transaction is a record of the token, and its inherent status, being applied.

During the compilation of the database the status level of a transaction can be determined by at least one of: the token value or token unit; an identifier; the minting record; and the public key, whose status can trace back to the entity in control of the minting transaction, which can be cross-checked with a register held by the database management system.

Overall the status of a transaction is determined by the parent token from which it was derived. It is to be noted that the parent token, through its own writechain, can issue instructions to modify the status of a transaction i.e. the parent token's transaction has a greater status and can change how a database management processes transactions from tokens derived from their parent token. The database management system determines the database by checking the status of transactions determined before and/or after minting of a token.

When established, the database record can include the name of the owner, title, type of database, such as graphical or relational, and details of the number of attributes.

Following the establishment, further tokens can be created from the original token. During this subsequent creation there is at least one of: a record of the creation of a new token; a connection to the original token from which it was derived; a new database established, which can be a part of the original database. A newly created token will have its own token-related output (T-UTXO) and associated public key.

Token outputs can define many aspects of the database, such as: information related to the modification of the table and/or database, the information comprising an instruction to at least one of amend by adding, deleting or modifying at least one of a row, column or record; and/or tokens having differing levels of authority, which can be indicated by at least one of the token value, additional information parameters and the public key, which can be allocated a status level that determines the outcome or impact that an output of a transaction on the writechain has upon the determined content of a database.

The first transaction that establishes the database can be referred to as a minting transaction, root transaction or a Genesis transaction, and a master token (mT) can be included in this transaction output. Additionally or alternatively, and the first transaction can output an administration token (aT) and/or a write token (wT). A subsequent edge connected node can also output an administration token (aT) and/or a write token (wT). The authority associated with a token can be determined from the identity of the token and its possession. Information about the token is recorded in the output that it is placed into, or in the hanging token mint record. This information will contain information about token type and function. The master token (mT) is configured having at least one of: the authority to create a write token (wT) having a quantity of token-related cryptocurrency (TRC) represented by one of the one or more token-related outputs (dT-UTXOs), said write token having write-only authorisation over the database content; the authority to create an administration token (aT) having a quantity of token-related cryptocurrency (TRC) represented by one of the one or more token-related outputs, said admin token having administration and write authorisation over the database; the authority to administer any database content created by itself or any tokens derived therefrom; the authority to write database content to any part of the database it has established, or that is subsequently established; the authority to add, modify or remove any token derived therefrom, such as changing the administration rights of said tokens; and the authority to modify or undo any action taken by a token derived therefrom upon the database.

Authority can be determined by at least one of recording the level of authority in the output or in the token mint record. Authority information can contain information about token type and function. The authority information can be recognised by the database management system such that tokens and their associated writechains can determine the modifications made by another token.

The master token (mT) can be created from the inaugural transaction. The inaugural transaction, or the transaction that creates the master token can also include the database establishment record. It follows that transactions made by each subsequently created token derived from the master token has a connection to its parent transaction. Through this connection the database establishment record can be determined from each token transaction, which provides a linear history leading back to the establishment transaction as proof of provenance. Additionally or alternatively, each token transaction can include the database establishment record within its identity or parameters. All subsequent transactions made by the master token have an edge connection from the parent transaction, thus creating a writechain of the master token.

An administration token, whether created in the minting transaction, or from a subsequent transaction, can function as a master token for all tokens and transactions derived therefrom. An administration token can be configured with the authority to create a further administration token. An administration token can be authorised to at least one of: administer and write database content that was created by said administration token or a write token derived from said administration token, thus enabling the administration token to modify the database, including, in relation to administration and/or write tokens, create a new token in an output, nullify a token and modify a token's authorisation; and create a write token (wT) from the administration token in a subsequent blockchain transaction, said write token having a quantity of token-related cryptocurrency (TRC) represented by one of the one or more token-related outputs (dT-UTXOs), and said write token having write-only authorisation over the database content.

Overall, an administration token provides an access right to the database, for example to create additional administration tokens with different access rights, or simply to make changes to the database itself. These tokens are used by the controllers of the database to manage the data flow into the database. To create an additional administration token or tokens, an administration token with appropriate rights is used in a transaction as a feed input and is spent into a script containing a ‘minting record’ which details the new administration token(s) being created. The transaction must also contain the appropriate signatures and data so that a database management system reading the information can know that any newly created administration tokens can validly make changes to the database. In a similar manner to static tokens, the administration tokens can retain their satoshi value so a separate input must be used to provide e.g. BSV satoshis for the payment of transaction fees.

While both the master token (mT) and administration token (aT) can create transaction outputs that determine database content, said content can be achieved through a write token transaction. When a write token is created, an administration token outputs a quantity of token-related cryptocurrency (TRC) represented by a token-related output. Write tokens can be configured with write-only authorisation over the database content.

The authorisation and level of control over an asset, and what happens to that asset, is generally determined when a token is created using an inaugural transaction and/or a token definition transaction. In relation to write tokens, wherein the asset is the output data for a transactional database, the authorisation is determined when an administration token creates the write token. The administration token can refer to a token definition transaction or create a new token definition transaction, said definitions including script that determined the scope of the write token.

As described above, authority can be determined by at least one of recording the level of authority in the output or in the token mint record. By way of example, the authority of a token can be limited to: a set number of write records, e.g. 10 write actions on the database before the database management system disregards any further transactions from that token; or modify a database on the condition that a threshold signature is valid. Different levels of authority and/or different limitations can be set on each token or token type.

Recognition of the authorisation of a transaction is determinable from the writechain and the token, such as a master token or an administration token, that created the token making the transaction. A token making a transaction will have been purposively received from the creator of the parent token from which it was derived, thus the controlling entity inherently possesses the authority. This purposive transfer can be determined from the key-pairs associated with the UTXO transfer of the token. A database management system can determine the authorisation through the relationships between the parent and child tokens.

Each of the tokens can have a changeable quantity of token-related cryptocurrency (TRC) represented by one of the one or more token-related outputs. This enables the token to be able to fund its transaction fees. In the case of the master token or an administration token the total token-related cryptocurrency (TRC) can be increased by spending UTXO to an input transaction of the token thus enabling it to create new tokens.

Any of the tokens described herein can be created with a limited function. A limited function can restrict the number of transactions it can make, or prescribe a specific lifecycle requiring information to be provided in a predetermined format in a chain of 1 or more token transactions. After the limit has been reached e.g. the set number of transaction exhausted, or the lifecycle has been complete, the token can be configured to expire and the outputs spent into a zero value or false return output. A token can be minted with a cryptocurrency balance e.g. satoshi balance, which is enough to pay the fees of all necessary state transitions, ending at a zero-value outcome, removing the need to make a fee payment through some other method.

Overall, a token transaction defines at least one of the format, an entity and/or information related to the modification of said database. Each transaction can hold any number of parameters. Parameters can include a ‘tag’ for identifying the entity and an item. Transactions can also be labelled and/or provided with a version level or number. Transaction labels can be used to attach metadata, such as index or constraint information, to specified transactions.

Database content can be defined by a set of key-value pairs in individual outputs. These outputs can contain data within a script, such as FALSE RETURN script e.g. an OP_RETURN script using the BSV protocol. The content of the key-value pairs can be data in a known format, or be linked back to another transaction or output.

By way of example, each parameter can be held in a separate FALSE RETURN script output. The FALSE RETURN script can contain various parameter outputs that provide instructions to the database management system e.g. the script can be structured as 2 pushdata operations, wherein the first is the name of the parameter (varchar) and the second is the data itself. The first part of the data push includes a 2 byte indicator of what type of data the parameter is, followed by the data itself. Parameters can be any type of data including, by way of example: numbers (int, uint, float, etc); character array (string, varchar, char etc, JSON formatted data, YAML, HTML etc); Boolean values (true/false); links (A:, B:, C:, D:. HTTP:, FTP: etc); files (images, documents, archives); timestamps; and ECDSA Signature.

The only restrictions on parameter and node size are the restrictions in place on the bitcoin network at the time the node was created. The parameter can also be a link to other on-chain data referenced using Bitcoin protocols such as B:// or C://. A parameter can also be a link to a sources (e.g. files, images) that are stored outside of the blockchain to minimise cost to the user however information stored off-chain is not immutable and may be lost over time, which depend on whether they remain available, which depends on factors outside the cryptocurrency network.

In a subsequent transaction from the minting transaction a subsequent blockchain transaction is derived from a previous transaction, wherein said subsequent blockchain transaction includes: a public key of the transaction, and a unique identification; an input, including a signed public key of the previous transaction, creating an edge connection with the previous transaction; an identification of the previous transaction; an output including an update to a parameter of the database and/or a database instruction.

An edge connection functions to determine a relationship between two node entities. An edge can only be formed at the time of the creation of a subsequent transaction, which refers to an earlier transaction during its creation. The determination of the database and its content uses the edge connections specified in each transaction to determine each action upon the database. Edges can link to other transactions or parameters in the same database or to information in other transactions or databases.

Various edges can be configured in a token transaction, as described above.

A static edge always returns the same information, while a dynamic edge receives the most recent update. Edges can also be a parameterised edge that references data outside the database, wherein the edge includes a specification for a wrapper, or an edge can be a query inclusive edge, wherein the returned data is the result of a plurality of queries. If the edge includes a wrapper or a blob, such as a package, then data can be retrieved inside a Tokenized message, a HTML table, JSON header and footer, or any other wrapper, giving users the ability to create nodes that serve wholly complete documents or web pages in native formats when linked or queried. In this way, the same source data can be made available in multiple formats for purposes such as creating EDI transactions or serving different streams of data. By simply adding a ‘query node’ with several edges back to the same node, each edge can have a different wrapper type. By way of example, an edge that retrieves a temperature in Fahrenheit can automatically convert it to degrees Celsius.

If the edge is query inclusive, then the queried edge returns data that is the result of another query. For example, if a database node is being constantly updated with new data (e.g. hourly temperature) the edge can be programmed to return the 24 most recent updates, or the highest and lowest temperatures in the last 7 days. By setting up a query inclusive edge inside a parametrised edge, this data can be wrapped in HTML and served as part of a rich browsing experience.

Edges can be created that link a node parameter to any transaction on the network allowing parameters to reference things such as: On-chain identities; Smart contracts; Files; Other TXDBs; and Nodes in other TXDBs.

Overall, edges function as an instruction to the database management system, wherein the edge determines which parameter of a transaction to look back upon and modify. Static edges can refer back to a specific transaction output parameter, while dynamic edges can refer back to the latest version of a specific parameter.

The database management system can track modifications made by each transaction, and transactions connected via edges in the writechain, to enable database content to be modified or its overarching structure to be overwritten or deleted. Each token, the transactions that it makes and the outputs it generates form its respective writechain. Transaction outputs that determine the updates and/or instructions that determine the content of the database, such as those that define entities or parameters of the database, can be unconnected and can be said to ‘hang’ from transactions. These ‘hanging’ outputs that are unconnected can be terminal, such as a FALSE RETURN e.g. an OP_RETURN.

Outputs from a transaction can be locked by at least one public key, which can then be unlocked by corresponding digital signature(s). Outputs can additionally or alternatively be locked by an OP_CHECKMULTISIG script. In this way an important entry, or condition, of a database can require the approval, via a private key, of at least one of: more than one other token or at least M of N public tokens, and the entity or authority in control of said tokens. By locking outputs using multiple signatures a database management system can permit a token to determine database content from output from its own writechain e.g. it has limited authority to read and write content to the database. A database owner, however, can have particular needs such as controlling the editing rights of the database content.

For example, a master token can create five administration tokens, wherein each administration token can create and manage an unlimited number of write tokens. The master token, during the minting of the administration tokens, can limit an action taken by an administration token e.g. to delete the write token derived therefrom and the associated writechain, which would require an output instruction from the admin token. Therefore, a transaction output that deletes a write token must be locked by multiple digital signatures, which in this example requires 3 of the 5 administration tokens to concur in their own separate transaction, each of which can be recognised by the database management system to affect the deletion of the write token.

In this way, the entity or authority behind the database retains control of the database content because instructions on a writechain can be superseded by instructions on a writechain created by its parent token. To be clear, approval is not derived from a token as such, but the entity or authority that created said token. By retaining control within the token minting process, and the parent-child relationship, the database administrators of the database management system are able to determine database content based on the requirements of the database creator i.e. the authority that created the founding master token, or the genesis token. While the database management system interacts with the writechains the control is retained by the founding authority. By tracking the modifications made on one or more writechains, from the creation of a token and the establishment of a database, the database management system can compile a database in a deterministic way by chronologically following the database assembly instructions in the transaction output in the or each writechain. Token transactions are made at a ‘blockchain’ level, while the database management system can be described as a ‘layer 2’ agent that is programmed to retrieve and compile token information from the blockchain into a transactional database.

The database management system can begin determination of the database content by obtaining information from the database establishment transaction, which outlines the type and format of the database. Subsequent transactions in the write chain contain instructions to build the database. For public databases, these instructions can be stored as open, unencrypted data items. However, databases which hold private information may contain encrypted data and instructions. In these cases, the database management system would be required to have knowledge of the encryption keys needed to build a valid database. During the determination of a database the management system can accept information from a writechain derived from at least one of a write token, admin token and master token. By way of example, writechains of transactions are created from a chain of addresses having a linear history that represents the token. A writechain is an unbroken chain of linked token transactions.

A query language can be used to determine the database and its content from token transaction information. A query can start from a token transaction and follow edges to a final parameter. If an edge links back to another node, the query can add a parameter from that node to be returned. Where the final parameter link is an edge back to another node, the full contents of that node is included in the return. If that node includes edges back to other nodes, the query can specify a specific parameter to find data in any linked nodes, or return the full contents of the linked nodes.

All tokens are derived from a database establishment transaction, which can create a master token held in cryptocurrency UTXO that is used to create further tokens held in UTXO. A UTXO holding a token can be used to extend the writechain of transactions with at least one input derived from at least one token holding output from a parent transaction, while database operations, such as adding information instructions, can be stored in a FALSE RETURN e.g. an OP_RETURN output, or spendable outputs containing data.

Vin0 and Vout0 of any transaction can be connected in the writechain such that a database management system determining the database can track the inputs and outputs and actions to be performed upon the database. Preferably, the input to a transaction (Vin) containing the token is input at Vint, although it can come in at any input before being spent at the corresponding output (Vout). Database parameters can be output after the token input and linked output index i.e. if the token is input at Vin(n) then database parameters can be input at Vout(n+m), where ‘n’ and ‘m’ are positive integers i.e. outputs being created by the hanging token should have a higher output index than the hanging token itself. Typically a hanging token spends its UTXO to itself in a transaction, preferably into and out of Vin/Vout index 0. However, the database management system (DBMS) can have predetermined rules governing the position of the token input to the transaction in relation to the output, wherein said rules can be determined in data submitted in the scriptSig, which instructs the DBMS on which outputs contain the database instruction.

If no monetary output is used, it can end the chain. It is to be noted, however, that a chain can continue because an output can have a zero-cryptocurrency value e.g. zero satoshi value and still be valid. Alternatively, an unspendable script e.g. FALSE RETURN, can be used to end the chain.

The operator, such as the provider, of the DBMS can determine the format of the transactions. The transactions, therefore, can be configured to be actionable on the condition that a payment is made and/or an asset is transferred during a transaction. In other words, payments for the establishment and use of the service can be incorporated directly into the on-chain actions that create and extend the database. Payments can be made to determine a transaction and change outputs provided to receive any excess cryptocurrency e.g. satoshis or asset value e.g. dynamic tokens or static tokens received.

While a master token can perform any function, including those of the administration and write tokens, in relation to a database established from the database establishment transaction, an example of the different transaction types is given for an administration token and a write token.

Administration tokens can create transactions for a list of purposes, including:
Database Establishment. Both master tokens and administration tokens can take one or more UTXO inputs and create a master administration output or a master write output. This transaction can also create one or more setup fee and change outputs. Database names, ownership rights, purpose, links to relevant information such as organisational data and contractual data e.g. smart contracts, can be provided in this transaction. Add an administration chain. This transaction divides an existing administration writechain UTXO to create at least one new token, and assign administration privileges to the or each token. These newly created administration tokens can be created with a restriction that allows the token creating the new write chain to review and sign off on changes to the database made by the newly created token. This can be achieved by creating a token in a multiple signature (multisig) output.
End Administration chain. This transaction indicates that the writechain of this token is complete. Unspent UTXO from the token is spendable in a normal cryptocurrency transaction. No further administration transactions can occur on this writechain, and a database management system will ignore any further transaction outputs.
Invalidate Administration Chain. With the relevant authority, this token transaction can refer to the identification e.g. the transaction identification, of another administration token writechain and indicate to a database management system that all actions upon said writechain, or all subsequent actions, are to be ignored and not form part of a database.

Administration tokens are created by an authority, which typically controls a master token or administration token having the rights to post transactions with instructions that specify, for example, that the actions of a separate write/administration chain after a particular TXID do not represent valid actions in the database and that the DBMS should exclude them from the records it uses to build the database. This can be retroactively applied.
Change Administration rights. With the relevant authority, this token transaction can refer to the identification e.g. the transaction identification, of another administration token and output an instruction to a database management system that said another administration token and/or writechain has a modified level of privilege or authority. The change can be from that transaction onwards or can be retrospectively applied to reverse historic actions made by that writechain.
Add Write Chain. This administration token transaction creates a new write token in an output. Transactions made by a write token can create new entries in the database through outputs. A write token can be restricted to editing database content derived from transactions on its own writechain, or restricted from editing nodes at all. This writechain's UTXO can also be created as a multisignature output giving an administration token that created it the ability to approve or deny modifications to the database.
Change Write Chain Authority. This administration transaction can instruct the DBMS to modify a write token's authority. By way of example, transactions from said writechain can be enabled to link to nodes on other chains or within other segments of the database.
Create Segment. A database segment can be created within an existing database. In effect, a master token or administration token can create a further master token or further administration token, which has full authority within that segment, together with a further database establishment transaction. Further tokens can be created and their use can be restricted to that segment of the database.
Invalidate Token. This transaction tells the database management system to ignore a specific transaction and any edge that links to the transaction will be flagged to indicate that the transaction is invalid. No further writechain can be connected to that transaction.
Invalidate Node Update. This transaction tells the database management system to ignore a specific update within a transaction. This transaction can be used to correct an error.

Write tokens can create transactions for a list of purposes, including:
Entity creation This transaction creates an entity within a database, such as a thing, person, place, unit, object or any item about which the data should be captured and stored in the form of parameters, properties, workflows and tables. Parameters or properties associated with the entity are provided in individual outputs e.g. a FALSE RETURN output.
Transaction update. This transaction can be used to add new parameters, new properties, or update parameters or properties in a database. When parameters are updated, the database management system that determines the database will always regard the most recent valid update transaction as correct. However, transactions can also create edges that link to specific versions of a particular parameter to add or modify data already in the database.
End transaction. This transaction signals the end of the writechain. If a writechain does not have the right to declare its own end, the transaction must be countersigned using an administration token. No further transactions from this token or any of its descendants will be considered as part of the database.

Blockchain ledgers can be used to record the status of a single piece of data, but the tokens taught herein provide a mechanism enabling the formation of a database, said tokens having lineage to an establishment transaction, enabling the authority of each database modification to be determined. The relationship between each token transaction creates a writechain enabling a database management system to build a database from the relationship of the transactions in one or more writechains. Tokens can be provided with different levels of authority, such that a transaction on one writechain can modify the effect of a transaction output on another writechain has on the database. By following the transactions from one or more writechains a database can be formed in a deterministic manner.

The deterministic formation of a database from transactions and their writechains' extracted from a blockchain ledger (i) provides integrity for a newly formed database, and (ii) enables an existing database to be imported, and the management of data entry and maintenance of an existing database to be seamless during the conversion process. By way of example, an existing database e.g. in the form of a spreadsheet, may be implemented on Google® documents and shared amongst 99 people, who can simultaneously view or edit the spreadsheet. Importing, or transferring, said spreadsheet can be achieved by minting a master token, or administration token, together with a database establishment transaction that included the existing spreadsheet at the time of minting. 99 write tokens are subsequently created from the master token, each token having a relationship with the master token and establishment transaction. Subsequent transactions by each write token have an output that functions as an instruction to modify the database in the establishment transaction and define a new transaction in its own writechain. A database management system can find on the blockchain ledger the database establishment transaction and each of the transactions on each of the 99 writechains. By following the writechain from the database establishment transaction to the end of each of the 99 writechains a database can be determined. The determination can follow the chronological order of the transactions.

Fees

The formation of a writechain can incur costs through external fees, including (i) miners' fees associated with each transaction on the blockchain and/or (ii) fees associated with the database management system. These fees can be processed through a secondary input containing funds, and a separate change output can be added into the transaction without impacting the database chain. Alternatively, the write/admin token itself can contain cryptocurrency e.g. satoshis which it uses to pay transaction fees. If there were no external fees a token on a writechain can output the same number of satoshis from a transaction as it inputs by spending the token UTXO to itself. To accommodate external fees token can be provided with a secondary input containing funds, which can be used to add satoshis to the transaction to cover external fees.

Alternatively, a token itself can contain satoshis which it uses to pay external fees. If the input has excess satoshis for the fees being paid, this change value can be spent to the output.

Another funding option can involve the service that provides the DBMS structuring the transactions such that payments for the establishment and use of the service can be incorporated directly into the on-chain actions that create and extend the database. Change outputs are to show that the party paying for the service can take any excess satoshis/dynamic tokens/static tokens received as change and pay them back into their own wallet in the same action. Database information is preferably contained exclusively in unspendable FALSE RETURN outputs, although any kind of output can be used. Due to the nature of a hanging token it is not necessary for an output containing database outputs to have a blank input, however it can be a rule that is applied for the purposes of laying out a transaction.

### Examples

The establishment of a database, the transactions, writechains and deterministic formation of a database using a database management system can be applied to any database application, and will be described below using, without limitation, various examples. In light of the teaching herein a skilled person would be able to apply the teaching and/or features of one example to another.

Different applications can benefit from different token arrangements, which depend at least one of (i) the entities controlling the tokens, which can be either distributed or centrally located, (ii) the number of parameters being monitored, (iii) the resource budget and (iv) the frequency of transactions required. The provision of tokens for forming transactions to enable a database to be determined provides scalability, limited only by the resource of the blockchain and the database management system. Different token arrangements can include n^{th}-order functionality.

Example arrangements are provided below for different applications, wherein an asset is monitored and data associated with the asset is output on a token transaction.

Cows

The first example relates to ‘central’ management of data originating from a centrally located entity having multiple local assets. In this example cows on a farm are monitored and data stored on a transactional database, wherein one token is provided for each herd on a farm, and each cow's data is managed in a bespoke table within a database. Each cow is considered an asset, and in practice each cow is provided with a unique tag having a machine readable code e.g. an RFID that can be read when data is being recorded in preparation for a transaction.

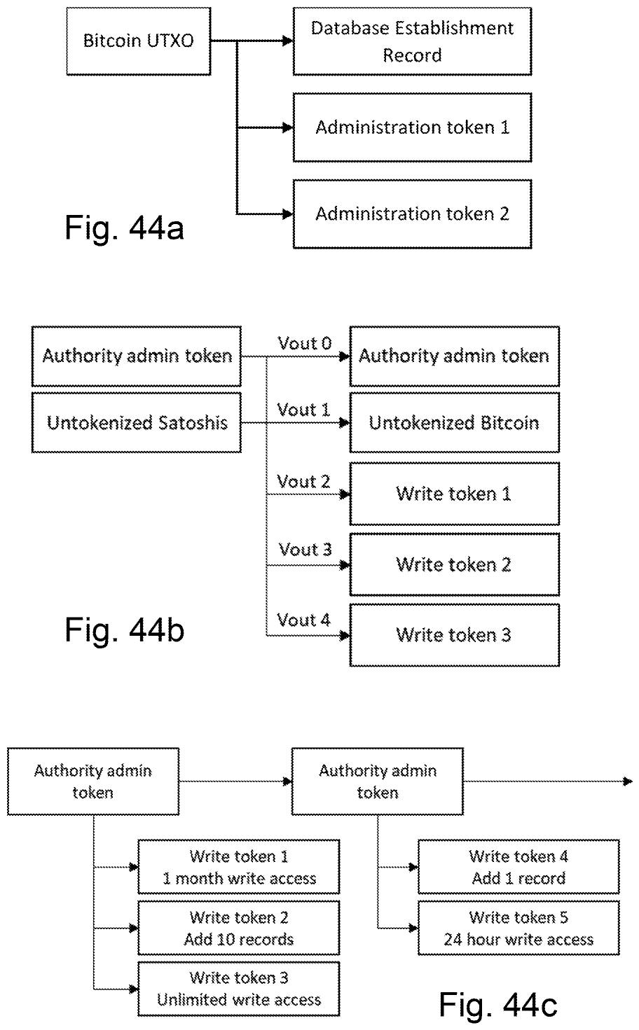

In one example, a farm owner having a herd of cattle wishes to monitor each individual cow using token transactions and a database management system that will collate and determine a database based on said token transactions. FIG. 44a shows the initiation of the creation of a monitoring system using tokens and the establishment of a database, said Figure representing the input and output of a minting transaction, wherein tokens are created. The minting transaction can also determine the authority of the issuer using signatures, as described in other examples of the invention where tokens are minted.

As described above, a write token can create transaction outputs that determine database content. Write tokens can be configured with write-only authorisation over the database content.

In relation to write tokens, the asset is the output data for a transactional database and the authorisation is determined when an administration token creates the write token. The administration token can refer to a token definition transaction or create a new token definition transaction, said definitions including script that determined the scope of the write token.

FIG. 44b shows how an ‘authority admin token’ i.e. an administration token is input (Vin0) to a transaction, and output at Vout0. Similarly, untokenized cryptocurrency e.g. satoshis are input (Vin1) for allocation to newly created write tokens—write token 1, write token 2 and write token 3, respectively at Vout2, Vout3 and Vout4. Unused untokenized cryptocurrency is output at Vout1. In less detail, FIG. 44c illustrates two transactions, wherein the first creates three write tokens: write token 1 having write access, or permission, for 1 month; write token 2 having write access for 10 records only; write token 3 having unlimited write access, and wherein the second creates two write tokens: write token 4 having write access, or permission, for 1 record only; write token 5 having 24 hour write access. A database management system can determine the access of each token during the retrieval of the token transaction from the cryptocurrency ledger. During the retrieval the level of access of a token can be determined from the token data e.g. the output script and/or by referring to the token definition transaction used to create the token(s). The farm owner spends cryptocurrency e.g. Bitcoin UTXO into a transaction as the first input (Vin0) and the change output is spent as the first output (Vout0). Further outputs are the database establishment record, a first administration token, shown as Administration token 1, and a second administration token, shown as Administration token 2. The first administration token has full authority over the database content, and the ability to create further tokens, which is held by the owner, who can also be the issuer, and functions as a master token. The second token is an administration token that is passed to a farm manager, who will monitor the herd on a daily basis and use the token to make transactions that record data on each cow in the herd. This transaction can be referred to as the minting transaction for all tokens derived therefrom.

Administration tokens provide a level of authority and/or access right to the database. The tokens are used by the controllers of the database to manage the data extraction from the ledger upon which the token transactions are made, and manage valid data flow into the database output. With the correct level of permission a token can be used to create additional administration tokens with different access rights.

To create an additional administration token, an administration token with appropriate rights is used in a transaction as a feed input and is spent into a script containing a further ‘minting record’ which details the new administration token or tokens being created. The transaction must also contain the appropriate signatures and data so that a database management system reading the information can know that this new token can validly make changes to the database. In a similar scenario to static tokens, the administration tokens can retain their satoshi value so a separate input must be used to provide BSV satoshis for the payment of transaction fees.

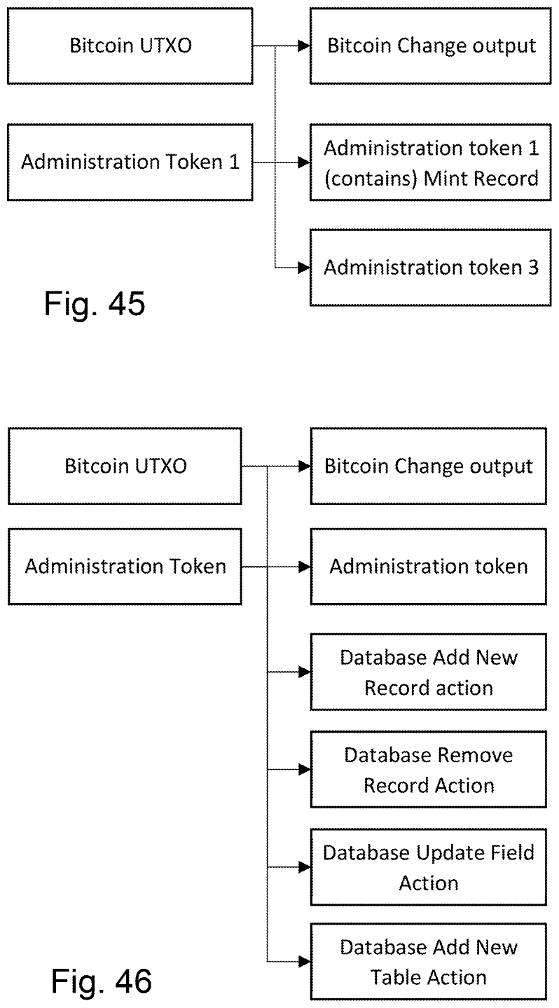

When the farm owner purchases a new herd of cattle, for management by a different farm manager, they require their own token. In FIG. 45, the farm owner performs a transaction using their master token i.e. Administration Token 1, creates a mint record and third administration token on the output. Cryptocurrency e.g. Bitcoin UTXO, is spent into a transaction as the first input (Vin0) and the change output is spent as the first output (Vout0), with the administration token being spent into the transaction as the second input/output pair (Vin1/Vout1). The third output (Vout3) creates a newly created third administration token. In this action a data buffer in the database management system can be used in the new administration token as a means by which the DBMS can trace the different tokens.

It is to be noted that the tokens do not write information to the database, but create an immutable record of the status of a resource being monitored through transaction outputs. The issuer, which in this case is the farm owner, can provide the details of the minting transactions and token details in order for a database management system to efficiently search for associated transactions on the ledger. A database management system can determine a database, or determine an update to a database, from the token information and their outputs. Therefore, the full history of the database remains recorded on-chain as a set of outputs from transactions in a writechain, and the database management system determines the database by compiling said outputs. The database management system can be provided with at least one of: the private and public keys of the tokens; the mint transaction details; the database establishment record; and the authority level attributed to tokens—and using information provided it can search the ledger and determine the transactions and edges in the writechain of each token, and the instructions on transaction outputs.

An example of an administration token transaction is shown in FIG. 46. More specifically, in FIG. 46, cryptocurrency is spent and the UTXO output assigned back to itself. The token itself can have a public and private key pair, functioning as the UTXO that permits the holder of the token to make transactions with the token. Data relating to the database actions are not recorded in the administration token itself, but in transaction outputs. The transaction outputs preferably that carry zero satoshis and are spent into FALSE RETURN outputs. These FALSE RETURN outputs can include instructions to the database management system to perform any definable database actions including but not limited to the creation and removal of tables within the database, the creation and removal of records in the database and the modification of fields within records in the database.

The farm manager responsible for the second administration token wants to track each cow in the herd. The second administration token was established containing information including the owner of the new database, the name of the database and the type of database, which in this example is relational, although it could be any type of database, such as a graph database. A token can also contain information about the database management system that can be used to determine the database from the associated transactions on the writechains.

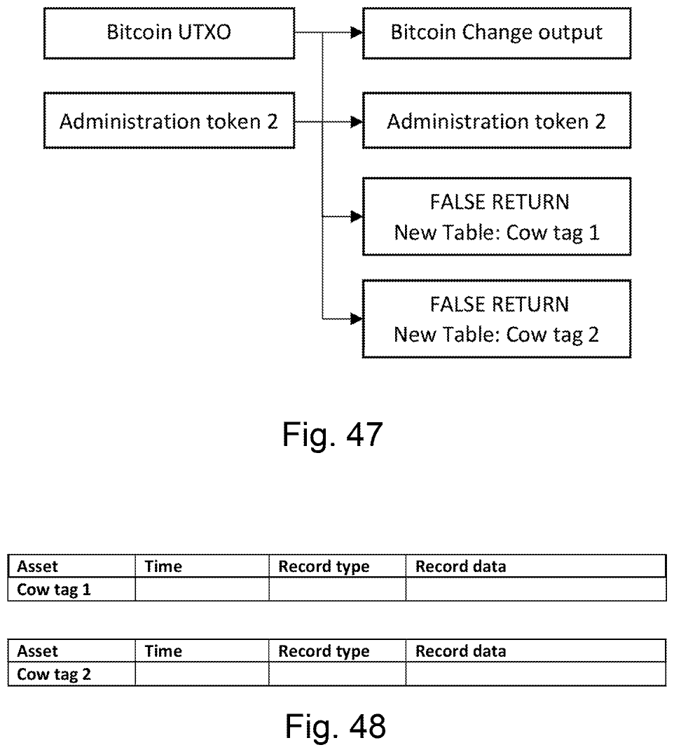

In FIG. 47, a farm manager performs a transaction with the Administration token 2 for a relational database that creates a table for each cow tag, although only two are indicated in the figure for simplicity. Each table can be extended each time a new record is added for a cow.

FIG. 48 shows the format of the table specified in the FALSE RETURN output in FIG. 47. For each asset i.e. for each cow's record, the asset is specified and includes three attributes—namely time, and a key:value pair i.e. record type and record data. In this example, the tables are only updated with timeseries data once per unit time, which is accurate to 1 second, and only 1 update can take place in any given second.

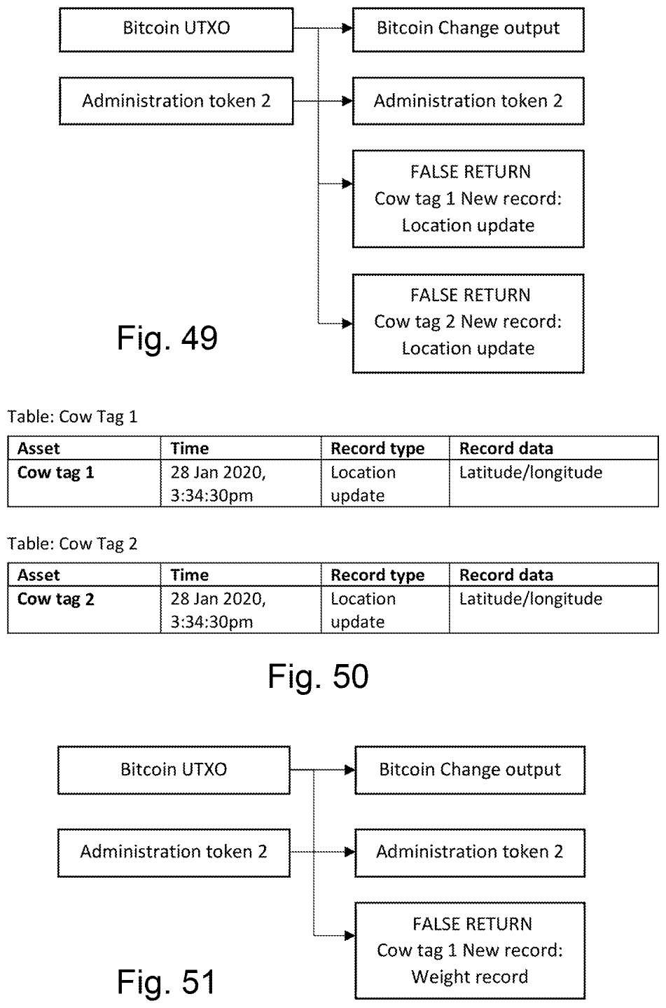

FIG. 49 shows a transaction of the first administration token that adds a ‘location update’ for each of the assets, which when determined by the database management system would appear as shown in FIG. 50.

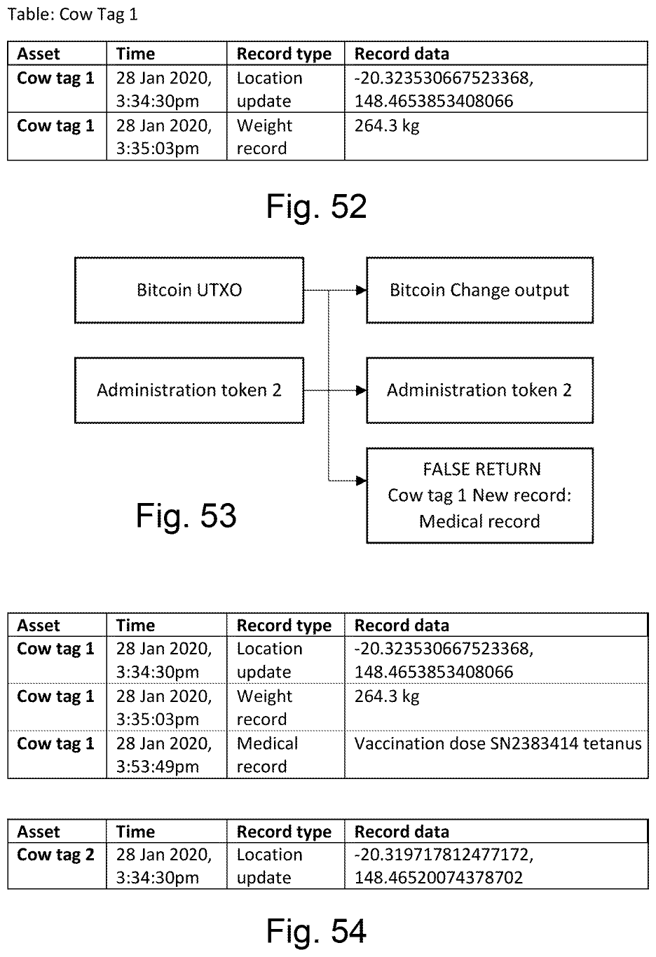

After weighing the first cow, a further transaction of the first administration token is made, as shown in FIG. 51, with the output from that transaction being determinable by a database management system to create the table shown in FIG. 52, wherein the location of each cow has already been determined from the previous transaction and the table for ‘cow tag 1’ additionally includes a further key:value pair in the form of a weight record.

FIGS. 53 and 54 show a transaction and the resulting tables determinable by the database management system, respectively, following a transaction of the first administration token to add a new key:value pair record, said record being the vaccination of cow 1 for flu. Details can be provided, such as a serial number which the farm manager adds to his database records allowing the vaccine to be traced to a particular animal.

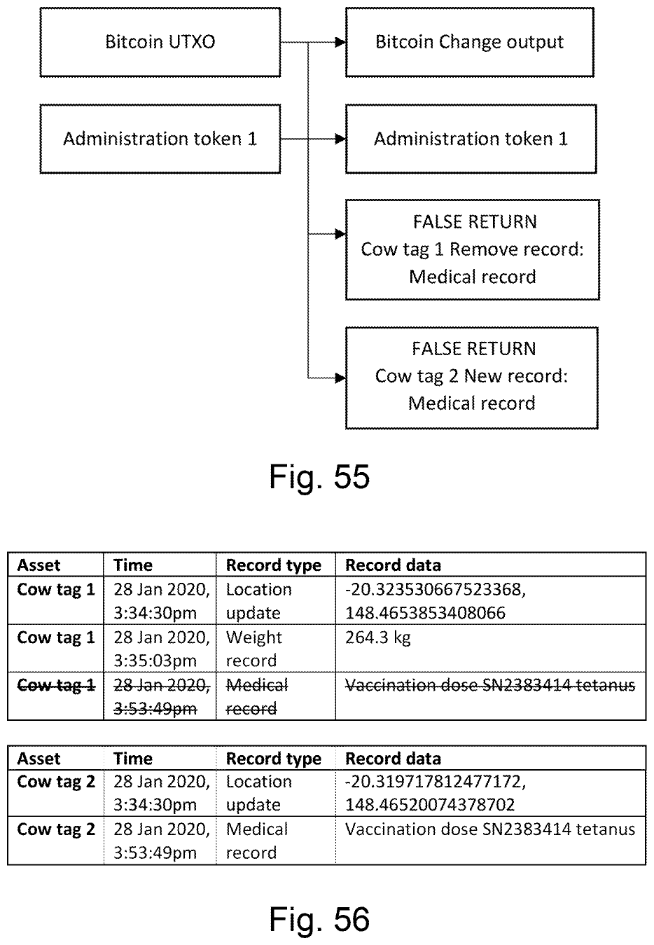

The farm manager realizes later that they have vaccinated ‘cow 2’ but recorded the vaccination against ‘cow 1’. If the second administration token has the authority to make a correction then a transaction can be made as shown in FIG. 55, and the table would be updated to delete a record from the table of cow 1, and add a key:value pair record to the table of cow 2. In this case, however, the farm owner has restricted the authority of administration token 2 such that it cannot modify medical records. Therefore, it is administration token 1, with full authority, held by the farm owner, that creates the transaction. The database management system can monitor and extract information from each of the writechains of the respective tokens and update the database accordingly. FIG. 56 shows the tables that have been determined from the token transactions and indicates that the record was removed from the Cow Tag 1 table, and an identical record added to the Cow Tag 2 table. For the farmer owner this administrative record is a valuable means to record what happened and ensures full traceability.

Weather

The second example relates to the ‘hierarchical’ management of data by a central entity, with many distributed sub-entities that have multiple local assets. This example corresponds to a weather monitoring for a nation, having specific countries, counties and individual weather stations. The source of the data is distributed across a large geographical area.

Using the United Kingdom as a representative nation in which weather conditions are to be monitored by recording conditions on token transaction outputs, the central Meteorological Office (Met Office) in Devon, England can establish a database on a blockchain in a minting transaction. As with all minting transactions, and the tokens produced therefrom, the entity creating or commissioning the tokens is the main owner or authority.

In one example, the Met Office records in the minting transaction a database establishment record for establishing a database and one or more token-related outputs representing a token. The transactions for establishing the database can be established in a series of separate transactions, including a transaction that establishes the authority, a transaction that establishes the database itself and a further transaction that establishes or issues a token.

In this non-limiting example the minting transaction produces a master token and four administration tokens—one for each of Scotland, England, Wales and Northern Ireland. The output of the minting transaction provides each administrative token with a quantity of token-related cryptocurrency. The quantity can be zero.

Each administration token can create further administration tokens, for example the administration token for Northern Ireland can create an administration token a county, e.g. Derry or Antrim, and each county administration token can create a write token for each city or location in said county e.g. Derry or Belfast. This process can be repeated until a token is provided for each weather station in the United Kingdom. Preferably, the token for each weather station is a write token. Multiple write tokens can be created from an administration token. Each token has its own write-chain, and each transaction extends the writechain from the first transaction that created said token. Further tokens can be added or deleted, as required. The key pairs for all tokens created for the Met Office in the original minting transaction, and in subsequent minting transactions, are known. The key pairs can be provided to the database management system for use in extracting transactions from the ledger or blockchain to build the transactional database.

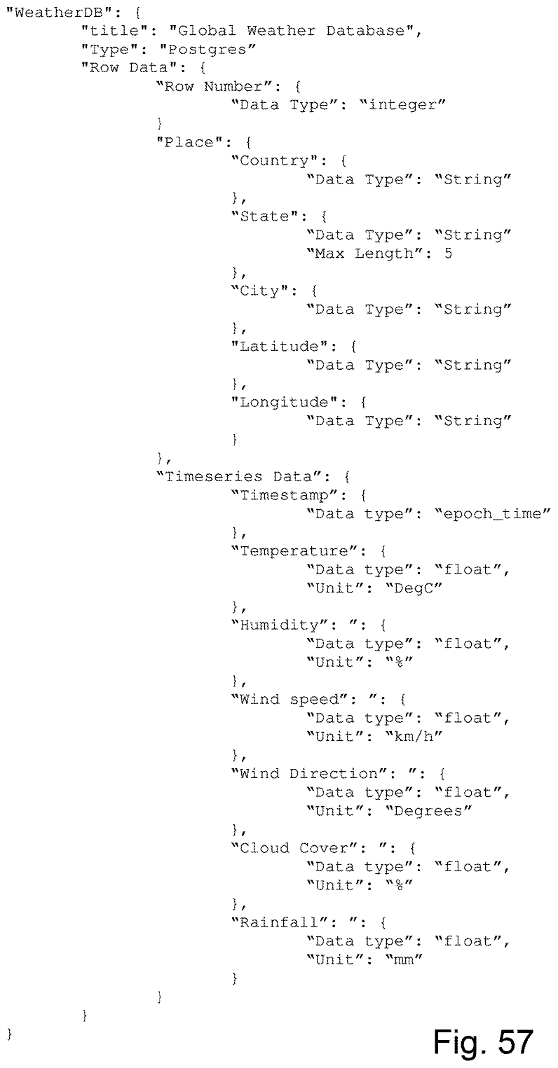

The minting transaction defines the content of the database, including the entities and parameters to be monitored, as shown in FIG. 57, which shows a JavaScript Object Notation (JSON) defining a weather token which could be used to generate a database of national weather data. JSON has been used by way of example another format can be used to create script, such as pushdata script. When each row is created, the row number and place are set.

After each token is created its subsequent transactions on the blockchain can provide one or more instructions to the database via the FALSE OUTPUTS, e.g. OP_RETURN outputs. For example, the outputs from transactions can contain instructions to at least one of: add a new row; update a full row; update part of a row; remove a row; freeze/lock a row; or thaw/unlock a row. In more detail:

During the creation of a new row, each of the row parameters can be added as a separate pushdata item within the transaction, in the order in which the JSON outlines them:

OP_FALSE OP_RETURN N 120 “N.Ireland” “Derry” “Derry” “27.4843° S, 152.9837° E”,

wherein the ‘N’ indicates that this row is a NEW row, ‘120’ is the row number, and the following items are the place data as defined in the JSON. A database management system determines that row 120 has been added to the database as Derry, Derry.

During the update of a complete row, the token transaction is used to update a row with a new set of timeseries data, wherein each of the row parameters is added as a separate pushdata item in the order in which the JSON outlines them:

OP_FALSE OP_RETURN U 120 202010032120 19.6 60.0 13.0 90.0 20.0 0.0,

wherein the ‘U’ indicates that this is a timeseries update, and is adding a new set of timeseries data to row 120. The data is timestamped as 3rd Oct. 2020, 9:20 pm. It is 19.6 Deg C., 60% humid, the wind is blowing at 13.0 km/h from the east, there is 20% cloud cover and since the last timeseries update there has been zero rainfall.

During the partial or compact update of a row, the token transaction the token is used to update a row with an update to only a subset of timeseries data. Parameters are preceded by their order in the list in the JSON:

OP_FALSE OP_RETURN C 120 0 202010040820 5 80.0 6 12.0,

wherein the ‘C’ indicates that this is a ‘compact’ update action. A compact update transaction provides an instruction that allows timeseries data to be added or modified in the database in small amounts, which is especially useful when handling databases with large numbers of columns. In this example, item 0 is the timestamp which is 8:20 am on the 4th of Oct. 2020, item 5 is the cloud cover, which is 80% and item 6 is the rainfall which tell us that 12 mm of rain has fallen since the last update.

A token transaction can provide an instruction to remove a row, or part thereof, with the pushdata script e.g. JSON:

OP_FALSE OP_RETURN R 120,

wherein the ‘R’ indicates that this is a removal action, and that row 120 is to be removed. Any further instructions to add timeseries data to row 120 will not be reflected in the database state because the database management system takes in to account all actions upon the writechain to determine the database content.

Freezing a row using a token transaction can use the pushdata script:

OP_FALSE OP_RETURN F 120,

which provides an instruction to the database management system not to accept any further updates to this row. This action can be performed by any of the parent tokens of the token that that created the row.

Thawing a row using a token transaction can use the pushdata script:

OP_FALSE OP_RETURN T 120, which instructs the database management system to begin accepting new updates to this row. This action can be performed by the same authority token that created the freeze on the row.

The use of JSON script in the example is not limiting to the underlying function it represents.

After a token is created each subsequent transaction is tied to one of its earlier transactions, which can be referred to as a parent transaction, through an edge connection. Different edge connections can be created according to the latest instruction to be stored on the blockchain for retrieval by the database management system. Edge connections can be dynamic, wherein content retrieved by querying this dynamic transaction edge is the most recent transaction or parameter added to the database entity e.g. a correction is required to the latest data entry, such as yesterday's total daily rainfall. Edge connections can also be static, wherein content is retrieved from a specific transaction such that, for example, a correction can be made to any transaction or parameter in the writechain.

Identity

The third example relates to ‘parameter’ management, in which a number of established parameters of assets that are unlikely to change are monitored for a high number of individual assets. This example corresponds to an identity database, such as a passport database, or a database for managing driving license records, that is manageable by or on behalf of a government. The management of the transactions would require authoritative control thus the number of administration tokens can be at least an order of magnitude fewer than the number of individuals holding passports.

An individual holding a passport could hold a write token to define their own database content. The write token can be configured to function like a static token, being unchangeable in value, and appear to the user as holding a fixed asset. However, the outputs from the token can be viewed and/or authorised by an authority, which manages a transactional database. By way of example, a write token can be configured with an expiry data and a holder can renew the token by presenting themselves to an authority and prove that they hold the public key for the token's UTXO, wherein the authority countersigns the write-token with a transaction from their own token such that the user's write-token is renewed. The processing cost of managing such a resource could tend to become impractical and vulnerable to abuse.

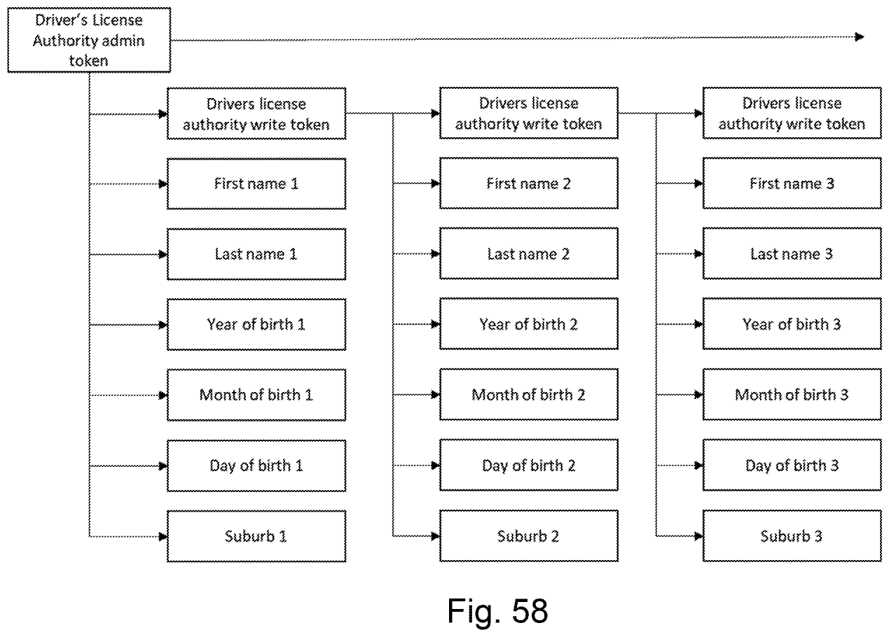

Tokens can be used to establish a database and monitor a collection of individuals' details that represent an identity card, driver's license or passport. A system analogous to the ‘central’ management technique described above can be implemented using tables, which are created for each individual whose information is to be held on the database. FIG. 58 shows a Drivers License Authority (DLA) administration token that has produced a single DLA write token, which outputs, in a series of transactions, parameters associated drivers having the identity ‘1’, ‘2’ and ‘3’ as viewed from left to right. A small selection of parameters is shown for illustration purposes in the figure, although the parameter details can include, by way of example: first name; middle name; surname; date of birth; place of birth; address—1^{st} line; address—2^{nd} line; address—city; postcode/zip-code/suburb; link to current photo; hash value of photo image; and passport number. Only 12 parameters have been listed here, and while the number theoretically unlimited the number of parameters on a passport could be between 100 and 200.

An alternative configuration, not shown, would require each driver to possess their own write token. If administration was distributed according to geographical areas then this would be analogous to a ‘hierarchical’ management technique, as described above in the example of weather station tokens. Such a configuration would require a token for each individual license holder, or passport holder, as well as several layers of administration tokens. While this requires initial set-up investment, the long-term benefit would result in an efficient use of resources with identity tokens being retained by each individual and being updatable in perpetuity. In the United Kingdom, 5 million new passports are issued each year and, therefore, a parameters-based approach can be used to manage transactions for retrieval by the database management system. By way of comparison, a country with a population of around 10 million would require just over the same number of tokens, with additional administrative tokens required for management.

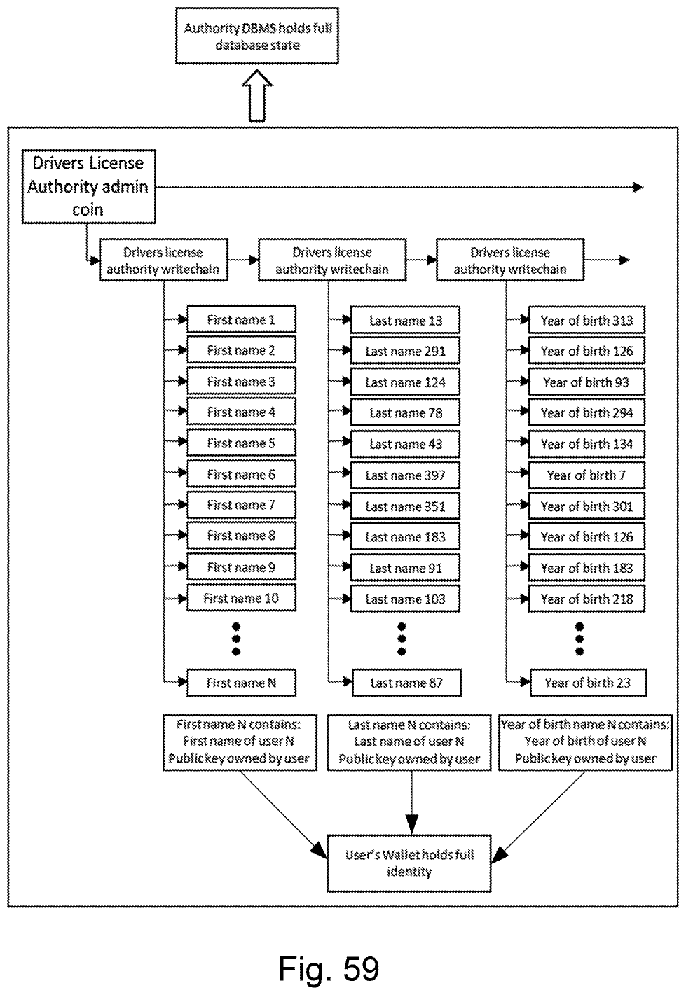

In contrast, using the previous example, all passports could be managed with one token per parameter (estimated to be between 100 and 200 parameters), as shown in FIG. 59 with additional administrative tokens required for management. Not only can this substantially reduce the number of tokens required, but the distribution of the parameters would be obfuscated such that no single token could write the profile of a single individual.

The central, hierarchical and parameter management techniques illustrate the potential of tokens for managing data by token transactions that are compiled by a transactional database, which compiles the transactions on the writechains in to a deterministic and usable database. For example, individuals can hold tokens for several identity functions e.g. driver's license and passport. Individuals can request to make a change to their details, such as update their photo, change their address or request a renewal—said changes being requested via a transaction. However, these transactions can require multiple signatures before being accepted by the database management system as being ‘accepted’ and made permanent on the database—the other signatories to the multiple signatures being tokens held by the respective establishment. The level of the authority required to effect a change can be tailored according to the security level.

By way of example, an individual holds a passport token, which was issued by a government authority and provided to the individual to enable them to prove their identity or cross-borders. The individual would have initially applied for the passport token and their application details would be provided in a database establishment record associated with the minting of their token. The individual now wants to renew their passport and update their photo, and can do so by making a transaction that has outputs including paying the required fee, making a request and adding a file containing their photo to the transaction output. To effect the change, the individual must obtain signatures from the Passport Office, the DLA and their local bank manager, who must identify them in person. The Passport Office can cross-check the request with the existing token status and, for example, compare the biometric properties of the new photo image compared to the old photo image on filed; the individual can use their DLA token to request approval of the passport renewal request by making a transaction that pays a fee and adds a link that enables the Passport Office to access the individual's DLA token for verification; and the individual can present themselves in person at their bank, provide a code, such as a QR code for scanning to verify their identity while cross-checking the individuals details with their bank account.

It is to be noted that the assets managed in these examples are symbolic and the invention is not limited to cows, weather monitoring or passports. Each of these examples illustrate different aspects of the inventions and a skilled person could apply the explanation of the JSON database establishment to other applications, such as the weather token. Moreover, each cryptocurrency that supports tokens and the transactions taught herein can have its own format of code and instructions.

Multisig

Any of the tokens described herein can be conditionally transferred, said transfer determined by an instruction in the transaction that controls the output. By way of example, a Bitcoin transaction can send payments to a public key address through the pay-to-public-key-hash (P2PKH) function.

As described herein, tokens can be used in a communal manner in which multiple individuals are associated with a token, and the token and/or its family or derivative tokens, often referred to herein as sub-tokens, can be used to verify whether a private key signature presented corresponds to one of a number of public keys in a list.

For example, Switzerland often allows its population to vote on amendments to its law. A token-based tracking system, as described herein, can be used to (i) determine whether a person has voted, and (ii) enable a voter to determine that their vote has been counted.

In a simple example, a master token can be minted to establish a transactional database for monitoring votes, then create and subsequently monitor write tokens that have been minted, wherein each citizen entitled to vote is issued with a write token. To vote, a citizen simply has to use their private key to sign for either a ‘yes’ or ‘no’ option e.g. at a polling booth, or online.

After voting each of the signatures e.g. private keys must be checked against each of the public keys. The tokens herein and their configuration can be adapted for any voting system. Separate tokens can be issued in relation to a single ballot to segregate the identity of a voter and their right to vote and the ballot that they cast e.g. a first token can represent proof that a person has voted by the act of them using the token to access their vote, while a second token is unrelated to the person voting and includes script that presents the voting option, wherein the act of voting spends the token in to the choice made.

Within Bitcoin's native scripting language there are a two opcodes designed for handling multisignature scripts which are OP_CHECKMULTISIG and OP_CHECKMULTISIGVERIFY. OP_CHECKMULTISIG checks that a presented set of signatures collectively sign M public keys from a set of N provided where M<N. If the M signatures can be shown to have been generated from public keys within the list, the function leaves TRUE (1) on the stack. OP_CHECKMULTISIGVERIFY performs the same function as OP_CHECKMULTISIG and subsequently performs an OP_VERIFY function, creating a gateway that either fails the transaction or allows it to proceed. If the function is successful, nothing is left on the stack and the transaction script moves to the next opcode.

Each of these opcodes require a set of data points to be arrayed on the stack including integer values, elliptic curve signatures, public keys and a currently unused value to be arrayed on the stack. The example below is for an OP_CHECKMULTISIG script, although it can be applied to an OP_CHECKMULTISIGVERIFY script. In both scripts, the currently unused value to be arrayed has no function and requires an ‘junk’ value (typically OP_0) to be placed on the stack before the first signature. This ‘junk’ value requirement is colloquially referred to as a ‘bug’, which is undesired and tolerated because it can be addressed by assigning a value of ‘0’. Including the ‘junk’ value, a multisignature operation must be submitted for validation in the following manner:

<junk_value>
<signature a> <signature b> ...<signature M> <M>
<pubkey 1> <pubkey 2> ... <pubkey N> <N>
OP_CHECKMULTSIG

The current operation involves the OP_CHECKMULTISIG script performing the validation by taking <signature a> and comparing it to <pubkey 1>. If this does not match, it compares the signature to <pubkey 2>. This process repeats until there is a match, e.g. signature a> matches <public key 2>, the validator takes the next signature to be matched i.e. <signature b> and compares it to <pubkey 3> and so on. This forces signatures to be submitted to the script in the correct order. Once all of the signatures have been validated, the function solves ‘true’ and the process moves onto the next opcode.

In a system in which scripts are processing large numbers of public keys and relatively small numbers of signatures the process is inefficient because large numbers of signature checks against invalid combinations of public keys and signatures occur. Signature checks are computationally expensive and occupy many cycles of the validator CPU, creating bottlenecks for the processing of large multisignature transactions.

The inventor has created an improved method for OP_CHECKMULTISIG and OP_CHECKMULTISIGVERIFY, which demonstrates an improved process. In the improved process a user configures the script to provide an indication, to a processor of a network node performing the script, of the position of the public keys that match the signatures. In other words, users of the Bitcoin network provide the nodes processing the transaction a signal that enables determination of the specific subset of public keys against which signatures have been provided, thereby eliminating the inherent inefficiency of the OP_CHECKMULTISIG or OP_CHECKMULTISIGVERIFY validation process. In this way the signal communicates to the node which public key to check each signature against, thus inhibiting the inefficiency of checking through the entire list of keys.

The Bitcoin protocol remains unchanged, and the ‘junk’ value (which has been replaced with a signal that enables determination of a subset of public keys against which signatures have been provided) is consumed during the processing of the opcode operation. Any node that does not recognise the signal can still process the transaction in the original manner with no impact to its validity.

In one example, the signal can be comprised of a binary string/field that is four bytes long (32 values) where each bit represents one signature in the list. Therefore, for each signature, the bit in the string that corresponds to the public key being submitted is set to true. More specifically, the signal is represented as a binary string, wherein bits 10, 19 and 25 are set to ‘one’ and the remaining bits are all set to zero.

| | |
|---|---|
| <00000000 01000000 00100000 10000000> | (signal) |

<sig 10> <sig 19> <sig 25> 3
<pubkey 1> <pubkey 2> ... <pubkey 32> 32
OP_CHECKMULTISIG

The node validating the script would initially read the list of bits in the signal and know that ‘pubkey 10’ should correspond to the first signature listed in the signal, ‘pubkey 19’ should correspond to the second signature and ‘pubkey 32’ should correspond to the third signature. In this way, the node validating the script can check just 3 signatures, instead of the 25 that would normally be required. In this example an 8-fold efficiency improvement is achieved, which would allow a user to (i) have their transaction completed faster, (ii) create an opportunity to incur a lower processing fee from nodes who understand the signal to process the transaction, and (iii) lower the processing cost of the transaction.

In another example, the signal can be represented by a concatenated list of fixed length integers where the maximum integer value is greater than N (the number of public keys). For example, in a multisignature operation with more than 256 public keys, at least 2 bytes per value must be used. For a list of more than 64,536 keys, 4 byte integers must be used. Since there is no limit on the number of signatures that can be processed, this technique can scale to very large numbers of signatures (more than 4.3 billion) by extending the integer to 8 bytes.

These examples are most efficient in instances where the number of signatures M is less than N/(integer bit length) i.e. for a script with 256 public keys, optimum efficiency is achieved when less than 256/8 (32) signatures are to be verified; and for a script with 512 public keys, the integer length is 16 bits so the value is 512/16 (32).

In a further example, a user can signal to the node which of these two techniques it is using by pre-pending a 1 byte indicator to the signal string. In order to use this technique, network nodes must employ specific software which can understand the signal and extract the information contained before processing the signatures. The use of this software can provide a node operator with a competitive advantage by allowing them to process transactions with very large numbers of public keys without wasting processor cycles by checking invalid combinations of keys and signatures. This results in lower energy consumption and a greater processing efficiency.

Online Contract/Forms

The tokens described herein stem from a minting transaction. Each token has a deterministic relationship with the minting transaction that enables its authentication and/or a linear transaction history to be determined. When the transactions output data, the linear transaction history can be referred to as a writechain, which is the relationship between the use of a token in two or more transactions. In each of the examples of the invention, the minting transaction provides data that determines the functional operation of a token—which can, at least one of, manage an asset, record information in transactions and subsequently enable compilation of transactions on a writechain into a functional record deterministically. Further, the interaction with a ledger, such as a cryptocurrency ledger, inhibits corruption and optimises use of a scalable platform in an efficient and cost-effective manner.

In another example, an issuer can mint tokens for the purpose of digitally executing a form having a prescribed format. The form can include (i) a template component, such as a clause, statement of consent or agreement, and (ii) a data-entry component, for accepting details or signatures.

In general, a minting transaction produces a token including a form specifying a template component and data-entry component, the latter configured to correlate with user-specific data or content. The data-entry component is analogous to a blank-space or editable portion of a form that a recipient of the token can complete.

A recipient of a form token can review from the transaction history, i.e. the writechain, the format of the form and/or the template component, such they know what they are completing and/or approving. Then, the recipient of the form token can complete the form by making a transaction and outputting the data to be entered in the form from the transaction, preferably as a false output. The output can be a digital signature. A portion of template component, which can form the body of the agreement, can be a hash of its string and/or content. In other words, rather than repeating the full body of the agreement, a hash of its content can form a portion of the template component. Using a hash of the content can minimize the size of the token, with the full human readable template of the form being accessible via a link embedded within the transaction, or directly from the edge linked parent transaction. The template component of the form can be a component of a Ricardian contract.

Implementation of a form token, which is a tokenised form, can be achieved by an issuer creating a redemption script that requires a user to submit a complete and valid form in a prescribed format. This technique can be used to create textual entry requirements such as:

“I, <valid alias> using public key <pubkey>

agree to abide by these terms and conditions:
Term 1
Term 2
Term 3

Signed

<digital signature>”

In this example, the terms between the “<” and “>” symbols are the data-entry components, while the remaining text is the template component.

Further, the example can be implemented by a script as follows:
Part 1: Checking “I,”
   3 OP_SPLIT OP_SWAP 492c20 OP_EQUALVERIFY
wherein this code splits the first 3 bytes from the string and checks them against the Hexadecimal string that corresponds to “I,”.
Part 2: Checking <valid alias>
Checking the alias can be performed by (i) an agent which countersigns the script, or (ii) using a merkle tree of known aliases, wherein the user would supply the alias and a merkle proof that shows that it is included in a merkle tree of valid aliases, followed by script that can interpret and solve the merkle root, thereby proving the alias is a member of the tree. The latter technique, in certain scenarios, can remove the need for a third party agent to participate in the validation process.
Part 3: Checking “using public key”
   13 OP_SPLIT OP_SWAP 7573696e67207075626c6963206b6579 OP_EQUALVERIFY
wherein this code splits the first 19 (13 in hex) bytes from the string and checks them against the Hexadecimal string that corresponds to “using public key”
Part 4: Checking public key
   21 OP_SPLIT OP_SWAP OP_DUP OP_TOTALSTACK [checking function]
This script splits the pubkey from the text string, duplicates it and pushes a copy onto the altstack to check later against the digital signature. To check the public key, there are several types of checking function that can be used, including: a check of the public key, which can be performed by an agent which countersigns the script; or the check can be performed using a merkle tree of known public keys, in which the user would supply the public key or its corresponding alias and a merkle proof that shows that it is included in a merkle tree of valid public keys, followed by script that can interpret and solve the merkle root, thereby proving the public key is a member of the tree. The latter technique, in certain scenarios, can remove the need for a third party agent to participate in the validation process.
Part 5: Checking the body of the agreement
At this time the script must check the body of the agreement.
This can be done using the following script:
   52 OP_SPLIT OP_SWAP OP_SHA256
   698c281389c063c96be771e3e8d7e360221ce53d71af08d73390e3e546630d5b
   OP_EQUALVERIFY
This script splits 82 (52 hex) characters from the text blob, cutting the main body of the agreement out as follows:
“agree to abide by these terms and conditions:
   Term 1
   Term 2
   Term 3
Signed”
Including all spaces and formatting. Because it is larger than 32 bytes, for purposes of efficiency, the string is hashed and checked against a hash in the document.
Hashing the string in this way a form, such as a contract, with many terms and conditions can be checked using a script that condenses the check down to a small 32 byte string.
Part 6: Signature check
Finally, the only remaining information left on the stack is the digital signature. The script is processed as follows:
   OP_FROMALTSTACK OP_CHECKSIG
This final element pulls the public key from the altstack and checks the signature was generated using the corresponding public key. This is the final confirmation that the user has validly signed the contract.

Control System/State Machine

As generally taught herein, assets can be tracked and/or managed using one or more blockchain transactions in which token-related outputs, representing tokens, function to determine the status of an asset. The status can, for example, indicate at least one of ownership, access rights to a secured asset, data, state, operation, configuration and value of an asset. Token transactions include a quantity of token-related cryptocurrency associated with the respective token, and during a token transaction the authentication of the cryptocurrency processed in the transaction is deterministically verified by the miner processing the transaction. The tokens described herein stem from an inaugural transaction, which can be a minting transaction, database establishment transaction or in a control system a device set-up record. Each token is linked e.g. managed by a device to be controlled, such that each token transaction has a deterministic relationship with the is inaugural transaction that creates the token and/or establishes its application and configuration. When the transactions output data, the linear transaction history can be referred to as a writechain, which is the relationship between the use of a token in two or more transactions. The inaugural transaction and/or the device set-up record can include a digitally signed certificate of an authority that will monitor the operation of the device. Overall, the authenticity of the status of the asset and its history can be determined through verification that the token is derived from an issuer responsible for the asset and/or an inaugural establishment transaction, which can be verified, for example, from the token's relationship with at least one of the Issuer-related output (I-UTXO) associated with the issuer of the token and/or output that created the token.

Examples above correspond to assets having static values, dynamic values and the authority to write data to establish a transactional record of data, such as information and/or instructions e.g. for a transactional database (including the sub-division of those assets). The status of an asset can be analogous the status of a machine. The machine can be a computational machine and/or a physical machine having real-world sensors and devices to manage a set of physical outcomes. For example, an asset whose status is determined by a token can be configured to operate according to a finite-state machine. The framework of the operation of an asset controlled by a token e.g. the asset, such as an electric motor controller, can be managed by its token and operate according to the status of its token. The framework can determine a linear mode of operation. The asset can be managed using a token and its transactions to deterministically operate according to a finite-state machine. Operation of the asset can be determined by a token transaction, wherein a token transaction can change the state of the token and, therefore, the status of the asset. The use of finite-state machines can automate the operation of assets such as devices systems incorporating devices.

Known control and monitoring systems that manage assets include programmable logic controllers (PLCs), which can be operated alone or networked together, and/or distributed control systems. In known systems one or more system management rooms or facilities are required and often require dedicated communication networks, such as network lines or 3G or 5G systems. Large scale control systems can include over 100 PLCs distributed over thousands of square kilometres. Not only is the supporting infrastructure complicated and expensive to run and manage but it can be inflexible and difficult to change, such that upgrades must be backwards compatible.

In contrast, tokens taught herein, and their associated token transactions, can be configured to utilise an existing cryptocurrency ledger, such as the BSV blockchain, to implement improved control and monitoring systems using tokens and/or transactional databases and their associated database management systems.

The tokens can utilise the underlying cryptocurrency as a substrate for managing an asset, thus addressing security problems, while operating a simple low-cost and computationally efficient system. The tokens are suited, by way of example, for implementing a Sequential Control and data Acquisition (SCADA) system, with distributed sub-systems or devices controlling one or more tokens that determine the state of the sub-system or device they manage.

Deterministic management of the status of an asset is implemented in the script of the token transaction. The script can determine how the device's state transitions are managed with each device having a pre-determined finite state machine within which it operates. Each state the device operates in will incorporate script that determines the required inputs needed to change the state, and the consequential output or change of state.

The tokens that manage each asset, such as a system, sub-system or device operate within a dedicated ledger analogous to those shown in FIG. 9 and FIG. 24. In this way the status of the tokens and their associated assets and/or data can be monitored within a specific sub-ledger i.e. the token-ledger of the cryptocurrency ledger on which it is based. Only transactions occurring on the token-ledger that are authorised and validated as being derived from the authority that determined the token-ledger and/or the inaugural transaction that includes a ‘device set-up record’ can modify the status of an asset. Said authority has knowledge of all of the tokens on their token-ledger such that tokens can be added, modified or removed accordingly.

The token-ledger and associated authority can maintain the security of the system, while the transactions on the cryptocurrency blockchain provide an indelible record of the token transactions and the history of the status of assets managed within the ledger. The token ledger can enable live data management.

A system operator can create a token for each sub-system or device within the system. A device or subsystem can include a controller for managing the token and its transactions. A device can operate an embedded system and contain a secure module holding a private key which the device uses to update its state within the control system ledger. Devices can include control elements such as motors, pumps, valves etc as well as sensors, transmitters or transducers used to manage outputs of the devices. Some devices can control multiple tokens, and some tokens can represent multiple devices in aggregate forming a sub-system. A sub-system may incorporate several of its own control and monitoring tokens, which together feed into the status of the sub-system token.

Input devices can function to provide the status of a parameter, such as a level indicator, an alarm state or reset condition. The input device can have a respective token and the status of the input device can be recorded in the output of a token transaction. Each input device can be configured having an ECDSA keypair for signing transactions for output control devices. The signatures output from the input device function as status indicators and as inputs to other devices e.g. actuators, such that its status can be used as a control signal. Each time the input device's input status is changed, the control system can spend the device's respective token into a new state. For analogue devices, this state can be represented within a payment channel, reducing the overhead of on-chain recording while maintaining the overall control system state in a record that is recognizable as cryptocurrency e.g. Bitcoin (BSV) script. Each input device can monitor its own parameters, status and signatures. It can determine on an instantaneous basis which key it should output according to the status of the parameter being monitored. The input device can respond to incoming status requests by providing the relevant signature indicative of that status. An input device can inspect the messages and/or respond directly without inspection and apply a signature using its currently active keypair. Output devices can function to modify the operation of a machine. The output device can have a respective token and the status of the output device can be recorded in the output of a token transaction. Output device token transactions determine an instantaneous representation of an output device's current control status.

Output tokens can be spent according to a state machine that holds information on the current state of the output device and determines its operation. The state machine can be a deterministic finite-state machine. The frequency at which the state of the output device is determined can occur in response to at least one of: in response to a signal received from an input device; in response to an internal sensor; and periodically e.g. once a second, wherein the output device prepares a new iteration of its token transaction. The token transaction can require a signature from an input device in the system in order to change the state of the device. If the signature(s) provided by the input device are able to spend the output into a new state, the output device state transitions.

The key-pair signatures sent by the input devices and/or their respective tokens can be fixed, or can be updated periodically e.g. a keychain arrangement can be implemented that allows new keys to be created for each state change event.

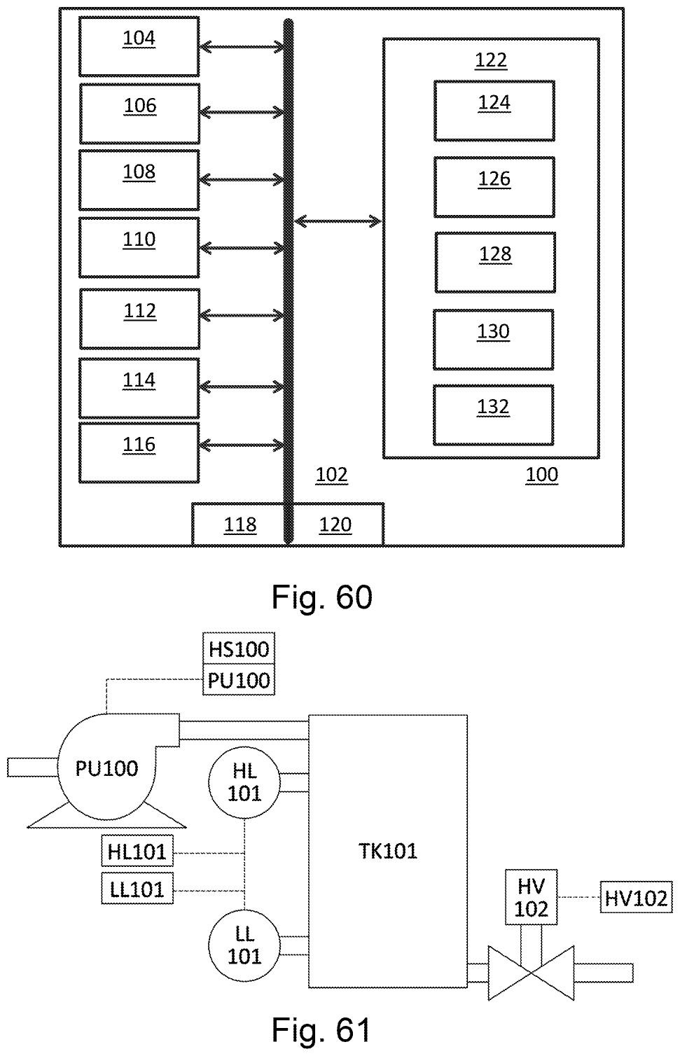

It is to be noted that input devices can operate with or without a token. When a token is not required the input device has a controller that is in communication with a corresponding output device, and respond to a status request e.g. a ping, with a digital signature indicating its status. The status of the input device is recorded on the input to the token transaction of the output device, which changes state accordingly. A control system having input and output devices can collate and record the status of the input and/or output devices on the transaction output of hanging tokens e.g. an administration or write token, such that a history of the input device's status is held in a transactional database. Different hanging tokens can be provided for input devices having different levels of activity or update frequency e.g. hanging tokens can be provided for input devices that update at least once per minute, at least once per hour and/or at least once per day. An example of a device having a controller and a control system is illustrated in FIG. 60. A device 100 can be scalable in size and across different locations to implement an aspect or method of the invention described herein. The device can also be representative of an input device such as a sensor or an output device such as an actuator. The device 100 includes a bus 102, at least one processor 104, at least one communication port 106, a main memory 108 and/or a removable storage media 110, a read only memory 112 and a random access memory 114. The components of device 100 can be configured across two (2) or more devices, or the components can reside in a single device 10. The device can also include a battery 116. The port 106 can be complimented by input means 118 and output connection 120. The processor 104 can be any such device such as (but not limited to) an Intel®, AMD® or ARM processor. The processor may be specifically dedicated to the device. The port 106 can be a wired connection, such as an RS-232 connection, or a Bluetooth connection or any such wireless connection. The port can be configured to communicate on a network such a Local Area Network (LAN), Wide Area Network (WAN), or any network to which the device 100 connects. The read only memory 112 can store instructions for the processor 104.

The bus 102 communicably couples the processor 104 with the other memory 110, 112, 114, 108 and port 106, as well as the input and output connections 118, 120. The bus can be a PCI/PCI-X or SCSI based system bus depending on the storage devices used, for example. Removable memory 110 can be any kind of external hard-drives, floppy drives, flash drives, for example. The device and components therein are provided by way of example and does not limit the scope of the invention. The processor 104 can implement the methods described herein. The processor 104 can be configured to retrieve and/or receive information from a remote server or other device.

The device 100 can also include an embedded system 122 and contain a secure module 124 having an associated private key. A key store 126 can hold the key-pairs assigned to the control signals of the system. A device can include a secure mechanism 128 for generating key-pairs for use in signing the UTXO of a token, and the secure mechanism can include a physical unclonable function (PUF). The operational history of the device can be held in a back-up store 128. A local copy 130 of the token transactions associated with the device ledger can be stored on the device. A separate data store 132 can hold at least one of the device identity, authority information, finite-state machine configurations and keypairs of the input devices.

An example of a controllable system having devices and respective tokens is shown in FIG. 61. In this example a tank TK101 can be filled with fluid from a pump control relay PU100 and emptied via a tank output control valve HV102, while a high-level sensor HL101 and a low-level sensor LL101 indicate the fluid level in the tank. The pump is additionally provided with a reset switch HS100. Each of the devices HS100, PU100, HL101, LL101 and HV102 have respective tokens. The signals, signal ID (said identification being the name of the respective token), signal type and description are shown in the Table 1 below together with an indication of the binary level signal output indicating the status of the device or parameter it is monitoring:

TABLE 1

| | SIGNAL | | |
|---|---|---|---|
| SIGNAL | ID | TYPE | DESCRIPTION |
| TANK LOW | LL101 | DIN | Tank low level signal |
| LEVEL | | | (1 = LOW, 0 = NORMAL) |
| TANK HIGH | HL101 | DIN | Tank high level signal |
| LEVEL | | | (1 = HIGH, 0 = NORMAL) |
| WATER PUMP | HS100 | DIN | Reset water pump fail alarm |
| RESET | | | (1 = RESET) |
| PUMP CONTROL | PU100 | DOUT | Pump run signal |
| RELAY | | | (1 = ON, 0 = OFF) |
| CONTROL | HV102 | DOUT | Valve control signal |
| VALVE | | | (1 = OPEN, 0 = CLOSE) |

The high-level sensor HL101, low-level sensor LL101 and reset switch HS100 are input devices, which function as sensors providing information to the system for controlling the output devices, which are the pump control relay PU100 and the control valve HV102. The operation of the system of FIG. 61 also includes alarms and timers, as shown in Table 2 and Table 3 below:

TABLE 2

| | SIGNAL | | |
|---|---|---|---|
| ALARM | ID | TYPE | DESCRIPTION |
| TANK LOW | TK101LL | ALERT | Tank low level alert |
| LEVEL ALERT | | | |
| PUMP FAIL | PU100AL | ALRM | Pump failure alarm |
| ALARM | | | |

TABLE 3

| | SIGNAL | | |
|---|---|---|---|
| TIMER | ID | TYPE | DESCRIPTION |
| VALVE RELEASE | TMR102 | TMR | Timer to manage valve |
| TIMER | | | opening |
| PUMP FAIL TIMER | TMR100 | TMR | Timer to trigger pump |
| | | | fail alarm |

In addition to the devices and respective tokens of the system shown in FIG. 61, input tokens are provided for each of the alarms, namely the tank low level alert TK101LL and pump fail alarm PU100AL, as well as the timers, namely the valve release timer TMR102 and the pump fail timer TMR100.

By way of example, the control system works on a 1 second cadence, and its operation can be described using the pseudocode below.

TMR102

| EACH TIME 10,000 Satoshis are received into TMR102 | |
|---|---|
| TMR102 = 10 // Set TMR102 to 10 seconds | |
| ENDIF | |
| IF TMR102 > 0 | // If timer running |
| TMR102-- | // Countdown |

### ENDIF

The status of TMR102 can, by way of example, can be conditional on a payment of cryptocurrency. Additionally or alternatively the valve release timer can be activated by the press of a button, or by a remote signal indicating that fluid is to be released e.g. to drive turbines in a hydroelectric power plant.

TMR100

| IF TK101LL == TRUE | // If TK101 Low Level |
|---|---|
| IF TMR100 == 0 | // And timer has expired |
| SET PU100AL | TRUE // Set PU100 Fail alarm |
| ELSE | |
| TMR100-- | // Timer counts down |

```
  ENDIF
ELSE
  TMR102 = 20 // Set TMR102 to 20 seconds
ENDIF
```

HS100

IF HS100 == TRUE // If Reset switch is ON
TMR102 = 20 // Set TMR102 to 20 seconds
ENDIF

TK101

```
The tank manages its own alarm state.
IF LL101 == TRUE // If low level is detected
  TK101LL = TRUE // Set tank low level alert
ELSE // otherwise
  TK101LL = FALSE // Reset tank low level alert
ENDIF
```

HV102

IF PU100AL == FALSE AND TMR102 > 0 // If no pump alarm and valve timer on

| | |
|---|---|
| HV102 = OPEN | // open valve |

ELSE

| | |
|---|---|
| HV102 = CLOSED | // else close |

ENDIF

PU100

```
IF LL101 == TRUE
  PU100 = ON
ENDIF
IF HL101 == TRUE
  PU100 = OFF
ENDIF
```

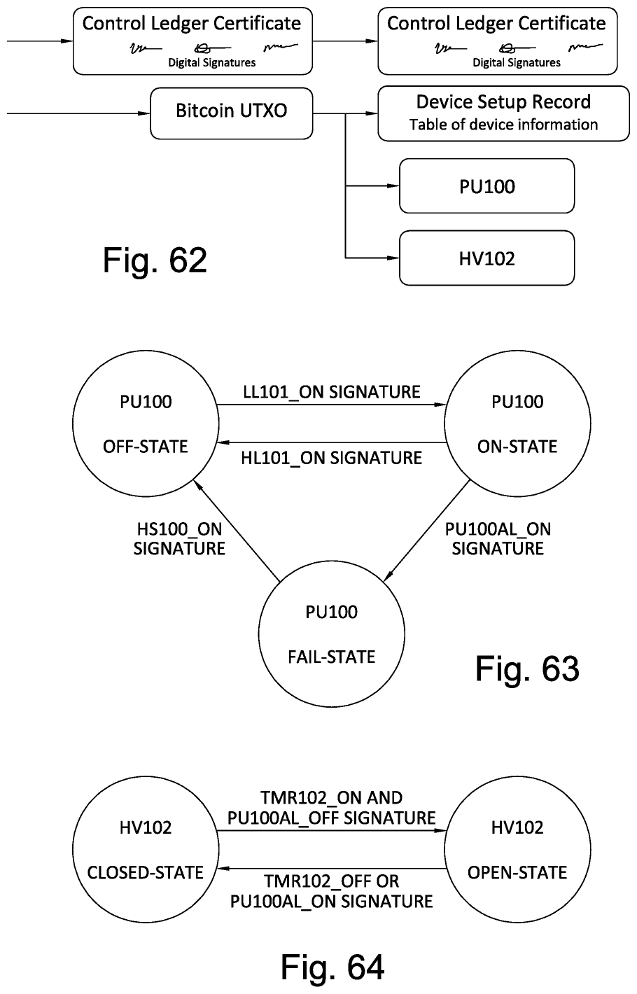

FIG. 62 illustrates a token transaction having in which the token for the pump control relay PU100 and control valve HV100 are minted. A digital signature representing a ‘Control Ledger Certificate’ is provided at the input, and output from the transaction, while an amount of cryptocurrency e.g. Bitcoin UTXO is also provided at the input. In a similar manner to the minting transaction and database establishment transaction above, the configuration and parameters under within which the tokens will operate are defined in a device set-up record together with the signatures indicating the authority under which the tokens were minted. In this example the device set-up record can include at least one of the keypair assignments and finite-state machines for pump control relay PU100 and control valve HV100.

The operation of the finite-state machines is determined by the token transaction output, which provides at least one of instructions, data and private key identification PKID. By way of example, the output can be implemented in script, such as Bitcoin Script. The script can determine, at least, the input signatures required to sign or spend the UTXO output from the token transaction. Not only can the script determine the status of the token and the associated with the asset that it is managing, but the script can include additional information, such as additional operational device parameters at the time the status was changed. Output devices operate according to the status of their respective tokens, and their status can be updated in a transaction every time it changed.

Input devices can have a set of keypairs and/or signals that indicate their status, and can be configured to create a token transaction with a signature and/or send a signature indicating their status. An output device, whose token requires a predetermined input signature to change state, can send a request to an input device, which will respond with a signature and/or determine the status of the input device's token. If an input device, such as a sensor, alarm or timer does not have a dedicated token then it can be configured with a controller that responds to a status query by sending a digital signature corresponding to its status, time or alarm state. A linear transaction history of changes to the state of an output device e.g. according to its finite-state machine can be recorded on the cryptocurrency blockchain as part of the change of state of the device, which is determined by the token of the output device. The change of state of the device from a first state requires specific input signatures to the token UTXO and the transaction output script that determines the state of the device and the signatures required to change to a second state.

The output device is configured to receive signatures, determine whether they correspond to the signals required to change state, compile a token transaction that determines the and configure the transaction output script according to the required signatures to at least one of the next states. Tokens can have a separate script for each potential state they can move to from their current state. Each time the status of a device changes its respective token(s) is spent into a new output.

Table 4, below, lists functional signals indicating the signals expected from the input devices together, the corresponding token and the keypair (PKID) identification that would be output from the token when its function was activated.

TABLE 4

| PKID | FUNCTION | TOKEN |
|---|---|---|
| LL101_ON | Signs when tank low level detected | LL101 |
| LL101_OFF | Signs when tank low level not detected | LL101 |
| HL101_ON | Signs when tank high level detected | HL101 |
| HL101_OFF | Signs when tank high level not detected | HL101 |
| HS100_ON | Signs when pump reset switch is pressed | HS100 |
| HS100_OFF | Signs when pump reset switch is not | HS100 |
| | pressed | |
| TK101LL_ON | Signs when TK101 Low Level is active | TK101LL |
| TK101LL_OFF | Signs when TK101 Low Level is inactive | TK101LL |
| PU100AL_ON | Signs when PU100 failure alarm is active | PU100 |
| PU100AL_OFF | Signs when PU100 failure alarm is | PU100 |
| | inactive | |
| TMR102_ON | Signs when TMR_102 is running | HV102 |
| TMR102_OFF | Signs when TMR_102 is not running | HV102 |

Each input device is configured to monitor its own data points, and determine on an instantaneous basis which key it should be using to sign incoming requests. The input devices can inspect the messages or simply apply a signature using their currently active keypair.

The finite-state machine for the output devices is shown in FIGS. 63 and 64 for the pump control relay PU100 and the control valve HV100, respectively.

The relay PU100 operates with three states:

an ‘OFF-STATE’, wherein the pump's token exists in a UTXO that contains the script “<LL101_ON> CHECKSIG”, and to be spent into the ON-State, the pump's controller must receive a signature for its UTXO from the LL101_ON public key, which LL101 will only provide if the tank low level signal LL101 is set to “1”, indicating that the level is LOW;

an ‘ON-STATE’, wherein the pump's token exists in a UTXO that contains the script “DUP <HL101_ON> CHECKSIG SWAP <PU100AL_ON> CHECKSIG OR”, and wherein the pump controller (i) requests a signature from the tank high level HL101 device and respective token, which spends the token back into the OFF-State script if the HL101_ON SIGNATURE is received, and (ii) requests a signature from the pump failure alarm PU101AL controller to spend the signature into the alarm state if the PU100AL_ON SIGNATURE is received, wherein the controllers of the respective input devices and/or tokens only provide a correct signature if their control state is in the necessary condition for the transition to occur; and

a ‘FAIL-STATE’, wherein in said state, the pump's token exists in a UTXO that contains the script “<HS100_ON> CHECKSIG”, and if the pump reset switch is pressed then the respective controller signs the input and the pump controller spends its token back into the OFF-State script.

The valve HV102 operates with two states:

a ‘CLOSED-STATE’, wherein the valve's token exists in a UTXO that contains the script “<TMR102_ON> CHECKSIGVERIFY PU100AL_OFF CHECKSIG” such that to be spent into the OPEN-STATE, the valve's state controller must receive a signature for its current UTXO from the TMR102_ON public key indicating that the timer's value is >0, and a signal from the PU100AL_OFF public key indicating that PU100 is not in FAIL state.

a ‘OPEN-STATE’, wherein the pump's token exists in a UTXO that contains the script “<TMR102_OFF> CHECKSIG SWAP PU100AL_OFF CHECKSIG OR”, such that to be spent into the CLOSED-STATE, the valve's state controller must receive a signature for its current UTXO from the TMR102_OFF public key indicating that the timer's has run down to zero, or a signal from the PU100AL_ON public key indicating that PU100 is in FAIL state.

The number of states of an asset, such as the devices in relay PU100 and valve HV102, can be two or more, but is unlimited. Through the output script from a device's token transaction, at least one of an event, physical event and characteristic change of the device can be determined. For input devices, the token transaction output includes a signature indicative of the at least one of an event, physical event and characteristic change of the input device. The input device can indicate and/or record its status in the form of an output signal, such as a digital signature and/or in the output of its corresponding token. For output devices, the token transaction output includes a signature indicative of the status of the device. The output device affects its status in the form of an action, such as a mechanical operation and/or in the output of its corresponding token.

The device can have a control system that can manage token transactions representing the status of the device and operate accordingly. A memory can hold key-pair signatures for signing the UTXO of another token to change the state of said device using the signatures. A device can include a secure mechanism for generating key-pairs for use in signing the UTXO of a token. The secure mechanism can include a physical unclonable function (PUF) for generating key-pairs. A secure mechanism e.g. PUF can be local to a device in the control system, preferably embedded within the controller such that it can only be seen by the device. A new key-air can be generated each time a device transitions into a new state.

Additionally or alternatively, a device can operate according to a status indicator held in a database. The status in the database can be determined according to a finite-state machine. However, the token transaction outputs can be recorded in the database and the finite-state machine operates according to a device set-up record and/or database establishment transaction that sets the conditions upon which the state of a device changes. The database can capture at least one of the operation, status and data that determines the configuration of the output device. The database can also record the events that provide the input signatures that spend a token transaction into another state.

### Nodes and Network Topology

In some examples, one, some or all of the following three elements may be combined to form a network arranged to implement the protocols and methods disclosed herein:
1. Trustholds
2. User wallets
3. Registers

Trustholds:

Trustholds are distributed threshold signature generators. They are networks of computers which provide users with threshold signature slices that can be combined to create an Elliptic Curve Digital Signature Algorithm (ECDSA) signature. User wallets have access to the network, for example via an Application Program Interface (API), and include a software module to manage signature recombination. A Trusthold's function, therefore, comprises relieving the user of the responsibility of key backup and management. They each validate the user's identity and provide signatures for their tokens. Users such as individuals, merchants, banks or other entities are able to cryptographically sign their transactions via a trusthold. Advantages of using a trusthold include the use of secure, distributed network, and a reduced risk of losing access to controlled resources.

Wallet:

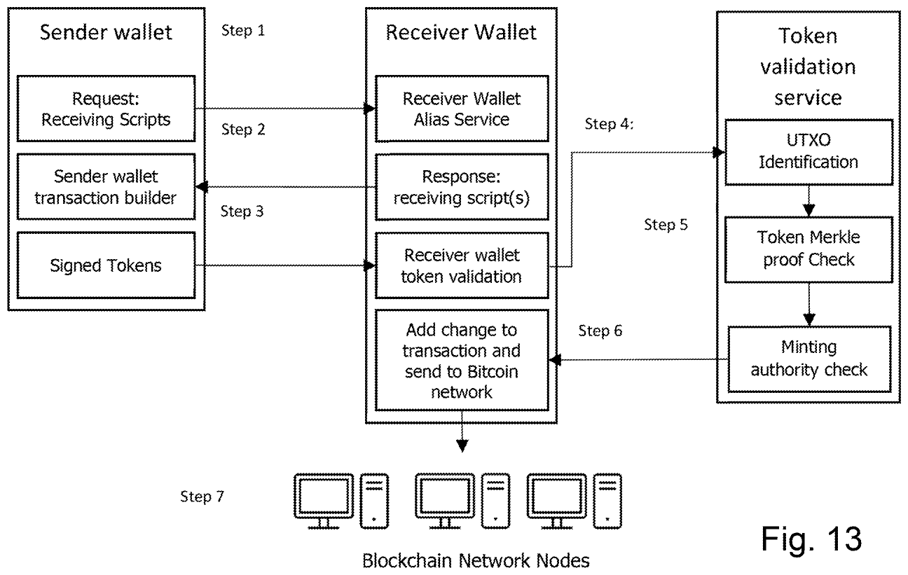

The wallet's main functions may include:
1. Tracking the public keys being used to receive tokens from senders and, where necessary, ensure that any relevant trustholds have knowledge of them.
2. Giving public keys to other authorised parties (e.g. Registers, collaborating or participating entities in a scheme or network) so that they can process tokens received from the wallet.
3. Monitoring an index of tokens held by the wallet and formed in accordance with the present disclosure, including various types and form of data relating to tokens and the UTXOs in which their control resides.
4. Where necessary, providing an interface between a user's trusthold network for the purposes of requesting and receiving signatures.
5. Communicating with other users to send and receive tokens, and send other data e.g. electronic data interchange (EDI).
6. Participating in collaborative transaction (Tx) and signature processes for creating and spending multi-signature tokens or threshold signature controlled tokens.
7. In some examples, searching for and processing data stored via an associated tree or graph in order to monitor data relating to a computer-implemented transfer or other process (e.g. details of tokens sent/received, any alias associated with one or more parties and other data such as, for example, EDI records). This is seen in FIG. 13.

Depending on how the tokens are to be used, a wallet user may request a trusthold sign message hash on demand. In other situations, the user can ask the trusthold(s) to pre-sign their tokens for spending. In examples where tokens are signed using ‘SIGHASH_ANYONECANPAY|SIGHASH_NONE’, this makes them easy, simple and efficient to transfer. These signed tokens can be held by the wallet to be handed to recipients. A recipient can store a pre-signed token and send it back to a receiver (e.g. a bank) for exchange with other tokens held within a pool or set of other minted tokens.

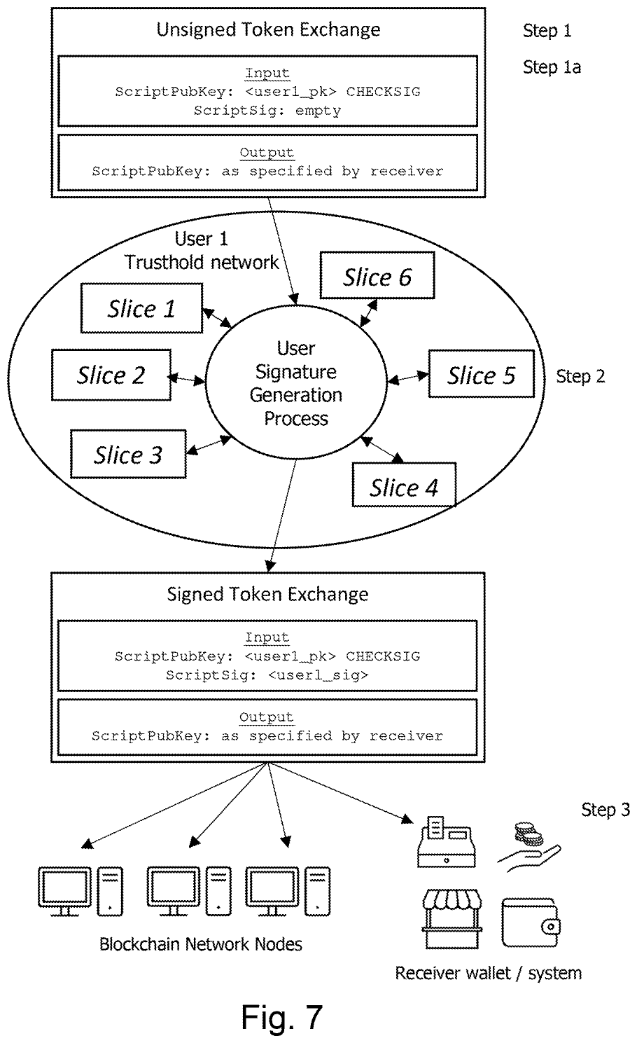

FIG. 7 illustrates an example using a wallet to conduct a token transfer. With reference to FIG. 7:

Step 1: User 1 receives a token value transfer request and selects one or more Token UTXOs they control to a value equal or greater than the requested amount. In this example, User 1 may receive information regarding the receiver's identity, a receiving script/scripts generated by the receiver, or both.

Step 1a: Where User 1 has not been passed receiving scripts their wallet or a money handling service they subscribe to conducts alias lookups to discover the receiving scripts to send the funds to. If the user does not have exact change, this process can include a negotiation to receive change from the receiving party or an API connection to a change providing service.

Step 2: Once User 1 has correct change, their wallet sends a signature request for each token selected in Step 1 to nodes in their trusthold network who create ‘signature slices’ needed for User 1's wallet to build USER1sig for each selected token's ScriptSig. In this example signatures can be signed using SIGHASH_ALL if the transaction is being handed directly to the receiver, or can use SIGHASH_SINGLE|SIGHASH_ANYONECANPAY if the transaction is being spent into a Group Transaction via a payment processor.

Step 3: Each of the fully signed tokens is passed to the receiver at the same time as they are broadcast to nodes on the blockchain network, completing the transfer.

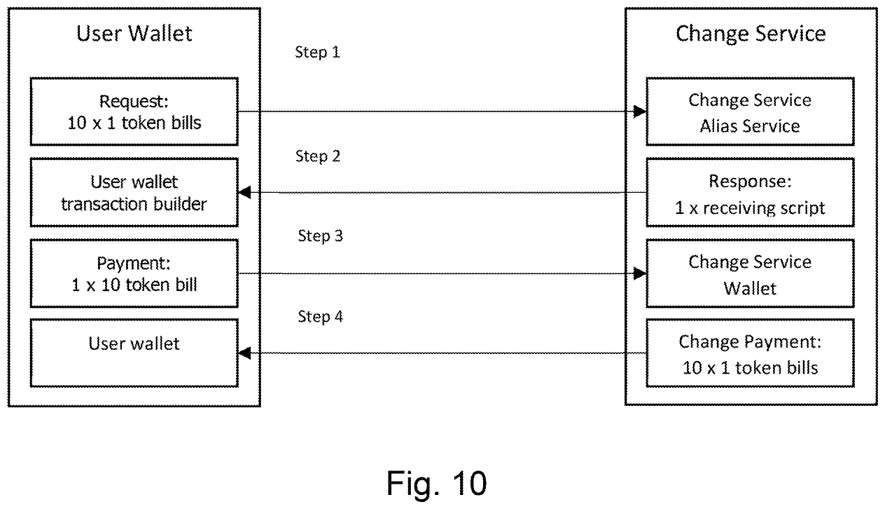

FIG. 10 illustrates an example of a change service as mentioned in step 1a above. With reference to FIG. 10:

Step 1: a user wallet connects to a change server API to define transaction requirements and request receiving script.

Step 2: The change service responds with receiving script/scripts.

Step 3: The user sends signed tokens to the change service wallet.

Step 4: The change service sends change back to the user's wallet.

FIG. 13 also shows a wallet in use in accordance with an example. With reference to FIG. 13:

Step 1: A Sender's wallet connects to a Receiver's wallet alias lookup/provision service to request a receiving script for a token delivery.

Step 2: The Receiver wallet's alias service responds with receiving script/scripts.

Step 3: The Sender signs and sends tokens to receiver wallet.

Step 4: The Receiver sends the token UTXO details to a validation service.

Step 5: The validation service performs a Merkle proof lookup, tracing the linear transaction history back to the back to token's minting transaction.

Step 6: The validation service validates the token's authenticity using the Minting authority provided via the MTx.

Step 7: If needed, the receiver makes an alias request to the Sender's wallet for receiving scripts to send tokens from its own wallet to provide change. These are applied to the transfer transaction before it is sent to nodes on the Bitcoin network to be processed.

Additionally or alternatively the receiving wallet may perform the token validation.

Registers:

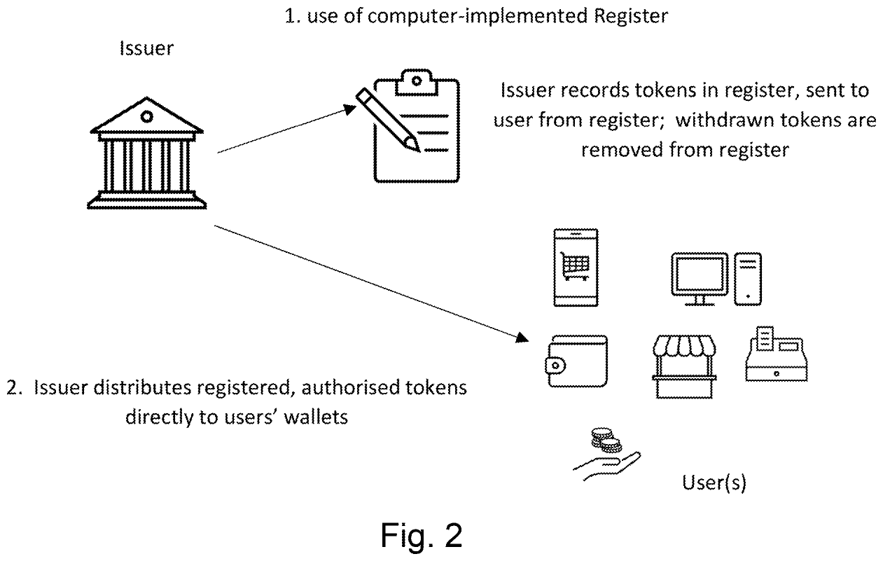

As shown in FIGS. 2, 3, 6 and 15, certain (but not all) examples may utilise a system component which we will refer to for convenience as a “register”. A register may be a computer-implemented resource which comprises a wallet arranged to process tokens that are minted and used in accordance with the present disclosure. The register may be a fully automated system component. The use or otherwise of a Register will be dictated by the requirements of a particular use case and its implementation.

FIG. 2 shows illustrative example(s) of the disclosure in which:

1. Token(s) for at least a required overall token amount or value are sent from a sender to a Register, and then tokens for at least the required overall amount are sent onwards from the register to a receiver; if tokens for more than the required overall amount are transferred, change is provided to the sender from the register or the receiver; performing the exchange via the register enables a record of the transaction plus the transfer of ownership/control of the incoming and outgoing bills to be included in the Register.
2. Tokens(s) for at least the required token amount are sent directly to the receiver without going via a register; if tokens for more than the required overall amount are sent, change is provided to the sender from the receiver or some other party.

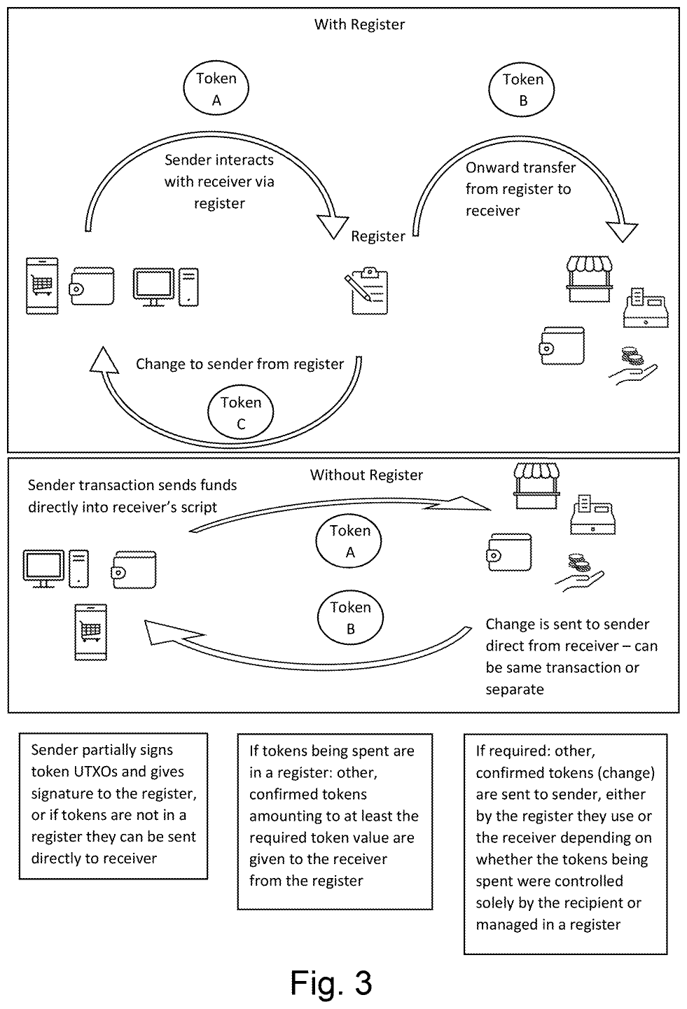

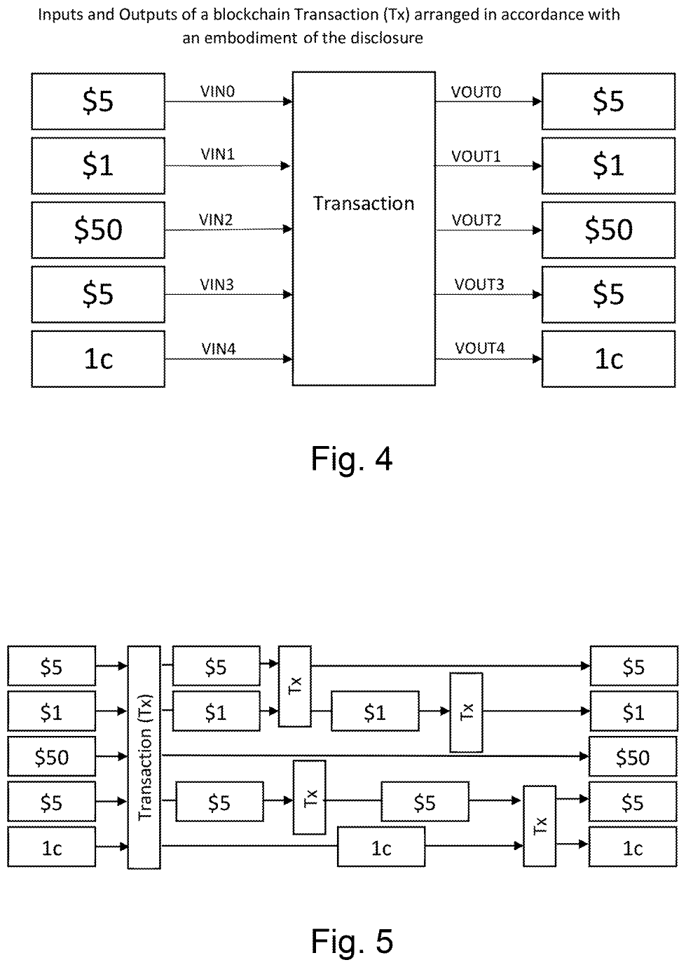

FIG. 3 also show two possible examples. In the first, an issuing entity creates and maintains a register of tokens. Each token that is issued is written to the register so that for each token that is put into circulation there may be a record comprising (at least) an identifier/serial number which uniquely identifies the respective token, and the token value associated with that token. If a token is withdrawn from circulation for some reason, it can be removed from the register using a melting action as illustrated in FIG. 18. A user which receives a token from the register may then transfer tokens to other users via the register or directly from user to user without going via the register.

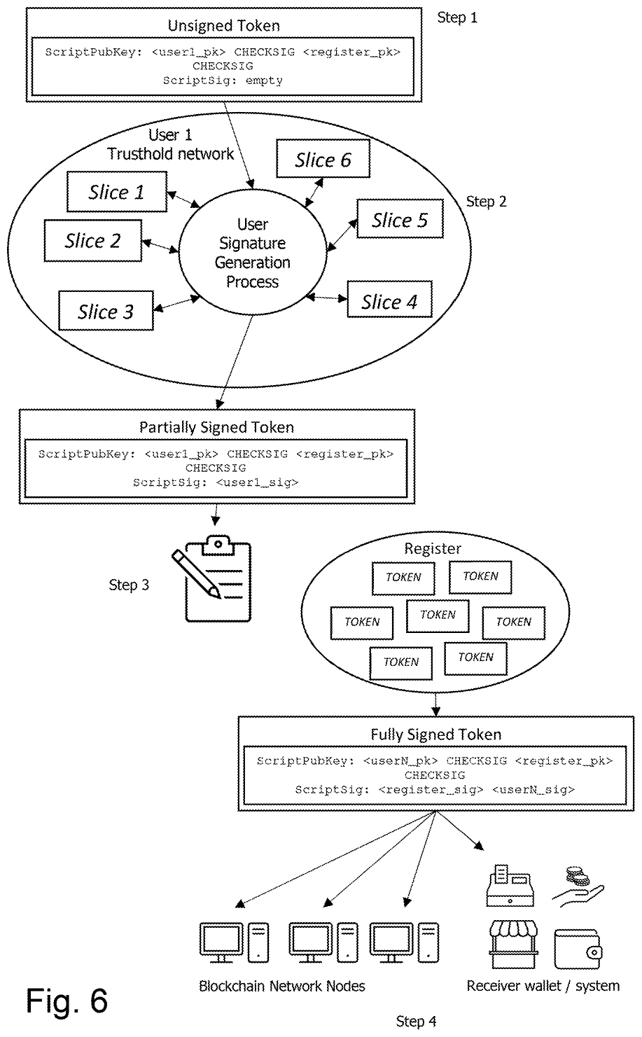

With reference to FIG. 6:

Step 1: User 1 receives a token value transfer request and selects one or more Token UTXOs they control to a value equal to or greater than the requested amount. In this example, User 1 may receive information regarding the receiver's identity, a receiving script/scripts generated by the receiver, or both.

Step 2: User 1 sends a signature request for each token selected in Step 1 to nodes in their trusthold network who create ‘signature slices’ needed for User 1's wallet to build USER1sig in each selected token's ScriptSig using SIGHASH_NONE|SIGHASH_ANYONECANPAY.

Step 3: User 1's register operator receives the partially signed token or tokens into their register and receives the details of the value transfer which can include receiver identity or identities, receiving scripts and transfer amount. If scripts have not been supplied, the register operator conducts alias lookups to discover receiving scripts on behalf of the user.

Step 4: The register operator selects appropriate tokens to make the full payment and any change payment from the partially signed tokens it has received for other transactions it holds in its register. It completes the signature process by signing each using SIGHASH_ANYONECANPAY|SIGHASH_SINGLE and adds the signed outputs to a group transaction. The receiving script can represent any type of wallet used in the token ecosystem without restriction.

Possible examples which make use of a register are also provided in FIG. 15. In FIG. 15, User 1 signs tokens 1, 2 and 3 for transfer to User 2. User 1 signs tokens held in a multi-signature account, co-signed by the register, allowing the register to transfer them forwards into transactions to other receivers. User 3 is also shown signing tokens 4, 5 and 6 for transfer to the register. The Register creates outputs to a group transaction using other pre-signed tokens that it holds in its pool to complete transfers to users 2 and 4 in a single on-chain action.

Although examples of the present disclosure can be implemented without the use of a register, there are technical advantages which flow from such an arrangement where an implementation lends itself to the use of a register. Although the title of the Satoshi Nakamoto whitepaper referred to a “peer-to-peer electronic cash system”, cryptocurrencies still face numerous technical challenges regarding adoption and implementation. One of these challenges is that the wallets used to control a party's coins typically use a seed for back-up and recovery purposes. The seed is typically a more user-friendly mnemonic such as a phrase or group of words that are associated with an address or series of addresses that enable the wallet to be replenished. However, this requires a wallet owner to memorise or somehow record the seed. There are numerous known instances in which the seed has been lost or forgotten, leading to non-recoverable loss of the wallet contents. Moreover, the use of a seed prevents or at least hinders certain custodial applications of cryptocurrencies.

In addition to the “Seed Word” problem, wallets face the challenge of how to manage unspent transaction outputs (UTXOs) and any required change. In Bitcoin, coins are received into a wallet as UTXOs. Typically, the wallet will combine more than one unspent coins (received via >=1 inputs) to create one or more outputs. As the combined UTXO coins often amount to more than the required payment amount, the remaining change is sent back to the payer's digital wallet. This is analogous to the use of fiat cash, in which a buyer hands over ten dollars for payment of a $9.50 transaction. It may be that the $10 is provided as two $5 bills, a $10 bill, or a $5 bill plus 5 lots of $1 bills. In any event, the 50¢ change is handed back.

In the digital cash paradigm, this gives rise to technical challenges including:

1) the wallet needs to manage its UTXO set; this set can become complex which in turn may result in security risks for both users and developers.
2) security can be compromised as it is often easier to identify ownership of coins through their transaction history; if coins can be traced to a source via a wallet, attacks may be more successful.

Thus, examples of the disclosure provide mechanisms for exchanging assets (e.g. cryptocurrencies, tokens, data etc) via a blockchain network which solve at least these technical challenges, including enhanced privacy and security for blockchain-enabled digital wallets.

Dynamic tokens allow a wallet to reduce the complexity of UTXO management by allowing for any token quantity to be spent into a transaction without needing to find static tokens in the necessary denominations to make exact change. The addition of a dynamic token or tokens to the transaction can allow the parties to pay an exact change amount without handling large numbers of small value tokens. When needed, static and dynamic tokens can be issued which represent fungible units such that a static token holding 1000 units with 1 satoshi would be fully fungible with a dynamic token holding 1000 satoshis each worth 1 unit. Much like coins and bank notes, the user can choose which they prefer to carry and use for their own optimised user experience.

A single-user can own many dynamic tokens, and can choose at any time to apply any single-use dynamic token they control to any of their dynamic tokens. They can also mix their dynamic tokens with other dynamic tokens to affect a coin mixing process for enhanced privacy.

Serial Numbers

In accordance with one (but not every) example, newly minted tokens may be assigned to or associated with a unique identifier. This may be performed via the Minting Transaction. This may be any type of identifier which can be used to refer to the token and distinguish it from other tokens that may be minted by the Issuer. We will refer to it as a “serial number” for convenience. A serial number can be embedded in the output script (scriptSig) of the T-UTXO of a given token in the Minting Transaction. The serial number can then be carried forward with the token as it enters into circulation within the network or merely referenced from the minting or issuance transaction.

In one or more other examples, though, serial numbers may be a hash of the TX used to create the tokens e.g. the TX combined with the Vout indices used to create the tokens. However, this is less favourable because of a reduced level of control. A particular example might process the transaction identifier (TXID) through a hashing function to create a unique identifier for the first output, and process the unique identifier for the first output through the same hashing function to generate a second unique identifier for the second output and so on. In this implementation, the issuer is unable to determine the serial number of an issued token prior to the issuance action and the identifier is not recorded onto the blockchain as part of the minting record.

As the tokens or token units can be spent into and out of the same index in any transaction they are used in, the tracing of the token or token unit back to the creation event can be done easily by tracking the usage of the token or token unit back through the token's transaction graph. In some examples, it may be desirable to periodically mark, flag or identify tokens or token units with their serial number to make verification and tracking more efficient.

Serial numbers may be used to track or link the provenance of the tokens or token units to the issuer and to index user transactions in a user's database/register. In one or more examples, a Group transaction may spend all fully signed output tokens into new scripts assigning them to new owners. This can enable dynamic re-assignment of tokens up until a time specified in a time lock mechanism. It is also possible to withhold the outgoing tokens at a wallet's discretion.

### EXAMPLE USE CASES

Further examples are provided as illustration of a small sample of the applications in which examples of the disclosure may be implemented. Many other applications and uses can, of course, be devised.

### Use Case Example 1: Prescriptions

Suppose a patient visits a medical practice because of back pain. The medical practice has implemented a system which utilises tokens in accordance with the present disclosure. The medical practice owns some Bitcoin and uses it to generate a minting transaction that issues a set of tokens as described above. These tokens can be used to present pharmaceutical prescriptions. Each doctor within the medical practice has a digital wallet which controls a private key that can sign the unlocking scripts of the pharmacy's token T-UTXOs so as to authorise the transfer of tokens to a patient. The digital wallet is arranged to implement the protocol disclosed herein, so can accept, verify, transfer and process tokens as described above. The patient also has installed a digital wallet that can receive, send and process the practice's tokens in accordance with the protocol.

After examining the patient, the doctor decides to prescribe some medication so she uses her wallet to generate a blockchain transaction which has a UTXO that comprises a locking script which can only be unlocked using a key controlled by the patient's wallet and also a key controlled by an authorised pharmacy. The doctor inserts a token comprising of patient and prescription data into the UTXO's script. The data can be encrypted. The token is then transferred from the doctor's wallet to the patient's wallet by spending the UTXO to an address owned by the patient's wallet.

When the customer arrives at the pharmacy, he presents the token he received from the doctor. The token must first be signed by the patient's own wallet and is then passed to the pharmacy's wallet for the pharmacist's authorisation. The pharmacist must be able to check that the prescription token is genuine and has not been forged. Therefore, the pharmacist's wallet traces the Token's transaction history on the blockchain to identify the minting transaction and checks the issuance data to verify the token. If verification is successful, redemption of the token can proceed. If not, the pharmacist declines to dispense the medication.

According to one example, to create the second signature needed to redeem the prescription, the pharmacy wallet acts as its own trusthold and communicates with a network of pharmacies who each use their private cryptographic keys to sign the token. This gives the pharmacy network the ability to monitor prescriptions across groups of pharmacies to identify fraudulent activities. In this way, an improved monitoring and control solution is provided. In other examples, redemption may require the patient's signature, the pharmacist's signature and the medical practice's signature. Other variations are also possible depending on the requirements of the use case.

The example above lends itself to single prescriptions, in which a static token represents a single prescription item. If the patient suffers from a chronic condition requiring a repeat prescription, the doctor medical practice can implement a system which utilises static, dynamic, single-use and second-order tokens in accordance with the present disclosure—the medical practice owns Bitcoin and can generate a minting transaction that issues a set of static and/or dynamic tokens, and configure the dynamic tokens with permission to generate single-use and second-order tokens as described above.

As an alternative to issuing a static token for obtaining a pharmaceutical prescription, example scenarios are envisioned.

1. Each doctor within the medical practice has a digital wallet which controls a private key that can sign the unlocking scripts of the pharmacy's token T-UTXOs so as to authorise the transfer of token units to a patient's dynamic token. The patient receives token units into their dynamic token within their digital wallet in a similar way to the static token, as before. After examining the patient, the doctor can decide to prescribe some medication over a period of time e.g. bandages and ointment for treating a wound over a period of 3 months. The doctor transfers enough token units for 3 months' worth of medication. As an alternative to a static token, the patient can use the token units to obtain medication from a pharmacists in exchange for token units until the token units are exhausted.

2. Each doctor within the medical practice has a digital wallet which controls a private key that can sign the unlocking scripts of the pharmacy's token T-UTXOs so as to authorise the transfer single-use tokens, from their dynamic token to a patient's wallet. After examining the patient, the doctor can decide to prescribe some medication over a period of time e.g. an emollient for dry skin over a period of 12 months. The doctor creates, accordingly, 12 single-use tokens, and spends them to the patient's wallet, each single-use token exchangeable for enough emollient for 1 month from a pharmacist.

3. Each doctor within the medical practice has a digital wallet which controls a private key that can sign the unlocking scripts of the pharmacy's token T-UTXOs so as to authorise the transfer second-order tokens, from their dynamic token to a patient's wallet. A patient suffering from ongoing high blood pressure can be prescribed medication over a period of time e.g. statins over a period of 12 months. The doctor creates, accordingly, 12 second-order tokens, and spends them to the patient's wallet. In contrast to the single-use tokens, the second-order tokens are generated with script that restricts when they can be exchanged for 1-month's supply of statins.

### Use Case Example 2: Game Tokens

Suppose that a gaming engine mints dynamic Tokens for game-related items. As an item is used in the process of playing the game, the dynamic token associated with the item can accumulate status points in the form of satoshis. In such an example a token system can be created which allows the game creator to deposit single-use tokens within the game for a user to acquire and absorb into the dynamic token of the item, such that the increase in satoshis value functions as a ‘powerup’ and can enhance item properties such as ‘damage’, ‘range’, etc. When the single-use token satoshis are absorbed by the dynamic token that represents the item, the addition of the new properties can be traced deterministically allowing for items to develop unique characteristics over time.

The dynamic token of an item that holds satoshis representing particular properties. These properties can be acquired or accumulated, or could be removed, disposed of, sold or traded. In this way different elements of a user's game can be tracked as a set of dynamic tokens. Each token holds the history of a user's gameplay elements (e.g. characters, items) with the properties of each item being a function of the satoshis held in the token(s). To remove a property, the dynamic token creates a single-use dynamic token which references the transaction where the property was added allowing anyone to see what it represents. It would be possible that an item's property can represent different things to a different type of item, so a satoshi carrying a particular material property might enhance particular item types or group in different ways.

Thus, in-game items can be issued by the game's creators as a sellable token which can be traded for cash or other in-game currency but where the traded item's ownership and usage history is tracked in a token ledger. As the item is used, each interaction with the environment can cause damage or add experience to the item's history, eventually leading to alteration of the item's functionality or usage over time. Such items could be customised by their owners, and retain their unique properties when they are exchanged.

Further possibilities include the tokenisation of in-game reward systems or the creation of usable currency for an in-game environment. Both static and dynamic tokens are suitable for in-game payments and rewards. In a particular example, the game controller can issue second-order tokens from their dynamic token, said second-order tokens redeemable in their own right, in the same way as single-use tokens. However, said second-order tokens can be created with additional script such that when a predetermined number of second-order tokens are collected by a player additional access is enabled in the game e.g. the player is able to level-up, access a hidden level or unlock an item for use in the game.

Further still, examples may allow for game developers to collaborate to allow items to be used by players in multiple games or to be carried forward into game sequels, allowing game items to accumulate status over many years and platform iterations.

### Example Use Case 3: Physical Tokens

FIG. 17 illustrates a process by which a digital token with a unique identifier e.g. serial number and token value can be locked into a script controlled by an issuer who can then create physical representations of the digital tokens. These can be verifiably linked to the digital token, and then destroyed by depositing them back into a register controlled by or associated with the issuer and removing the digital token from the locking script. With reference to FIG. 17:

Step 1: Tokens are spent into a locking script that requires a knowledge proof provably linked to the issuer.

Step 2: Physical tokens are created that represent the digital tokens being used, and contain details including the token value, serial number and the details of the UTXO the digital token is currently held in on the ledger.

Step 3: Physical tokens can be exchanged between trading parties. Receivers validate the provenance of the token by checking that the digital token is locked in the transaction output shown on the physical token. Checking may be done via PC, point of sale device, or using a smartphone or tablet application. When the physical token is deposited, information it contains is used to build a transaction that moves the digital tokens, triggering a process in which the physical token is destroyed.

By way of example, a transport company can mint a dynamic token, and from that dynamic token print a batch of ten single-use tokens that function as tickets, each ticket redeemable for a single journey. When redeemed value of the token units within the ticket are spent into a payment channel of the transport company and can be absorbed into their dynamic token or recycled. In this way the token units are transferred back to the transport company. Such an example is suited for a wide range of possible use cases and applications. Once of these is provided as follow with regard to voting/selection processes.

### Example Use Case 4: Voting Systems

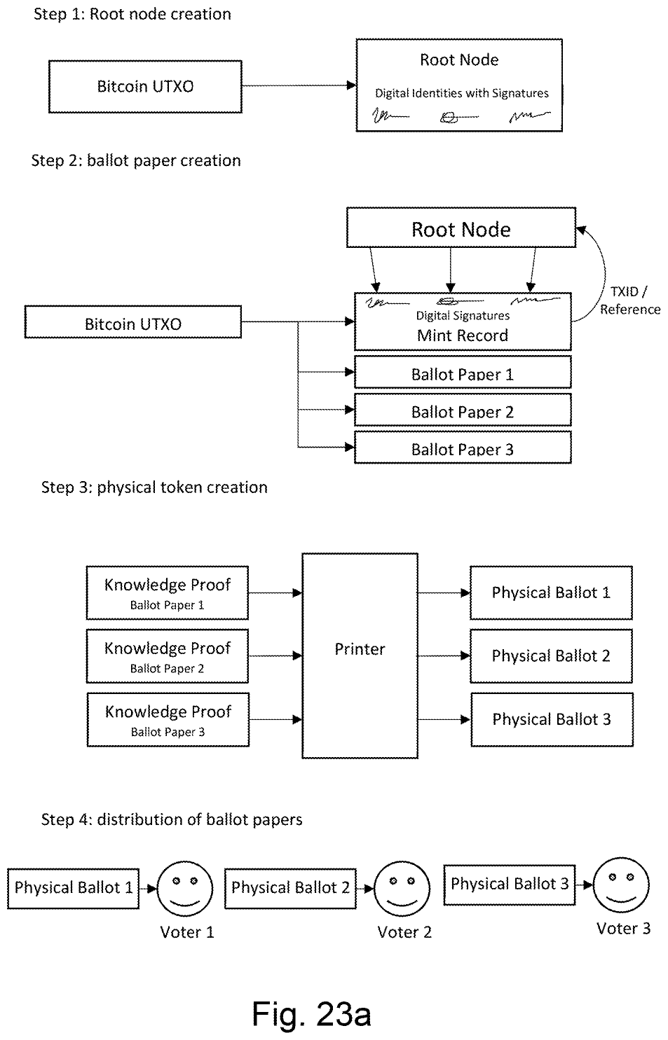

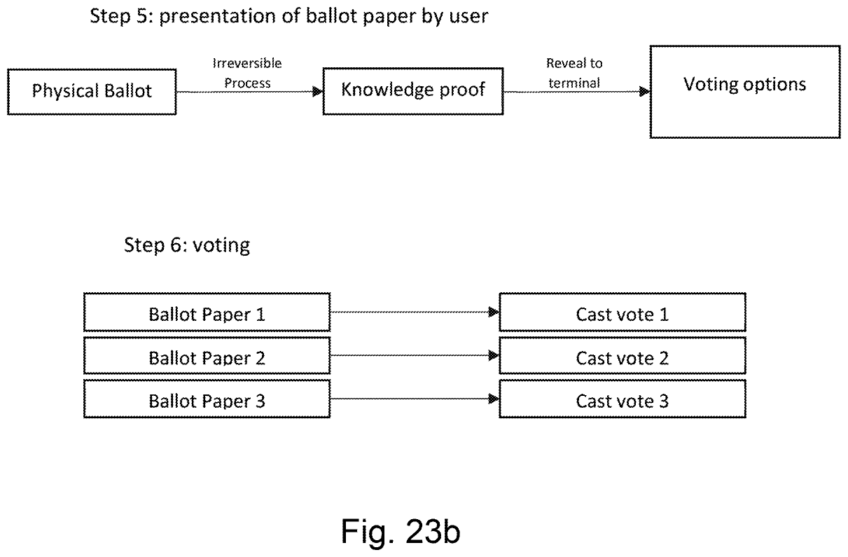

Example 4 is described with reference to FIGS. 23a and 23b. In this illustrative use case, certain examples can be arranged such that the tokens can be used to implement choice-making functions (which we will call “ballot papers” for ease of reference) in a selection process. This may be referred to as a “voting” system as known in the technical field, which should not be construed or mistaken as meaning purely political in nature. The term “voting” is used herein to refer to a process by which a choice or selection can be made and recorded. However, for the following example we will use an election process as this is readily understandable due to familiarity.

For example, consider a scenario in which an electoral commission establishes a Token Ledger in accordance with the disclosure for the purposes of conducting an election. Once the token ledger is established, the commission mints enough tokens to cover the voting process in each electorate, allowing for an extra quantity (e.g., 10%). Each token represents a ballot paper. Each ballot paper is then reproduced as a physical token containing a unique code which can be used to spend the digital token as part of a voting action. When voters arrive at the polling station their identity is processed through the normal means, in a way that is disconnected from the tokenized ballot paper. Once their identity and right to vote has been independently established, a physical ballot paper token is transferred to the voter. This could be, for example, a piece of paper with a bar code on it, or a plastic token or smart card with a chip or tag provided in or on it. A physical token can be picked at random from a pool of tokens provided to the polling station staff. In this way, the voter's identity is not known or attached to the physical token in any way, but the voter is now in possession of a token that represents their right to vote in the election.

The voter then presents themselves at a booth where a computer interface (e.g., touchscreen display) is provided and provides the terminal with the unique code provided by their physical token. The computer checks that the code represents an unspent ballot paper and presents the user with a voting process in accordance with the local rules of the electorate. This could be by being shown on-screen or could include other communication means e.g., audio means for use by blind users.

A further example may provide the user with a printed record of their vote to place into a ballot box as a backup to the electronic process, and a further example may use the unique physical token as the print media. Once the user's vote is concluded, the computer interface spends the ballot paper into a group transaction which is held in a time-locked payment channel that closes when the ballot is finished. If the user retains a record of their unique ballot paper, they can verify that their vote was correctly recorded once the transaction is finalized.

This process is illustrated in FIGS. 23a and 23b which comprises the following steps:

1. The issuer creates a Root Node to establish the token ledger that records the election's votes and outcome
2. The issuer uses the authority from the root node to generate enough ballot papers for the election process to take place using a minting transaction
3. A knowledge proof needed to spend each ballot paper is produced as a physical token with a secure device that a voter must break into through an irreversible process in order to reveal (e.g., tearable perforated sheet/scratch panel)
4. Ballot papers are randomized and delivered to voting locations where they are distributed to voters who have presented adequate identification to participate in the election process.
5. Voters reveal their ballot paper's knowledge proof by conducting the irreversible process needed to access it and present the information to a secure voting terminal. The terminal checks that the knowledge proof represents a valid token and presents the voter with a set of guided voting options.
6. The voter goes through the voting process using the secure terminal and once finished, indicates through an action that they have completed selecting their options. The terminal generates a new UTXO which it uses to transcribe the voter's selection and uses the knowledge proof to sign the digital ballot paper using SIGHASH_SINGLE|SIGHASH_ANYONECANPAY. At the end of the voting process, the signed ballot papers are all spent together in one transaction to finalize the voting process. A user who retains access to their ballot paper can easily check that their vote was recorded correctly. Alternatively, the ballot papers can obfuscate the input.

### Example Use Case 5: State Machines

In one example of the disclosure, a token can be created that is intended to pass through a state machine with a linear processing framework. In this way, a token can be created, and pass through numerous transfer operations, changing state each time. Some tokens may be processed back into standard blockchain UTXOs at the finalization of a state transition. In this way, the disclosure can be used to implement deterministic finite acceptors (DFAs) and automated systems which can be used in a wide range of scenarios and for many different purposes.

For example, consider a scenario in which a user purchases an airline ticket on a particular flight. The first state is a ticket booking which includes data such as flight and date. Prior to the flight, the user may change the booking which would involve a transition into a different booking state. The user may also add other services such as meals and a specific seat selection to their booking, each of which modifies the state of the ticket. When the user checks into their flight, they are assigned their final seating and the ticket changes state into a boarding pass. If the flight is cancelled, the ticket's state may be changed back into a booking. Once the passenger has arrived at their destination, all of the underlying cryptocurrency that held the tickets that were used by all of the passengers on that flight can be processed back into a Bitcoin UTXO which the airline can then recycle into new tickets.

### Example Use Case 6: Data Consumption Plan

In one example an internet data service provider mints a dynamic token for issue to a user of their service, who will use the provider to gain internet access. The dynamic token can be for a mobile connectivity plan for a data device from the provider. The device user buys a plan which carries a credit measured in satoshis/megabyte, and the provider pays 1000 satoshis into the user's dynamic token to indicate that their account may use 1000 Megabytes of credit.

The user's mobile phone service is tracked in a payment channel which is closed at midnight every day. If the user's credit runs out or expires, they can purchase additional credit to be applied to their dynamic token. Each time the user consumes data e.g. completes a call/message/session, the channel is updated to a new state. Throughout the day the channel state tracks the user's usage and decrements the user's credit from their dynamic token. Each time a whole megabyte of traffic is transferred, the payment channel transfers one satoshi into a single-use token.

By way of a specific example,
At Midnight, the channel is cleared, and the balance reset to zero.
At midnight, the user's wallet contains 459 MB of credit.
By 10 am the user has made a 45 second call and consumes 3.4 MB of data. The channel updates the user's balance to 455 MB.
At 11:30 am the user downloads 153 MB leaving the balance at 302 MB.
At 4 pm, the user sends a picture and consumes 5 MB, leaving the cumulative total at 297 MB.
At Midnight, the user's wallet automatically signs the single-use token containing the whole amount consumed and the payment channel is refreshed.
At 3 am, the phone company's own dynamic token spends all of single-use tokens into a company balance to be handed out as users purchase more credit.

### Example Use Case 7: Message Tokens

In one example, a single-use token can be configured with data, such as a message, that can be unlocked when the value of token units therein is absorbed in to a further dynamic token, and the data is read.

In one example, the single-use token is a zero-satoshi token (zsT) that functions as a message token (mT), which can be passed to each participant in a transaction (e.g. using a writer token). These messages would be unspendable outputs and hold data.

In one example, the data attached to a zero-satoshi token confers additional rights upon any other tokens held within a particular script.

The issuer is always watching the ledger and can see when tokens are destroyed. This service would allow the issuer to send targeted messages to participants in destructive transactions without needing to know their identities and would work via the wallet that manages the wallet's tokens, which would know the protocol for these messages.

The single-use token provides a messaging function, which can be sent to any script used by any token in a wallet to pass a message about a token which has been invalidated.

In another example, message tokens can be used to send messages to people.

In another example of message tokens, they can enable a message to be sent to a set of token outputs which have been incorrectly spent resulting in an invalidation process taking place. If the sub-ledger permits, then these tokens can be frozen or confiscated before being re-issued.

### Example Use Case 8: Dynamic Identity Token (Works with Key-Slices)

In one example, a dynamic token can be minted with an associated identity and can be referred to as an identity token (iT). An identity token can be minted for a machine or a person. The identity token can hold information about the machine or the person, such as service history of a machine or a change of name of a person.

Using a person as a more detailed example, the identity token can be configured to hold a set of information about said person. For example, the identity token can hold information associated with a driver's license or a passport. The identity token could hold all, or a subset, of the information provided in such a third-party document.

After obtaining an identity token, a person can have their identity at least one of inspected, approved or updated—and the details of this record, inspection and/or revision can be held within the identity token. Details associated with a person held in an identity token can be held in whole and/or in-part.

In one example, after an identity token is established, the details of any of an inspection, approval or update can be split into multiple elements. These elements are then shown to devices in a distributed network. By way of example, an update to an address can be divided in to 7 pieces, with each piece of information distributed to separate devices. Each of the 7 pieces have been signed off as true by an appropriate authority and held by devices in a network. The 7 pieces could, for example, be timestamped with a new passport number, and include: passport number; first name; last name; date of birth; house number; street name; and postcode.

The dynamic identity token can be updated, for example periodically, with a verified new photograph of the same person, the hash of which can be stored on-chain. It follows that when a person presents themselves for identification, for example in an airport, they present their wallet which returns a signed message from a set of distributed networks of devices.

The devices that are contacted by the wallet containing the identity token each sign a key-slice in a threshold signature with a message validating its knowledge of the information. In one example, when a user is asked to validate that their age is over 18 their wallet displays their photo to the person checking their details, either directly or via a separate display, and the network of devices that have been shown the person's date of birth can attest to that. In this way, the person checking ID sees only a photo and an attested piece of information, because the devices validating the attested information know only the attested information—they have not seen a photo, just a hash of the photo.

The identity token provides for a simple, fast and low cost, scalable identity network which can provide fully attested information without disclosing the full identity of the party to anyone except the validating authority, and then having this disclosed only once, when their dynamic identity token is created. A single person can have multiple dynamic identity tokens, and each of these tokens can each be signed by a separate network.

Peer-To-Peer Electronic Token Transfer

In some ways, the creation and use of tokens as disclosed herein can be thought of analogous to the use of fiat currency bank notes or coins which are issued as tokens by a national reserve. A £5 bank note is a promissory note issued by the Bank of England, having a serial number, watermark and/or other identifying features (e.g. artwork) that enable them to be verified as being issued by an authorised issuer. A £5 bank note is fungible and may be exchanged directly between users Alice and Bob without an intermediary (i.e. a peer-to-peer cash transfer as per Satoshi Nakamoto's 2008 whitepaper title) simply by Alice handing Bob a £5 note or five £1 coins. Alternatively, Alice may pay Bob via the issuing bank or another intermediary. Suppose that Alice wishes to pay Bob £5 via her bank. The £5 that Bob subsequently withdraws from his bank's ATM is unlikely to (although theoretically may) be the same £5 note that Alice paid into her bank. If he withdraws it in person from a bank teller he may be given five individual £1 coins. In either case, Bob's concern is that he receives his £5 worth of Bank of England tokens into his wallet.

Although it is unlikely that they would wish to do so, Alice or Bob may also destroy their £5 note or five £1 coins if they so wish. They may burn their bank note or melt their coins. Alternatively, the Bank of England may withdraw a bank note or coin from circulation so it can no longer be transferred between users. Similarly, tokens minted in accordance with the present disclosure can be destroyed by users or withdrawn/cancelled from ongoing use by an issuer.

Also in common with tokens of the present disclosure, a bank note or coin retains its token value regardless of the number of times that it is transacted—a £5 note is always worth five pounds Stirling, whether it is used once or 10,000 times.

Moreover, a banknote cannot be split or recombined. If a £5 note is cut into 5 individual pieces of paper/plastic, or a £1 coin is melted down into smaller pieces of metal they will retain some (probably very small) intrinsic value relating to the resale of the paper and/or metals, but the (probably larger) token value is lost. In the same way, if a token minted in accordance with the present disclosure is used in a manner that is incompatible with the protocol, the underlying cryptocurrency may still provide some value to the owner but the usage as a particular type of token may be rendered ineffective.

However, while banknotes and coins are a simple, quick, and private means of transferring a tokenised resource between users, they are inefficient in that their printing medium is physical. By providing a digital version of a token, some use cases of the present disclosure may provide a peer-to-peer electronic cash solution as per Satoshi Nakamoto's original white paper which offers the advantages of cash but provides a cryptographically secured and enforced alternative, that reduces the opportunity for exploitation by unauthorised parties (e.g. counterfeiters and fraudsters) and removes the wastage, expense and inefficiency of physical print media.

In some ways, therefore, examples of the disclosure provide simple, efficient and yet powerful blockchain-implemented solutions which are fully aligned with Satoshi Nakamoto's original, ground-breaking design. However, the benefits of such solution extend well beyond the use of blockchain technology for simply digital cash or currency in the same way that the Internet's benefits extend well beyond the simple provision of an electronic message or web page. Examples provide potential for solutions which have not yet been explored on the blockchain. Any type of resource can be tokenised using the disclosed examples, giving rise to a versatile and advantageous blockchain-implemented data transfer mechanism.

In some respects, the recognition and conception of the present disclosure has been obfuscated to date by current blockchain rules which restrict the size of transaction outputs to “dust” levels, and which have resulted in efforts being focused on a combine-and-split paradigm at the transaction and token levels. Examples of the disclosure, however, are able to exploit and harness the benefits of existing functionalities within blockchain protocols, such as Bitcoin's SIGHASH flags and flags with the same or similar functionalities in alternative protocols. Instead of following conventional tokenisation approaches which break up tokens and recombine them into different token amounts during the transfer process, examples disclosed herein comprise the use of unique, fixed-value, denominated tokens which can be quickly and efficiently verified and enable the creation of systems for uses beyond the capabilities of known approaches. Thus, improved blockchain networks and solutions are provided.

Moreover, once the tokens disclosed herein are issued, there is no requirement for the token Issuer to build or maintain additional infrastructure for token exchange/transfer/verification, providing a highly efficient and secure improvement over known techniques. The capabilities and benefits of the blockchain network are leveraged by simply specifying the way in which the transactions are built in script. All token transfers are conducted on-chain and so the cryptographic enforcement, consensus mechanisms and security of the blockchain network are harnessed, plus the immutable, inspectable, timestamped record of events is secured on-chain. There is no requirement for a user to insert data into a script, while having the ability to lock tokens using scripts that are suited to their individual requirements without changing the value of the token. There is no requirement for a user to insert data into a script due to the designation of the underlying cryptocurrency units that represents the transferrable value of the tokenised assets. As there is no additional overhead in terms of scripting, this again gives rise to efficiency benefits in terms of ledger use.

With regard to digital wallets, the disclosure avoids or at least alleviates the problem of complex wallet integration so that development resources such as time, effort, computing power and costs are minimised. Wallets do not need to interface with the blockchain network other than to obtain block headers for validating SPV proofs for tokens within their transactions and the associated historical transactions they receive. Wallets are simplified in that in some examples they do not need to build transactions, they can simply receive, sign and send the tokens in the usual way. Thus, examples of the disclosure provide the ability to construct hitherto unknown tokenisation systems and tools which store and transfer tokens using the simplest possible blockchain transaction outputs.

Further still, examples of the disclosure do not require the Issuer to be party to each transfer transaction on the blockchain. This addresses problems faced by existing solutions with regard to privacy and scalability, as their resource and cost requirements can escalate relative to the number of users.

Thus, the present disclosure provides technical solutions to a variety of technical problems, including, but not limited to, those mentioned above.

Further illustrative examples of the present disclosure are provided in the following enumerated clauses.
1. A blockchain-implemented method of operating a system having a device, the method comprising: using, processing and/or generating a blockchain transaction (MTx) having: one or more token-related outputs (T-UTXO), each of which represents a respective token (T) issued by a Token Issuer (TI) and specifies a) at least one of the operation, status and data that determines the configuration of the device; b) a quantity of token-related cryptocurrency (TRC) associated with the respective token (T).
2. A method according to clause 1, wherein the blockchain transaction further comprises at least one Issuer-related output (I-UTXO) comprising issuance data (IData) associated with the Token Issuer (TI).
3. A method according to any preceding clause, wherein the at least one of the operation, status and data that determines the configuration and/or status of the device is determined from instructions on the output of a respective token's blockchain transaction.
4. A method according to any preceding clause, wherein the operation of the device is determined by a controller having a state machine, said state machine having two or more operable states, wherein said the transition between states is determined by a token transaction.
5. A method according to any preceding clause, wherein the system includes an input device configured to create a token transaction output including data corresponding to at least one of an event, physical event and characteristic change of the input device.
6. A method according to clause 5, wherein the token transaction output includes a signature indicative of the at least one of an event, physical event and characteristic change of the input device.
7. A method according to any preceding clause, wherein the system includes an output device configured to create a token transaction output determining at least one of the operation, status and data that determines the configuration of the output device.
8. A method according to clause 7, wherein a token transaction input is retrieved from the status of an input device token transaction.
9. A method according to clause 8, wherein the token transaction input is a signature indicative of the at least one of an event, physical event and characteristic change of the input device.
10. A method according to any of clauses 7 to 9, wherein the token of the output device requires input from two or more input device token transactions.
11. A method according to any preceding clause, wherein the device has at least one of:
a control system configured to manage blockchain token transactions representing the status of the device;
a memory holding key-pair signatures for signing the UTXO of a token to change the state of said device using the token and the device it represents;
a secure mechanism for generating key-pairs for use in signing the UTXO of a token.
12. A method according to any preceding clause, wherein at least one of:
the device is a sub-system having two or more devices;
the respective token (T) determines the at least one of the operation, status and data that determines the configuration of two or more devices; and/or
two or more respective tokens determines the at least one of the operation, status and data that determines the configuration of the device.
13. A method according to any preceding clause, wherein the blockchain transaction (MTx) further includes at least one of a database format, entity and parameter and/or data related to the creation and/or modification of a database, said database capturing at least one of the operation, status and data that determines the configuration of the output device.
14. A method according to any preceding clause, wherein the or each token related output defines, at least in part, a portion of a relational and/or graphical database.
15. A method according to clause 13 or 14, wherein the or each token related output is an instruction for the modification of the table and/or database, the instruction determining at least one of (i) amending by adding, deleting or updating and (ii) modifying at least one of a row, column or record.
16. A method according to any preceding clause, wherein a token transaction and each subsequent token transaction defines, at least in part, a writechain.
17. A method according to clause 16, wherein the writechain enables a transactional database to be determined.
18. A device, operable in a control system, said device having:
a controller configured to processing and/or generating a blockchain transaction (MTx), said blockchain transaction having one or more token-related outputs (T-UTXO), each of which represents a respective token (T) issued by a Token Issuer (TI) and specifies
a) at least one of the operation, status and data that determines the configuration of the device;
b) a quantity of token-related cryptocurrency (TRC) associated with the respective token (T).
19. A device according to clause 18, wherein the controller processes instructions on the output of a respective token's blockchain transaction.
20. A device according to clause 19, wherein the controller has a state machine, said state machine having two or more operable states, wherein said states are determined by the controller processing the output from a token transaction.
21. A device according to any of clauses 18 to 20, wherein the controller has a state machine, said state machine having two or more operable states, wherein said states are determined by the controller processing the output from a token transaction.
22. A device according to any of clauses 18 to 21, wherein the device is an input device configured to manage an input-token and create a token transaction output including data related to at least one of an event, physical event and characteristic change of the input device.
23. A device according to clause 22, wherein the token transaction output includes a signature indicative of the at least one of an event, physical event and characteristic change of the device.
24. A device according to any of clauses 18 to 23, wherein an output device:
communicates with an input device (i) directly and/or (ii) is configured to read the latest token transaction from an input device to determine the status of the input device; and
is configured to process the response from the input device to create a token transaction in which the output determines at least one of the operation, status and data of the output device.
25. A device according to clause 24, wherein the response from the input device is a signature indicative of the at least one of an event, physical event and characteristic change of the input device.
26. A device according to any of clauses 18 to 25, wherein: the device is a sub-system having two or more devices; the respective token (T) determines the at least one of the operation, status and data that determines the configuration of two or more devices; and/or two or more respective tokens determines the at least one of the operation, status and data that determines the configuration of the device.
27. A system having a device configured to manage one or more token-related outputs (T-UTXO), each of which represents a respective token (T) issued by a Token Issuer (TI) and specifies: a quantity of token-related cryptocurrency (TRC) associated with the respective token (T); and at least one of the operation, status and data that determines the configuration of the device.
28. A method of monitoring a control system having a device, wherein said operation, status and data that determines the configuration of the device is determined by a token transaction on a cryptocurrency blockchain, wherein a chronological series of transactions determine a writechain of token transactions, and wherein the method retrieves and collates the outputs from the token transactions on the writechain in a database.

It should be noted that the above-mentioned examples illustrate rather than limit the disclosure, and that those skilled in the art will be capable of designing many alternative examples without departing from the scope of the disclosure as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. Throughout this specification the word “comprise”, or variations such as “includes”, “comprises” or “comprising”, will be understood to imply the inclusion of a stated element, integer or step, or group of elements, integers or steps, but not the exclusion of any other element, integer or step, or group of elements, integers or steps. The singular reference of an element does not exclude the plural reference of such elements and vice-versa. The disclosure may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

In this document we use the term ‘blockchain’ to include all forms of electronic, computer-based, distributed ledgers. These include consensus-based blockchain and transaction-chain technologies, permissioned and un-permissioned ledgers, shared ledgers, public and private blockchains, and variations thereof. As the Bitcoin ledger is the most widely known application of blockchain technology it will be used herein for ease of reference, although it should be noted that the term “Bitcoin” is intended herein to refer to any version or variation that derives from, or is based on, the Bitcoin protocol. Moreover, other non-Bitcoin blockchain implementations have been proposed and developed and alternative blockchain implementations and protocols fall within the scope of the present disclosure.

The term “user” may refer herein to a human or a processor-based resource.

The skilled person will readily understand that in the art it is usual to refer to spending of cryptocurrency in terms of sending coins from one address/owner to another. However, in reality, no actual “coins” are transferred. Instead, control of ownership is transferred from one script to another. As used herein, phrases “quantity/amount/portion of cryptocurrency”, “non-negative quantity etc

of cryptocurrency” and the like are intended to mean zero or more units of a cryptocurrency e.g. >=0 Satoshi in relation to Bitcoin.

1. A blockchain-implemented method of operating a system having a device, the method comprising:
using, processing and/or generating a blockchain transaction (MTx) having:
one or more token-related outputs (T-UTXO), each of which represents a respective token (T) issued by a Token Issuer (TI) and specifies
a) at least one of the operation, status and data that determines the configuration of the device;
b) a quantity of token-related cryptocurrency (TRC) associated with the respective token (T).

2. A method according to claim 1, wherein the blockchain transaction further comprises at least one Issuer-related output (I-UTXO) comprising issuance data (IData) associated with the Token Issuer (TI).

3. A method according to claim 1, wherein the at least one of the operation, status and data that determines the configuration and/or status of the device is determined from instructions on the output of a respective token's blockchain transaction.

4. A method according to claim 1, wherein the operation of the device is determined by a controller having a state machine, said state machine having two or more operable states, wherein said the transition between states is determined by a token transaction.

5. A method according to claim 1, wherein the system includes an input device configured to create a token transaction output including data corresponding to at least one of an event, physical event and characteristic change of the input device.

6. A method according to claim 5, wherein the token transaction output includes a signature indicative of the at least one of an event, physical event and characteristic change of the input device.

7. A method according to claim 1, wherein the system includes an output device configured to create a token transaction output determining at least one of the operation, status and data that determines the configuration of the output device.

8. A method according to claim 7, wherein a token transaction input is retrieved from the status of an input device token transaction.

9. A method according to claim 1, wherein the device has at least one of:
a control system configured to manage blockchain token transactions representing the status of the device;
a memory holding key-pair signatures for signing the UTXO of a token to change the state of said device using the token and the device it represents;
a secure mechanism for generating key-pairs for use in signing the UTXO of a token.

10. A method according to claim 1, wherein at least one of:
the device is a sub-system having two or more devices;
the respective token (T) determines the at least one of the operation, status and data that determines the configuration of two or more devices; and/or
two or more respective tokens determines the at least one of the operation, status and data that determines the configuration of the device.

11. A method according to claim 13, wherein the or each token related output is an instruction for the modification of the table and/or database, the instruction determining at least one of (i) amending by adding, deleting or updating and (ii) modifying at least one of a row, column or record.

12. A device, operable in a control system, said device having:
a controller configured to processing and/or generating a blockchain transaction (MTx), said blockchain transaction having one or more token-related outputs (T-UTXO), each of which represents a respective token (T) issued by a Token Issuer (TI) and specifies
a) at least one of the operation, status and data that determines the configuration of the device;
b) a quantity of token-related cryptocurrency (TRC) associated with the respective token (T).

13. A device according to claim 12, wherein the controller has a state machine, said state machine having two or more operable states, wherein said states are determined by the controller processing the output from a token transaction.

14. A device according to claim 18, wherein the device is an input device configured to manage an input-token and create a token transaction output including data related to at least one of an event, physical event and characteristic change of the input device.

15. A device according to claim 12, wherein an output device:
communicates with an input device (i) directly and/or (ii) is configured to read the latest token transaction from an input device to determine the status of the input device; and
is configured to process the response from the input device to create a token transaction in which the output determines at least one of the operation, status and data of the output device.
